(19) United States
(12) Patent Application Publication
(10) Pub. No.: US 2007/0150368 A1
(43) Pub. Date: Jun. 28, 2007

(54) On-line personalized content and merchandising environment

(76) Inventors: Samir Arora, Woodside, CA (US); Dianna Gewing-Mullins, Dublin, CA (US); Fernando Ruarte, San Francisco, CA (US); Emmanuel Job, San Francisco, CA (US); Raj Narayan, San Bruno, CA (US); Susan D. Kare, San Francisco, CA (US); Bonni Evensen, San Francisco, CA (US)

Correspondence Address: STALLMAN & POLLOCK LLP, 353 SACRAMENTO STREET, SUITE 2200, SAN FRANCISCO, CA, 94111, US

(21) Appl. No.: 11/515,618

(22) Filed: Sep. 5, 2006

Related U.S. Application Data
(60) Provisional application No. 60/714,325, filed on Sep. 6, 2005.
(60) Provisional application No. 60/715,075, filed on Sep. 8, 2005.

(51) Int. Cl. G06Q 30/00

(52) U.S. Cl. 705/26

(57) ABSTRACT

A story-based approach is used to display information to a user in an online environment in a way that is easy to navigate and appealing to the user. Content of the story can be selected and organized for the user based on information and attributes obtained for the user, through style tests or other interactive processes created to be fun for the user. The user can flip through chapters and subchapters in a way that allows the user to control the amount and relevance of content presented. The content can be designed and arranged in a way that has more visual style than has been seen online, providing a more pleasurable visual magazine or catalog experience, wherein all content displayed to the user is selected based upon information for that user.

### RELATED APPLICATIONS

This application claims the benefit of U.S. Provisional Application No. 60/714,325, filed on Sep. 6, 2005, by Arora et al. and titled “Online Personalized Content and Merchandising Environment.” Provisional Application No. 60/714,325 is hereby incorporated by reference herein in its entirety.

This application also claims the benefit of U.S. Provisional Application No. 60/715,075, filed on Sep. 8, 2005, by Arora et al. and titled “Online Personalized Content and Merchandising Environment.” Provisional Application No. 60/715,075 is hereby incorporated by reference herein in its entirety.

### TECHNICAL FIELD OF THE INVENTION

The present invention relates to the presentation of related content and merchandising to a user or potential customer in an online environment.

### BACKGROUND

A significant disparity presently exists between the shopping habits of men and women when it comes to online versus “brick and mortar” experiences. It has been found that approximately 70% of the purchases in retail stores and other physical locations are made by women, while 80% of the purchases made on the Web are made by men. One suggested reason for this difference is that men in general tend to be “search-oriented” shoppers, in that, when a man wants to purchase a new item, he will log onto a Web site, do a search for that item, and purchase that item. There may be little comparison shopping, and the man may not look at any other items available on the site. Women, on the other hand, tend to be less search oriented. Women tend to browse and compare more than men, and tend to look at other items that catch their interest. Many women also enjoy the shopping “experience,” which can involve browsing for new and/or interesting items when there is no particular item that is actually needed. A physical store is ideal for these shoppers, as a number of displays can be set up throughout the store to catch the shopper's eye. Further, for an example such as the fashion industry, these store displays allow the merchant to show how an item would look on someone, as well as to present “looks” that could be created with the item, including other clothing items and accessories. The shopping “experience” has translated well to catalogs and magazines, which allow women to view looks, styles and selected items in a way that is much more visually appealing and entertaining. Further, these catalogs and magazines can be used to select items and styles based on preferences of the consumer, such as by presenting items that might appeal to a certain demographic or type of consumer that tends to buy that magazine.

Sites on the Web have typically not been very good at translating these concepts to an online environment. Most shopping sites display items using a search-based approach. While a number of items might be featured on the front page of the site, or even on sub-pages of the site, it still generally is necessary for the user to either use search terms or click through a number of links to find what the user is looking for. Further, the results typically are displayed using a standard template, such that items typically are displayed in a column, row or array with little visual appeal. Another problem with many of these sites is that they are very limited when using categories for the items. For example, clothing items might be broken down by “tops” or “summer accessories,” but do not allow a user to look for related items that are more personal to that user. Some sites will present recommendations, but those recommendations typically are based on prior purchases. When items are purchased for others on that site, recommendations based on these purchases might have nothing to do with the tastes of the actual user.

Still another problem with existing sites is the way in which ads are presented to a user. Popup and banner ads can be annoying to a user, particularly when the ad does not match the style of the site and has nothing to do with the item being sought. For example, a customer searching online for a designer handbag might not like a banner ad with flashing red lettering. Further, the user might not understand why the user sees, or appreciate receiving, an ad for motor oil when shopping for high-end couture. Even if the item is related, displaying an ad for clearance items at a discount store might lessen the experience for someone shopping for high-end items.

Another aspect that Web sites have failed to capitalize upon is the fondness of many women to read fashion magazines, celebrity magazines and catalogs as entertainment. While a woman might consider reading a fashion magazine a relaxing break during the day, clicking and searching through a Web site to try to find something interesting might not seem as relaxing. The user experience on many of these sites needs to be changed in order to increase their appeal and attract more female customers. Further, by adding more visual appeal, these sites might also increase the number of male customers as well.

### BRIEF DESCRIPTION OF THE DRAWINGS

FIGS. 1-83 provide diagrams and screenshots of pages, tools and other components that can be used in accordance with various embodiments of the present invention.

FIG. 84 provides an architecture overview of systems and methods in accordance with the concepts of the present invention.

FIG. 85 provides a flow chart for systems and methods in accordance with the concepts of the present invention.

### DETAILED DESCRIPTION

Systems and methods in accordance with various embodiments of the present invention can be used to develop and create a knowledge base about a user that enables a high degree of personalization and individual understanding never before offered or implemented on the Web. Such a knowledge base can be used to overcome deficiencies in existing approaches to presenting content, advertising and merchandising to users, particularly in an online environment that is relevant and particular to the user. These systems learn information about a user through the user's interaction with a Web site, for example, in a way that is entertaining and visually appealing to the user. This information is then used to present content that is completely personalized for the user. The novel concepts described herein obtain user information using approaches never before utilized in an online environment to target content and merchandising to a user.

As discussed herein in detail, the site uses any of a number of interactive approaches, such as are referred to herein for at least one embodiment of the invention as “Style Tests.” These tests are designed and created by a combination of editors, designers, merchandisers, stylists, psychologists, and/or any of a number of other persons, in order to create tests that are visually appealing and entertaining for a user, and that are presented to the user in such a way that the user actually wants to take the test and return to take other tests. These tests are also created to obtain specific types of information that can include obtaining information never before used in an online environment for personalization. One of the biggest problems with trying to present personalized content to a user is the ability to accurately model the user. Modeling a user not only includes information such as age, income, recent purchases and other objective information that is currently used to target information, but also can include many other factors such as a person's beliefs, feelings, preferences, styles, loves, hates, emotions, receptiveness, views, politics, interests and any of a number of other categories or dimensions that have not previously been used in an online environment to present personalized information. The site grows with the user to continue to present personalized content as the person changes and matures.

Some online sites target information to a user based on previous purchases. In one example, a user having purchased a pool float for a grandson might be presented with a bikini as being an item related to a previous purchase. The site would have no way of knowing, other than based perhaps on the age of the user, that a bikini might be inappropriate for this user. Through various style tests, as described herein, information can be obtained for the user showing that the user dresses conservatively, stays out of the sun, does not like the beach, thinks it is sexier to show less skin, or any of a number of other indicators that a bikini might not be the most likely item for the user to be interested in. Using the above criteria, however, a matching engine, as described below, can present the user with conservative summer clothing and accessories that match the style of the user. The ability to know about the user himself/herself, rather than simply tracking objective information, allows a site to present the user with content that is much more likely to be of interest.

Further, the categories of items presented to a user are not merely grouped automatically by search or keyword, but are selected, assembled and organized by a human team skilled in knowing users, styles, trends, designs, marketing, and any of a number of other aspects useful in matching a user with content that not only is relevant and may be of interest for the user, but also matches current styles and trends and many other useful criteria. These teams can assemble any number of different categories, subcategories, and other groupings of content, merchandising, advertising, and other materials to present to specific groups of users based on profiles, information, test results, or any of the other criteria described herein. This method of not only receiving personalized content but also of having a virtual “personal shopper,” stylist, advisor, and other useful functions online has never been done before and revolutionizes the way in which content is presented to a user online.

Further, the content is organized and presented in a way that resembles a series of stories that are personalized for the user. It is impossible to create a Web site that appeals to all users, due to factors such as personal preferences, maturity, viewpoints, etc. For this reason, a number of sites tend to focus on a specific niche or demographic. Of course, this greatly limits the potential user base and advertising revenue for the site. Sites based on embodiments described herein present content in a personalized story-based approach that presents different content to each user, such that a larger number of users can be targeted.

These stories are matched to a user based on a test result or other such data set. For example, critical data about the individual, such as age, fashion style, location where the individual lives and works, income level, and willingness to own fashion items are all analyzed and used to assemble a story that is precisely targeted and relevant to the user reading the story. Each story can have chapters, subchapters and story pages, each of which also can be personalized for the user based on user information. The entire user experience from the time the user first accesses the site is personalized.

A further advantage of embodiments of the invention disclosed herein is the ability of the user to browse or “page through” other chapters, subchapters or pages of each story in order to view as much additional information as is of interest to the user. For example, a story might be related to red carpet styles, which might include chapters relating to celebrity red carpet styles and evening gown designers, with subchapters relating to specific items and accessories for those categories that have been personally selected for a person matching the user's profile. The user might be interested, however, in viewing the other celebrity styles and designers that might not necessarily be in the user's style, but are of interest to the user nonetheless for entertainment or other purposes. Each of these categories/pages/etc. can carry through a visual and editorial theme that is selected to be entertaining and visually appealing to the user. In one embodiment, the user is presented with a personalized online fashion and merchandising magazine wherein the user can take fun tests to personalize the experience, read through personalized stories, view items selected for the user related to those stories, and purchase those items using the site.

The ways of organizing this content, selecting the content, personalizing the content for the user and creating the visual design, as well as other aspects, will be described in greater below. There are any of a number of tools, such as layout editors in accordance with various embodiments of the invention, that allow persons such as editors, designers, merchandisers, etc., to add content to the site. These tools can allow an inexperienced or non-technical person to update pages and content easily and quickly, such that the site can be continually updated in order to present the user with new information and keep the user coming back. A number of other features and advantages to the various embodiments of the invention will also be described below.

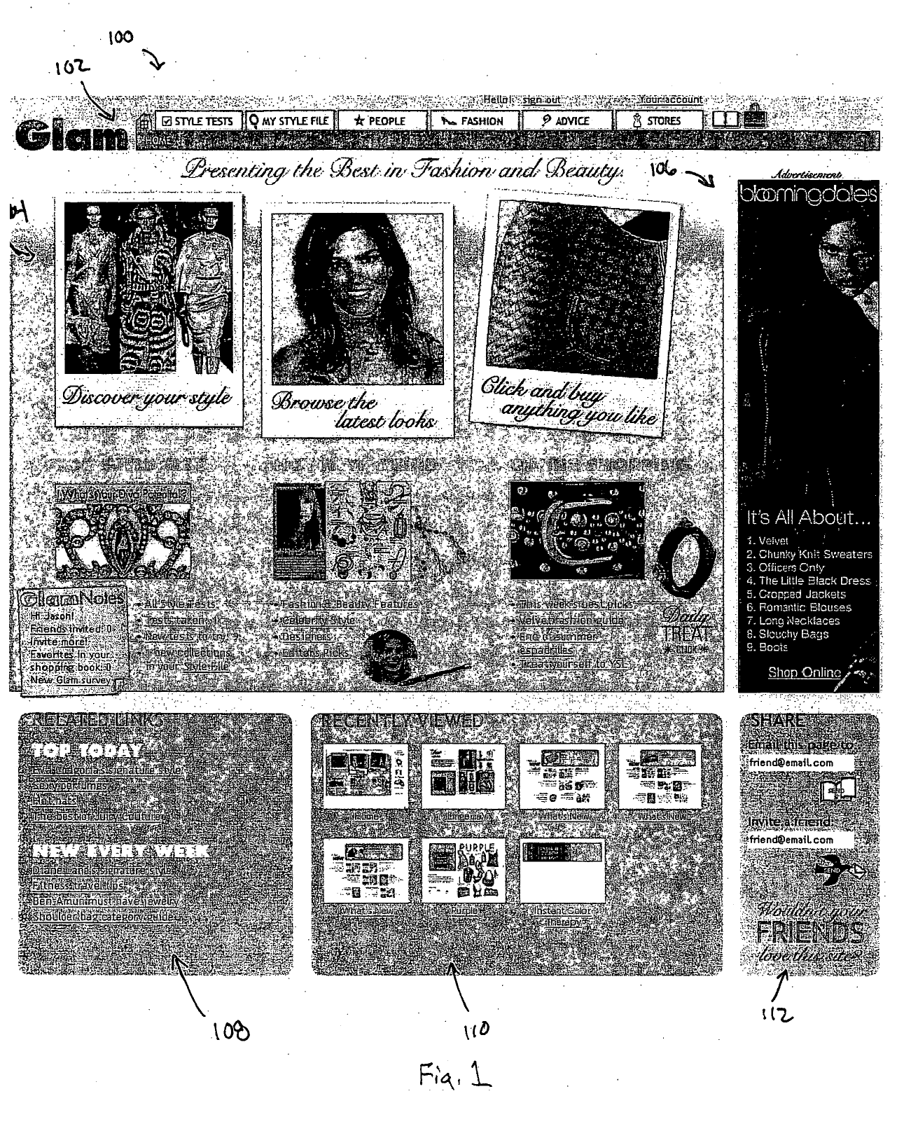

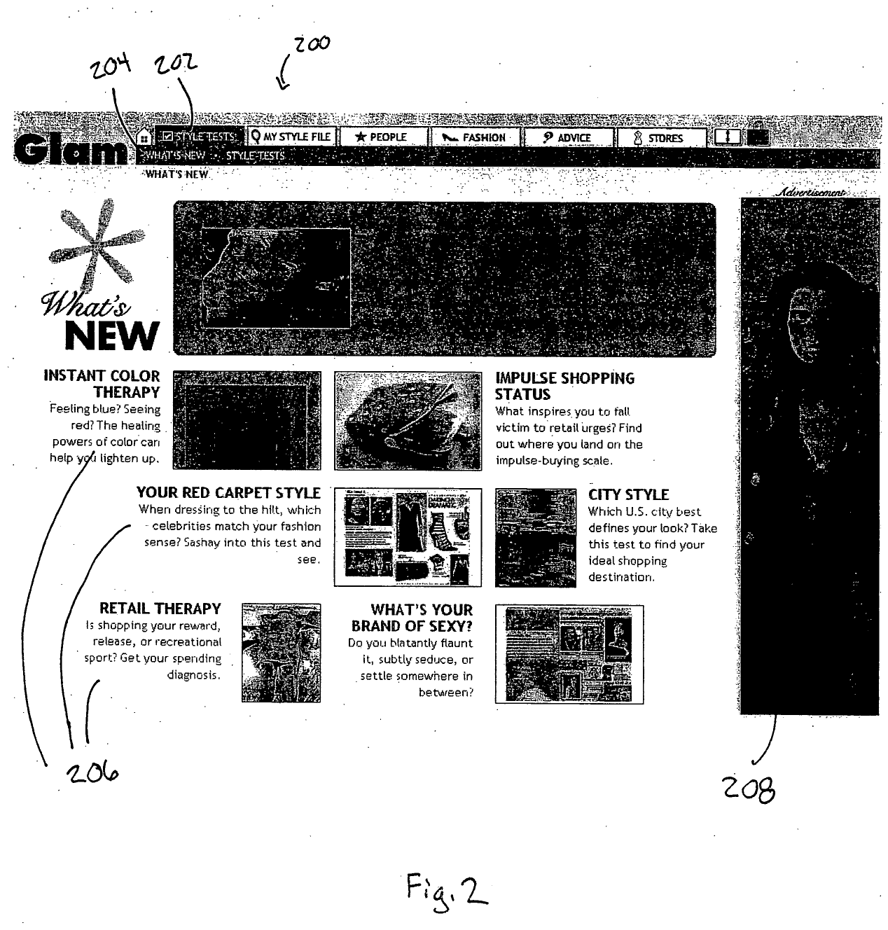

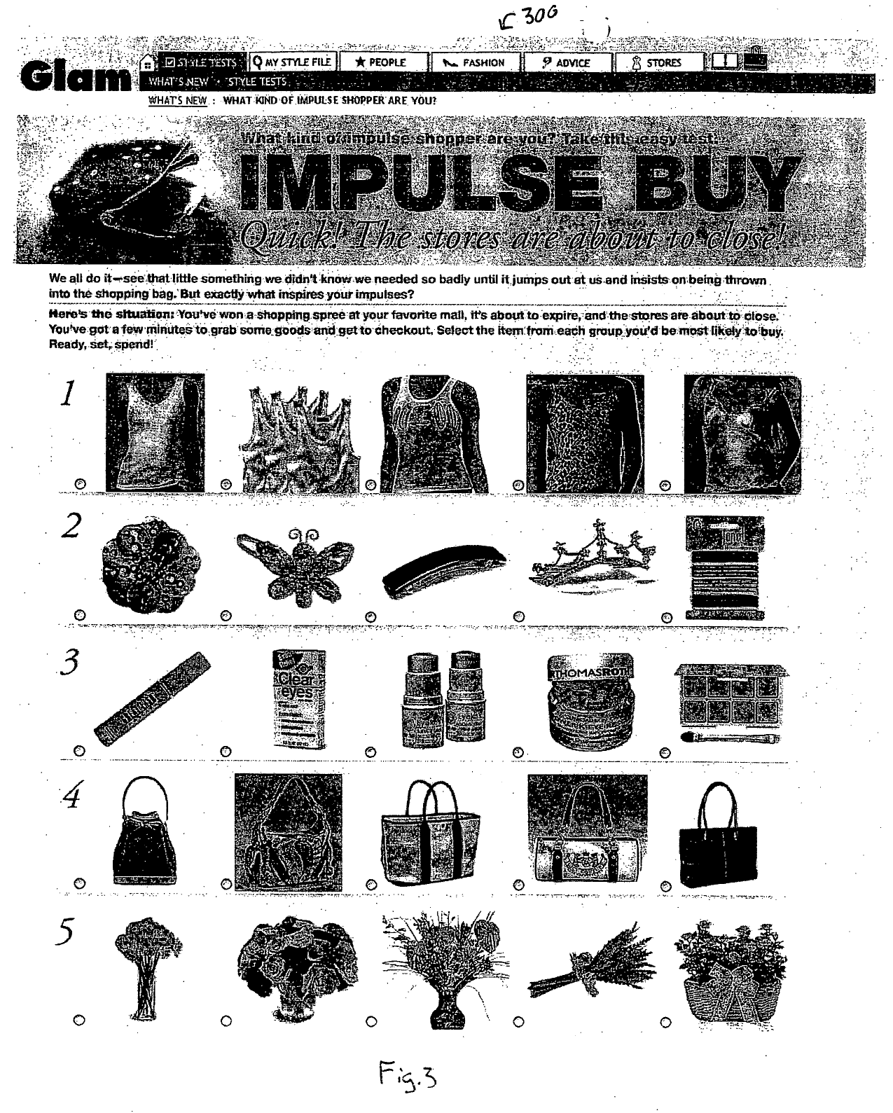

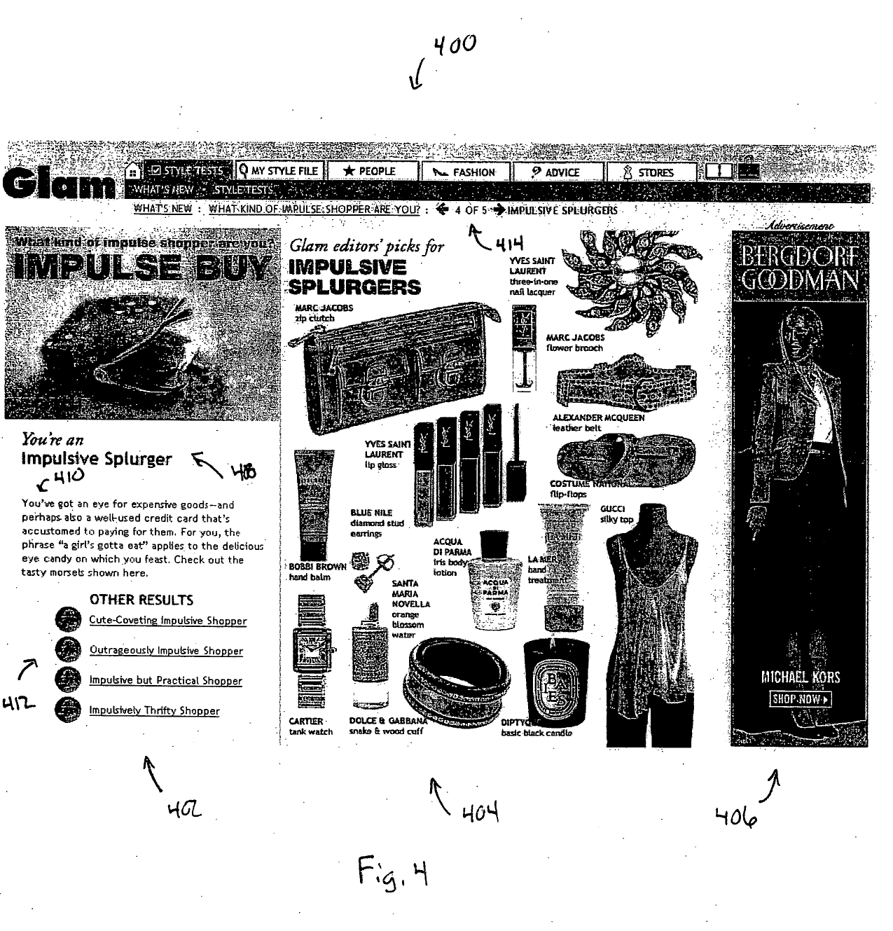

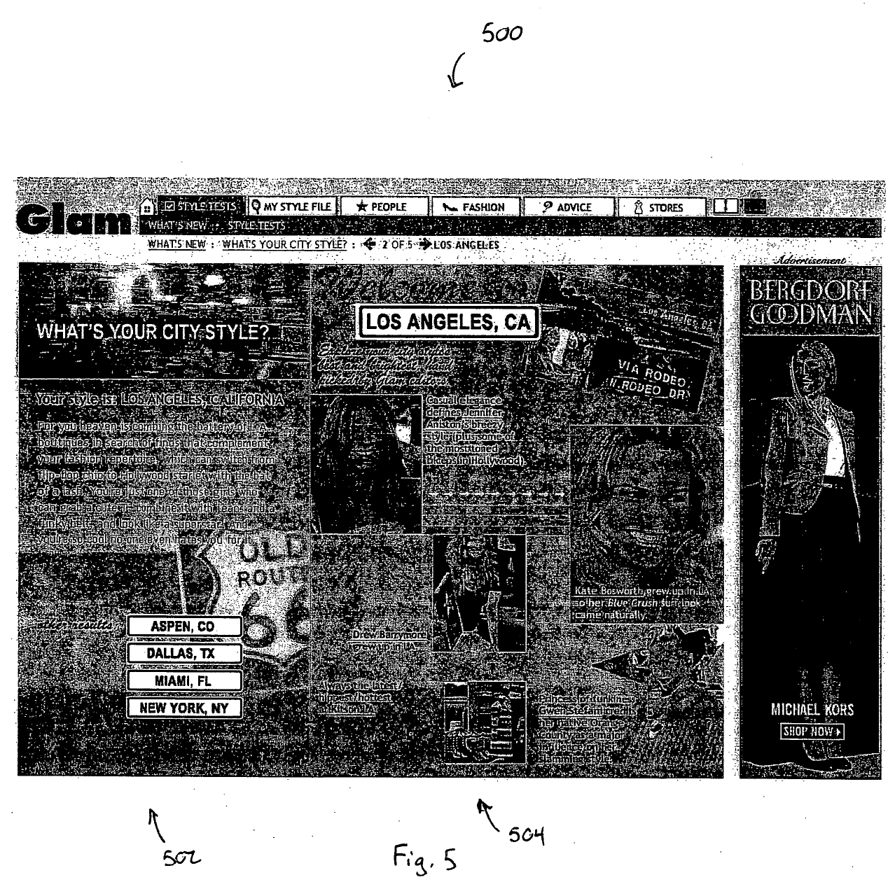

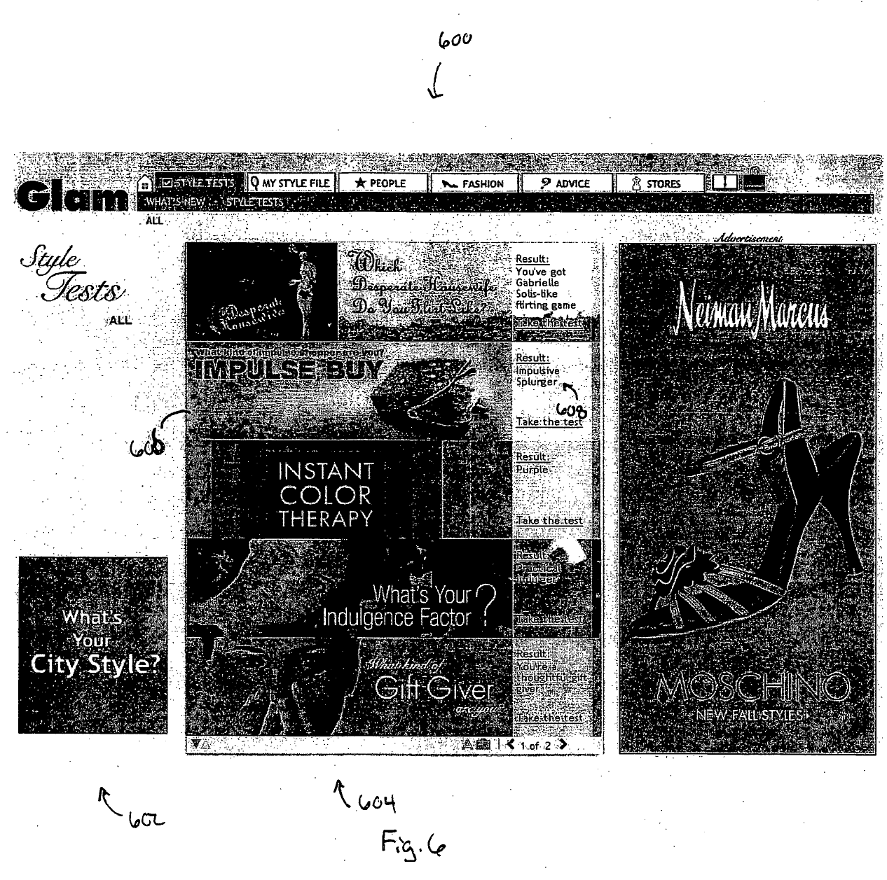

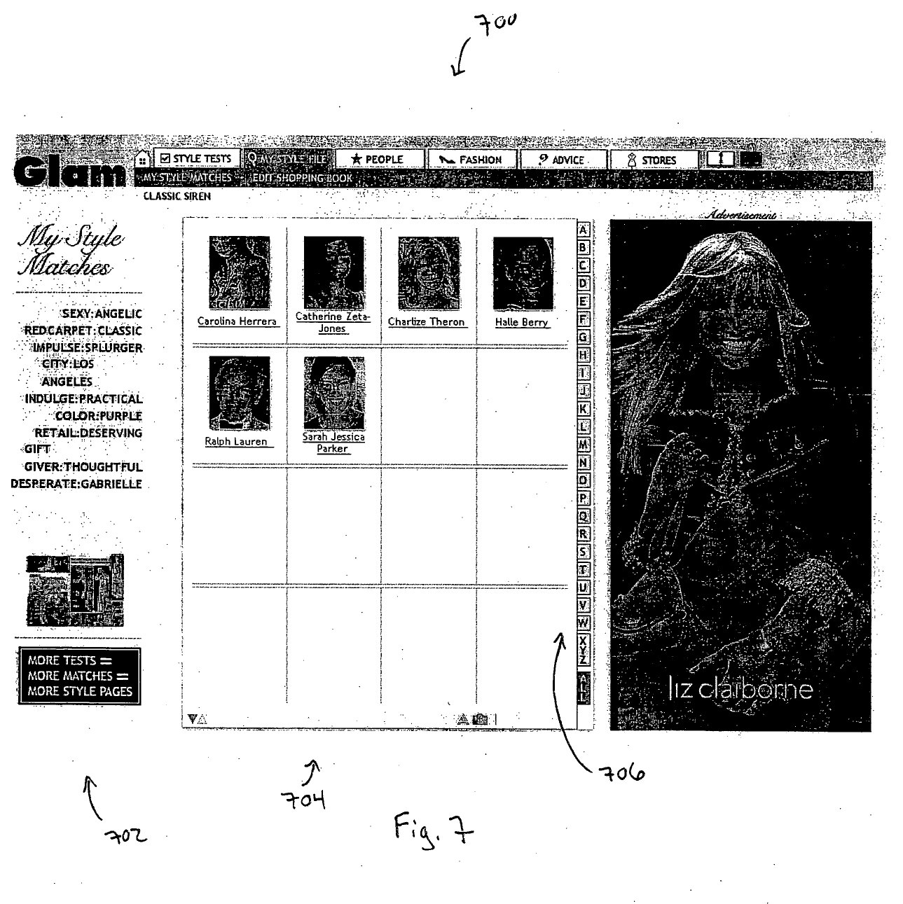

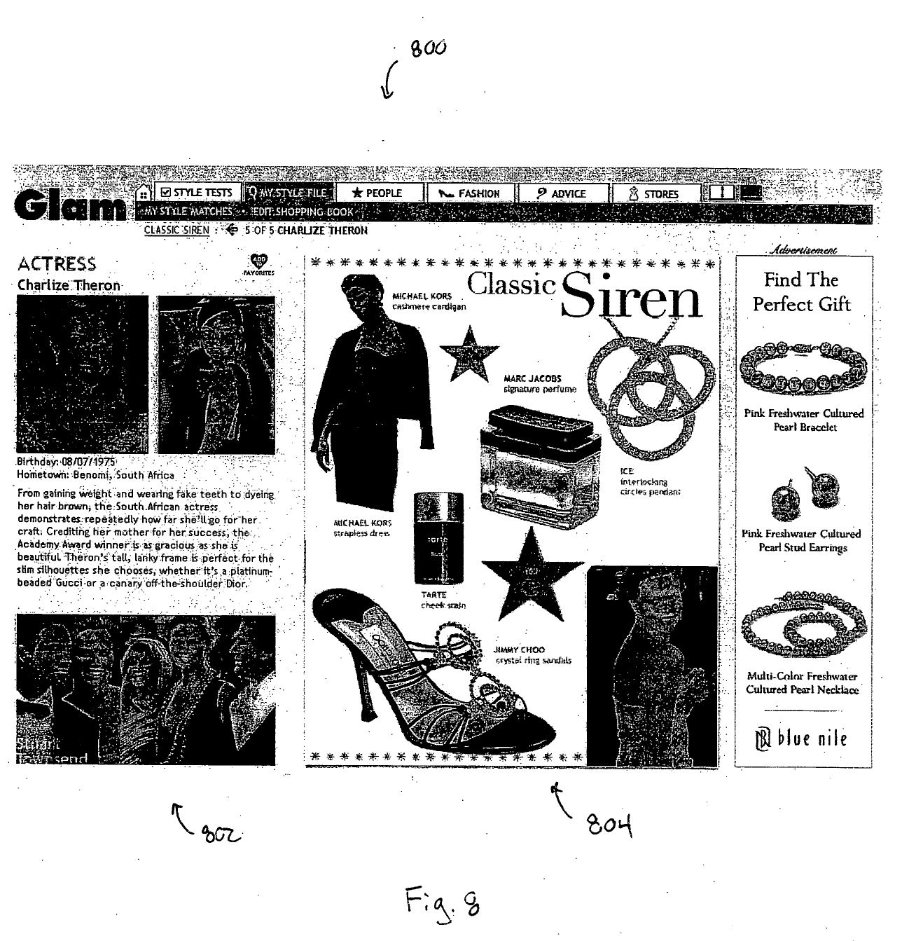

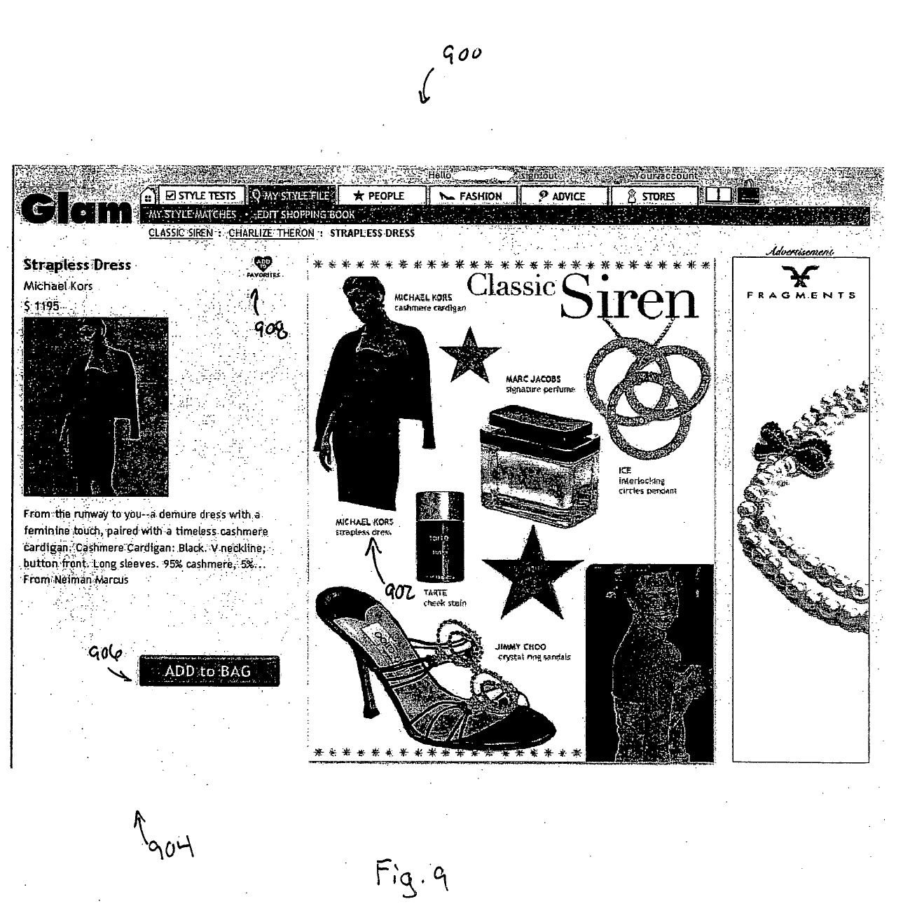

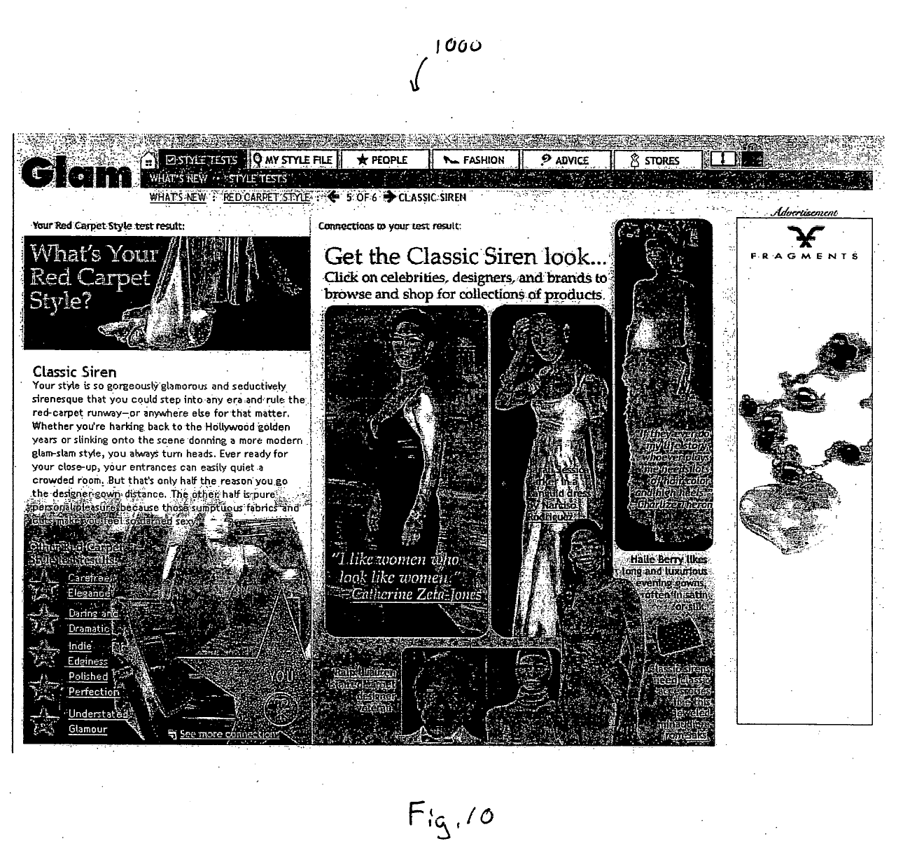

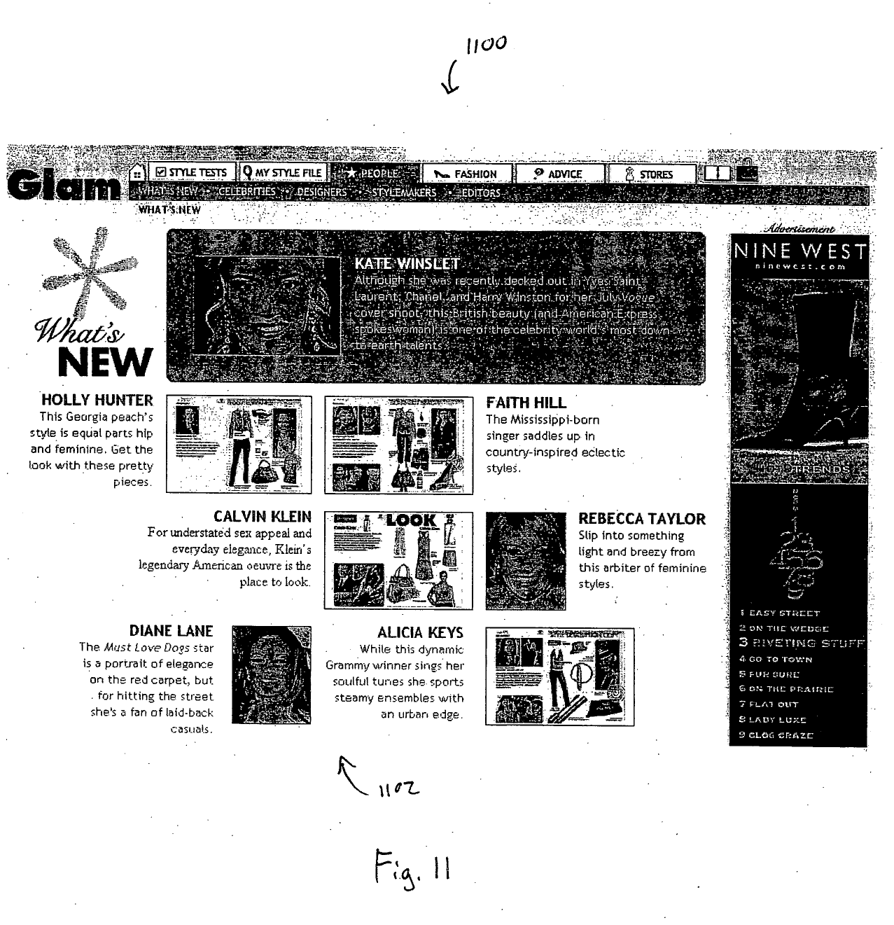

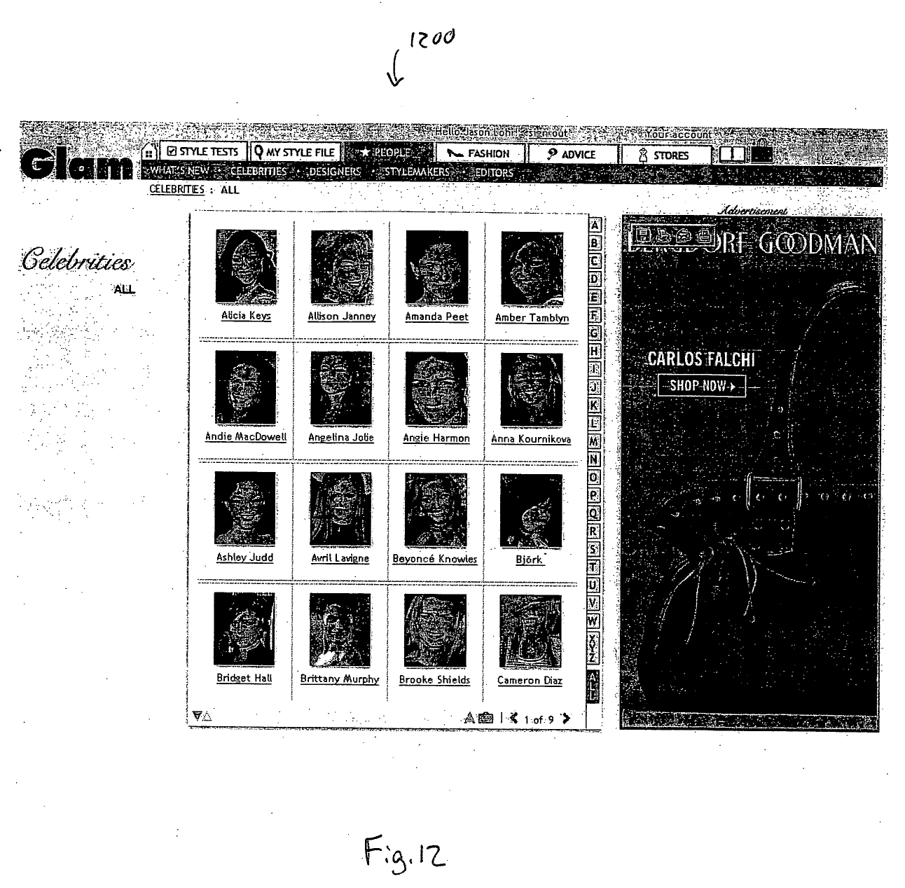

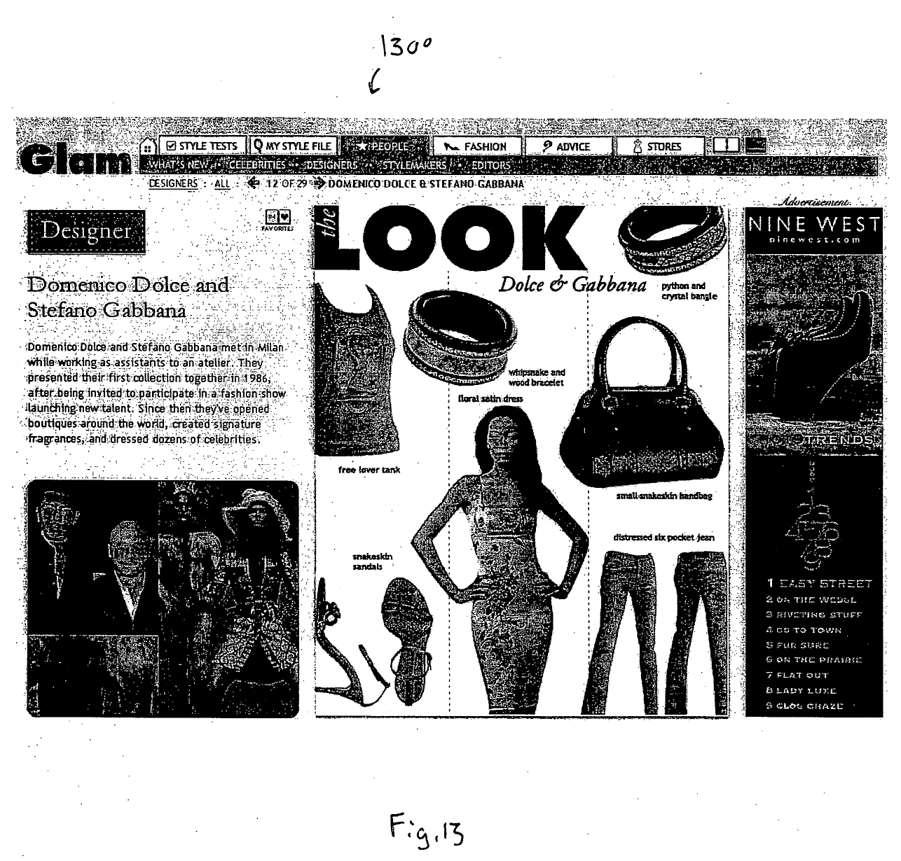

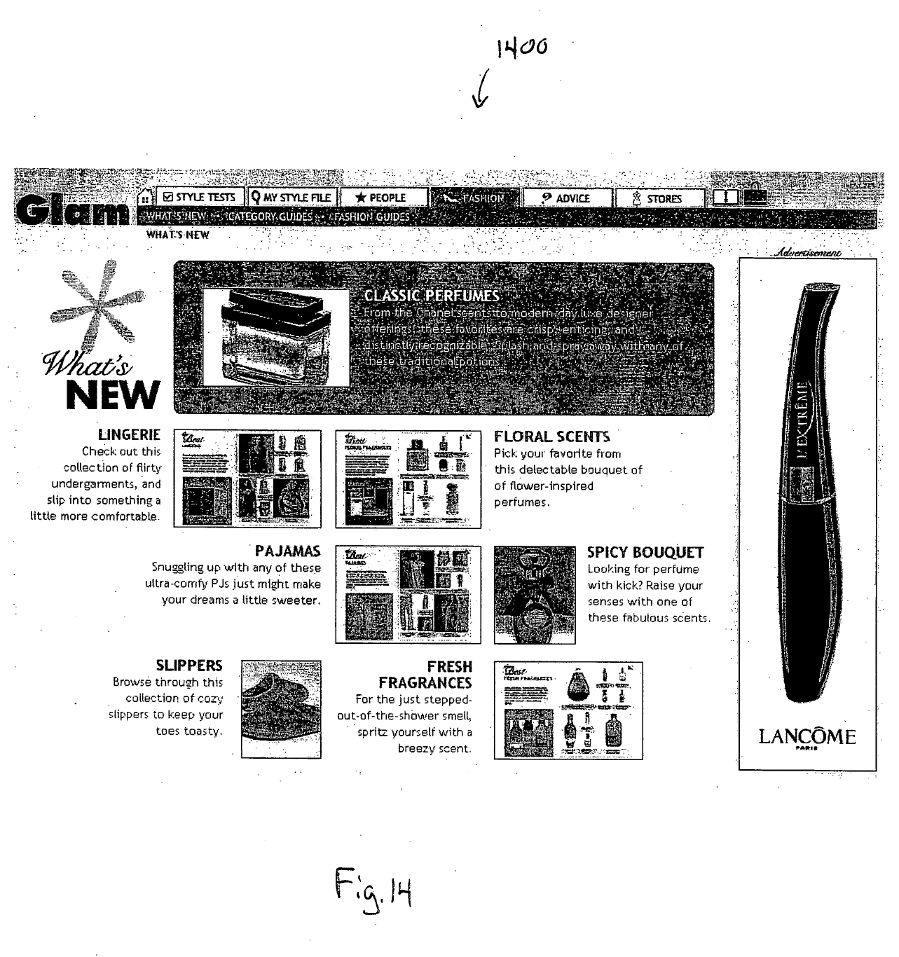

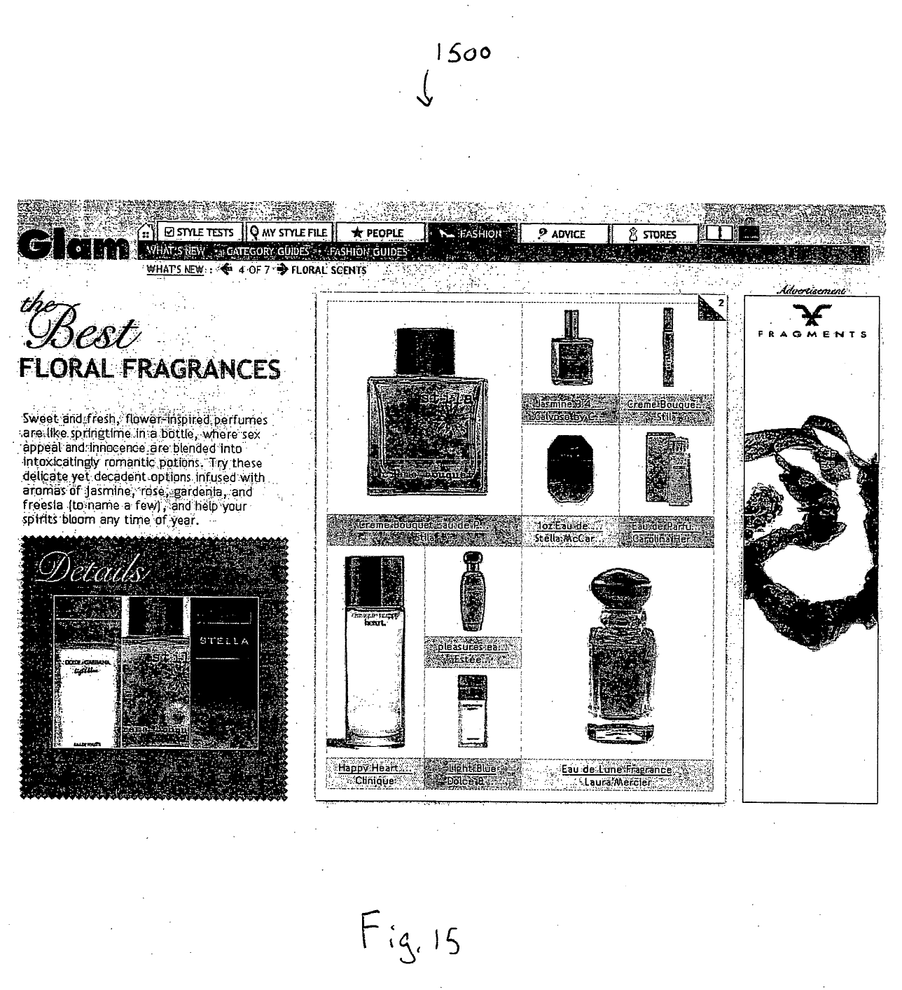

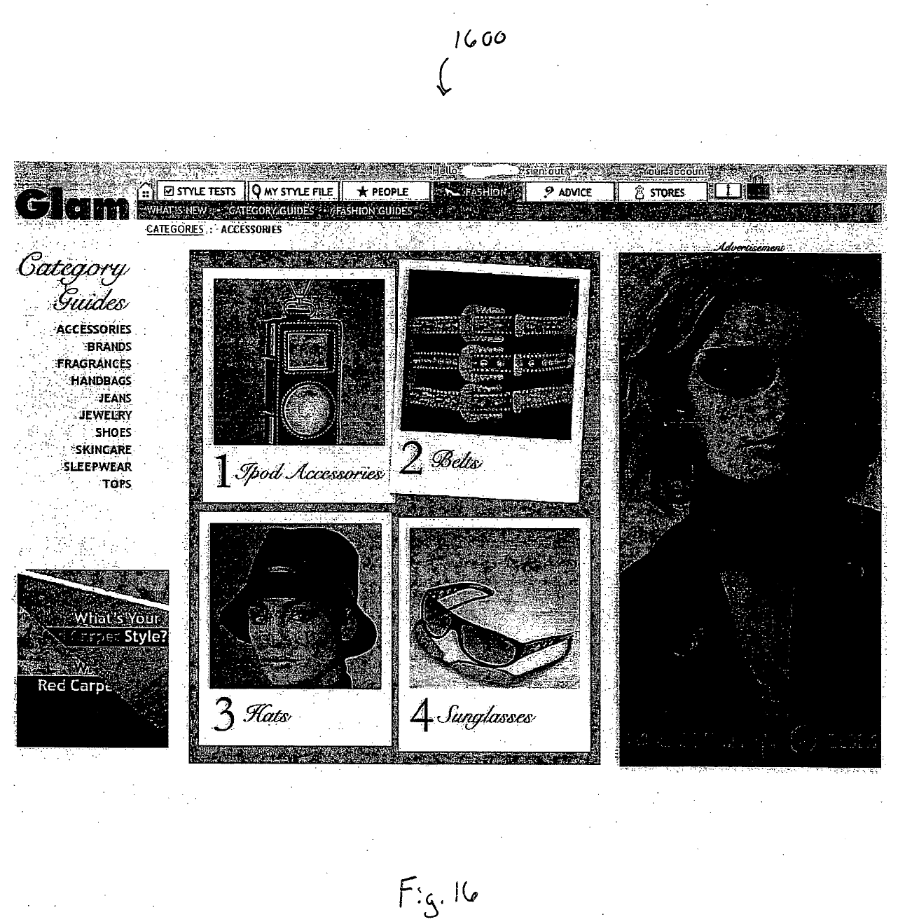

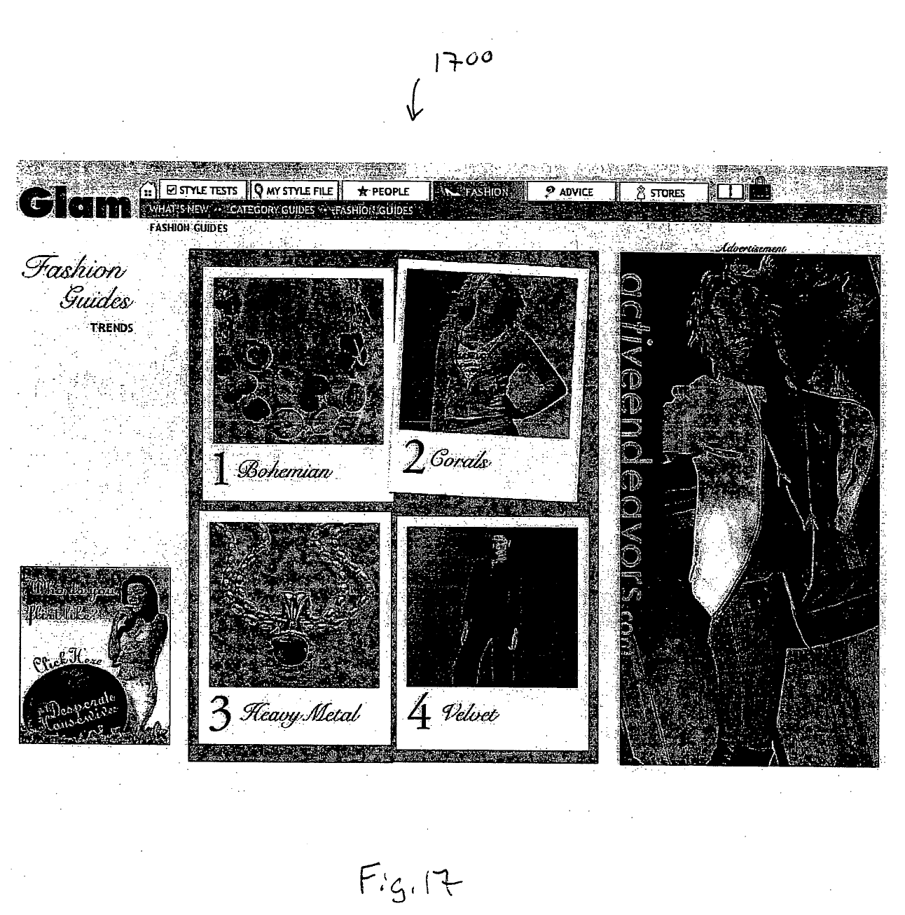

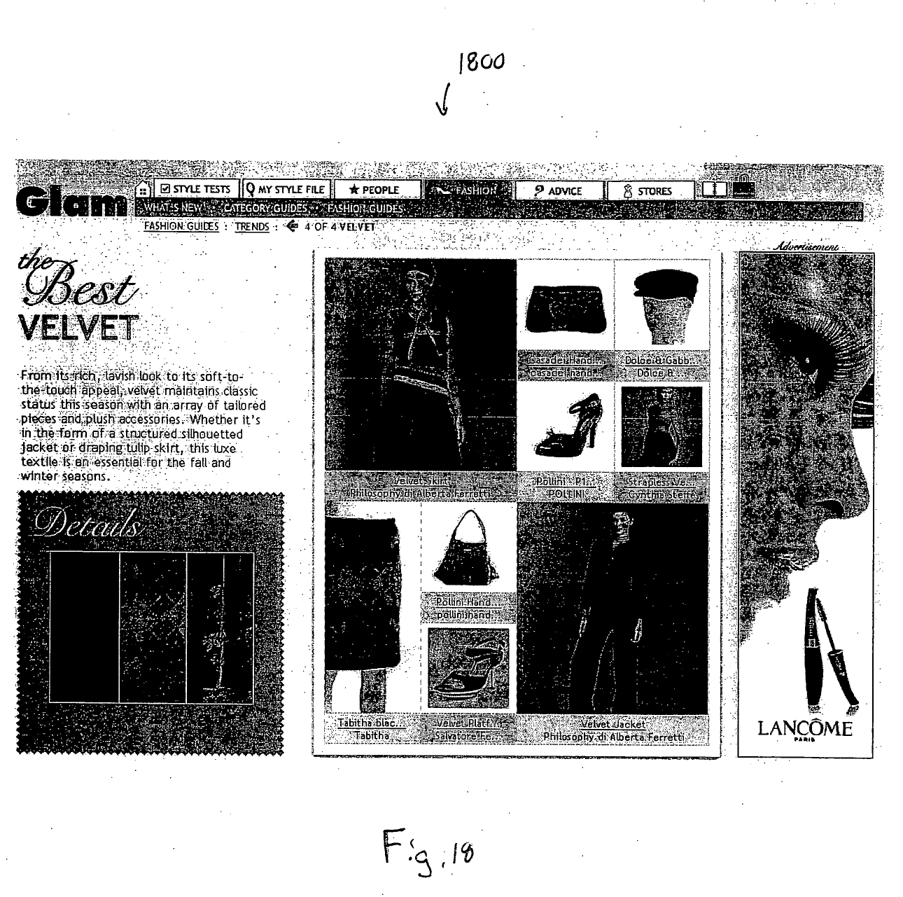

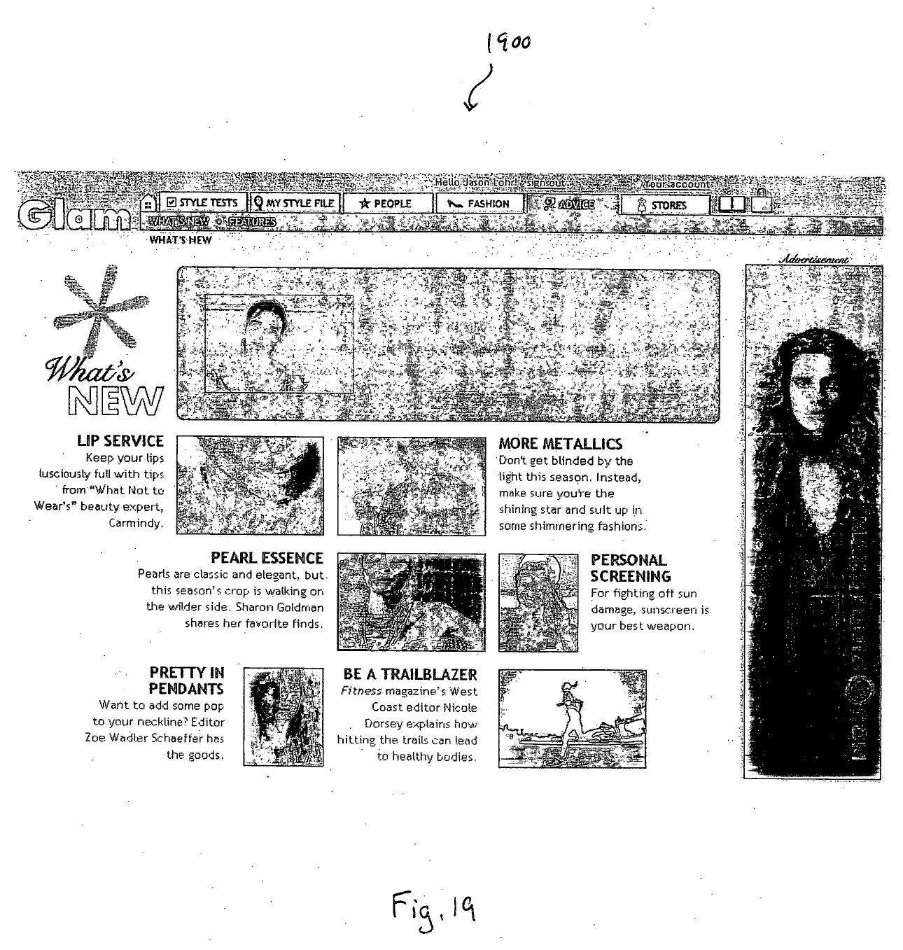

FIG. 1 shows an exemplary home page 100 for a fashion and beauty Website that is created and used in accordance with various embodiments of the present invention. This exemplary home page shows six main sections, although fewer or additional sections may be used in accordance with the various embodiments, as would be understood in light of the description contained herein. Further, while this site will be described with respect to a fashion and beauty example, it should be understood that there are any of a number of different content and/or merchandising applications that can take advantage of the various features and approaches described herein, and that the fashion example is merely meant to show one possible application and is not intended to limit the scope of the invention.

The home page 100 shown in FIG. 1 includes a first section 102 including a header bar, which will be described in detail later below. The header bar can contain any of a number of components, such as a home icon and/or site title that links back to the home page 100, and a series of tabs or other selection features (as known in the art) allowing a user to select between a number of different categories or features. The header bar also can contain icons or other selectable indicators that allow the user to go to a shopping bag, or shopping cart as more commonly referred to in the art, as well as to go to a shopping book as will be described subsequently. The use of a “shopping bag” instead of a shopping cart enhances the experience that the user is shopping in a private boutique instead of shopping “off the rack” in a discount store or other large retail establishment where the user might be pushing around a shopping “cart.” The header bar also can contain a welcome to the user, as well as a link to the user's account information and a link to sign/log out of the site. Any of a number of other features can be contained in the header bar, as would be understood to one of ordinary skill in the art. The header bar can appear to be static, in that its appearance does not change as the user navigates through the site (similar to frame-based navigation as known in the art), or can change with user navigation, such as to show which tab or other selection is active.

A second section 104, referred to herein as the targeted content section, contains active content that is targeted to a specific user. If a user is a first time visitor, the targeted content section can be set up to direct the user through the site. If a user is a returning visitor, the displayed content can be based upon information collected from that user. Shown in FIG. 1 on the home page 100, the section 104 includes items, images, text, or other selectable content that can direct a user to specific pages or stories on the site as will be described below. Once the user begins navigating through the site (and away from the home page), this section 104 can include content targeted to the user as will be described in greater detail below.

A third section 106, such as a skyscraper banner section, includes advertising to be displayed to the user. While a specific ad might be selected to be displayed to a first time user, the ad shown on the home page 100 (and other subsequent pages) to a returning visitor is selected using an appropriate ad-selection algorithm, such as will be described below, to display an ad that is more likely to be relevant to the user and/or the content displayed. In subsequent pages, the ad also can depend upon the content in the content section as will be discussed.

A fourth section 108 includes a number of links, selected by the site editors or selected based on user information, that direct the user to specific pages of the site. These links can change by the day, week, or season, for example, or can be determined by the popularity of certain pages, the user profile, or any other appropriate selection mechanism. These links also can be selected editorially, allowing an editor to select specific links to be displayed to a user based on content, interest, or any other appropriate selection mechanism.

A fifth section 110 includes a display of pages recently visited, pages that are most popular, pages that are recommended for the user, or pages that are recommended based on what is displayed in the content window. By displaying what was shown in previous content windows, or other selected content windows, a user can easily “flip” to a page of interest without having to navigate using textual links or search mechanisms. This also allows a user to easily switch back and forth between pages that are displayed in the content section 104 simply by clicking on the desired page(s) in this section. By showing screenshots, a user also can navigate back to an item based on a visual recollection of the page, even if the user cannot otherwise remember the name, subject matter, or other indicator for the page that would be needed to find that page in existing sites.

A sixth section 112 presents the user with the ability to share a page or the site with a friend or acquaintance. For example, if a user finds a page that might be of particular interest to someone, the user enters the email address of that other person in a share field, such that when the user submits the information, a copy of that page or a link to that page is sent to that person for viewing. Alternatively, the user can enter the email address in an invite field to send a message to that person telling them that they should check out this particular site, including a link for easy access. The icons used to submit these email addresses can be uniquely designed to promote understanding, such as an icon showing a page being torn out of a magazine to send a page to a friend, or a bird carrying a letter to mail an invitation to a friend.

FIG. 2 shows an exemplary page 200 that can be used to present new information to a user. Sections four through six of FIG. 1 are not shown in the following figures for simplicity, but it should be understood that any or all of these sections can be carried over to subsequent pages as would be understood to one of ordinary skill in the art. The FIG. 2 page 200 can be selected from the header bar, such as by selecting an appropriate tab 202 on the bar. This tab can lead users to pages that allow a user to enter information, such as through preferences or personal tests, that can be used to display information or content that is more relevant to the user. The page 200 includes links in the header bar that are specific to that particular tab, such as a link to new information 204 and a link allowing the user to go directly to the series of tests or other user input mechanisms. The exemplary page 200 corresponds to the “What's New” link of the Style Tests tab, which can be shown by default when the user selects the “Style Tests” tab. It should be understood that “Style Tests” and the name of any subsequent tab or section is merely exemplary, and any of a number of other names, uses or approaches can be used to accomplish the desired tasks, such as to collect information from a user or display contextual information to a user.

The content section of the “What's New” page allows an editorially-selected and designed page to be displayed to the user, which can be changed daily, weekly, or at any appropriate interval. There may be a single content selection to be displayed, or a number of content selections that can be displayed based on information obtained for the user. For instance, a young female user who typically buys trendy jeans and athletic wear might see a different “What's New” page than would be displayed for an older female user who typically buys business suits and cocktail dresses. The way in which this content is selected will be described below. A major advantage to this approach is that the content displayed to the user is selected and designed to be visually appealing and attractive to the user, relaying information in a way that is much more appealing and entertaining for a user than is typically displayed on a Web site. By using a visual style that is more like a magazine or catalog, it is possible to obtain a higher level of interest and create a better user experience.

The content displayed in the content section can include a number of images with editorial content. These images can link to new tests that the user can take for fun, as well as to provide information that can be used to better personalize the site for the user. In one embodiment, a younger user might see a test presented here for back to school fashions, while an older user might see a test for the latest in adult styles. A user who has indicated a preference for high-end couture might see a different test than a user who has indicated a preference for more budget-conscious selections. In another embodiment, all new tests might be presented to a user, allowing the user to select the test(s) of interest. While all of these tests might be available to every user, the ability to select and target specific tests to specific users on the default page provides the user with an easy way to see content that is of interest to the user, while also allowing merchants using the site to market specific fashions to specific users.

FIG. 3 shows a page 300 containing an exemplary test that can be used to obtain information that is specific to a user. In this particular test, a user is instructed to select the item that appeals most to the user (or that the user is most likely to buy) from each of a number of categories. This provides information about the user that can be used to create a user profile and target content, merchandising, advertising, and other information to the user. Such an approach is not only visually appealing, but also can be used to collect information from a user in a way that is fun for the user. There can be any of a number of other tests used to collect information. For example, the user can be presented with a series of multiple choice questions related to a fun theme, with different funny or interesting answers from which the user can choose. The user can also do a matching, check all that apply, rating, or any other approach known or used for collecting information from a user. In at least one embodiment of the invention, these tests are meant to be presented in a way that is entertaining and visually appealing to a user, such as can be found in various women's magazines, and not simply a formatted laundry list of questions as are presented on other Web sites for collecting information.

After taking the test, the user can be presented with a results page 400 such as is shown in FIG. 4. The FIG. 4 results page 400 includes an editorial content section 402 and a merchandising section 404 in the targeted content section. The editorial content section 402 includes the result of the test 408, such as (here) the type of impulse shopper that the user tends to be, along with a description 410 of that type of shopper. Such presentation is similar to what can be found in many popular women's magazines. For each type of test result, the merchandising section 404 shows merchandise that is selected for persons of that type.

The merchandising section is different from the way in which items are typically displayed to a user on the Web in a number of ways. First, the way in which the items are displayed, as well as the text describing those items, is not simply information pulled into a standard template. On many Web sites, selecting items that correspond to a particular category executes a database (or other appropriate) search/query that pulls in items matching that category and displays those items in a standard template, such as in a row, column, or rectangular array. The merchandising panel displayed in the merchandising section in accordance with one embodiment herein is instead created by a person (or persons) with a tool that will be described later, which allows the images and text to be easily placed by a designer onto the page in a way that is visually pleasing to the user, and that can vary based on factors such as the number and size of items, their color, their shape, and any of a number of subjective criteria that a designer might use to create a visually stimulating packaging and presentation of these items. This can include selecting different sizes for each image, overlaying various images, creating and overlaying descriptive text, including related images that are not actually one of the products, or any other items, titles, or text that can be desirable to be displayed to a user for this particular category, namely the “impulsive splurger” in this example. In this way, the items are presented in a way that is closer to that of a fashion magazine or catalog than is typically found on the Web. Further, the items displayed are not simply a listing of all products matching a given criteria or category, but are selected by a merchandiser or other person in charge of selecting items for that category. In this way, the site creates a virtual display for the user using items from a database in a way that is appealing to the user, does not require action on the part of the user to navigate through, and allows the merchandiser to create a package or “look” to be presented to the user that allows the user to see which items can/should go together and makes it easy for the user to select that look.

The illustrated editorial content section also includes links to the other types of test results 412, here the other types of impulsive shoppers. This allows users to see what the other types are, for entertainment or informational purposes. Further, the user can see in the merchandising section 404 those items that appeal to other types of shoppers. If, for instance, the user has a friend that is an “impulsive but practical” shopper, then the user can see items or “looks” in the merchandising section that might be more appropriate for the friend. This also can be a more entertaining way to present items to a user. If each type of buyer has ten associated items that are displayed in the merchandising section, then the user can be exposed to fifty products (in 5 categories) with each item being displayed in an attractive way, combined with other related items that follow a story. This can be much more entertaining and effective than simply allowing a user to navigate through fifty items as in most existing sites. As will be discussed later, the items in the merchandising section can also allow the user to view and/or purchase specific items from that section.

As shown, there are a set of arrows 414 in the header bar that allow the user to scroll through the various test results. This is similar to a user flipping through pages of a magazine, or through chapters of a book. Using a magazine or “story” based navigation system, and the advantages thereof, will be discussed in greater detail below. Further, the ad displayed in the advertising section 406 can be selected for the particular test result either manually, such as by an editor or merchandiser, or by using a selection algorithm such as will be described later below.

FIG. 5 shows a test result page 500 for another test, namely which city the user's style most matches. Again, the user is presented with the result and the other possible results in the editorial content section 502. In the merchandising 504 section of the targeted content section, no merchandise is yet displayed, but a visually designed layout of subcategories related to the category (here the city style) that is selected or “active” in the editorial content section 502. For instance, in this example there are a number of subcategories shown that are related to the category “Los Angeles.” Here the subcategories include celebrities, such as Jennifer Anniston and Kate Bosworth, who have the same city style, as well as shops or boutiques, such as Kitson LA, that carry clothes or items in that style category. This allows the site to further narrow the style of the user, and/or to present a wider array of products to the user in the visually appealing story style. For instance, a user might like the Drew Barrymore style, but not the Gwen Stefani style. This navigation approach allows the user to select Drew Barrymore from the merchandising section and be taken to a merchandising section that shows items related to Drew Barrymore's LA style, which might more closely match the user's style. The user can also scroll or navigate through each subcategory, so the user can again be exposed to a wider variety of products in visually arranged and selected virtual displays. This entertaining approach can be used to expose a user to ten products for each subcategory for each category, which can, through use of a magazine-style interface, expose the user to on the order of 250 products or more (in this example) while entertaining the user and collecting information about that user that can be used to target merchandising and advertising. Again, the advertising displayed in the advertising section can be related to the active category or subcategory.

FIG. 6 shows a style tests page 600 that can be navigated to/from the header bar or from any of the test pages. This page 600 includes a title and/or editorial summary in the editorial content section 602, and can include links to the various tests available in the merchandising section 604. As can be seen, the result 608 for each test 606 that the user has taken is displayed next to the link or listing of the appropriate test. This allows the user to easily navigate back to the appropriate result page without having to retake the test, or remember the user's previous result. The user always has the option of retaking the test, either for fun or to update the user's style. Allowing the user to go directly to the user's style page allows a user to easily find a previously viewed item, but more importantly, allows the user to go back to see new items or features for that user's style. For instance, the items displayed for each type of impulsive user might change with the season, such as by showing skirts in the spring and coats in the fall, and can change due to new items, out of stock items, newly featured items, new looks, or any other appropriate reasons for rotating in new items. Alternatively, the editors and/or merchandisers of the site might decide to simply rotate in new items periodically, such as every week, day, etc., in order to keep the site fresh and keep users coming back.

Another way to easily allow a user to navigate to items and features corresponding to that user's personal style is shown in FIG. 7, where selecting a tab such as “My Style File” on the header bar takes the user to a page 700 containing information for the user's style, based on test results and any other information collected for the user. In the editorial content bar can be displayed different attributes of the user, such as the styles or categories selected for the user based on the style tests. For each of the categories in the editorial content bar, related subcategories can be displayed in the merchandising section. This allows the user to navigate directly to a specific category/subcategory for that user's style. For instance, selecting a “Redcarpet Style” category from the editorial content section can display celebrities, designers, boutiques, or any other related subcategories related to the user's red carpet style. This allows a user to easily browse pages for formal events, for example, that match the user's style. Alternatively, if a user is looking for a specific subcategory, such as a specific designer or celebrity, the merchandising section can include alphabet tabs 706 that allow a user to easily navigate to the subcategories starting with a particular letter. For instance, selecting the “C” tab in the merchandising section might display celebrities such as Charlize Theron, cities such as Chicago, and designers such as Chanel.

Selecting one of the subcategories displayed in the merchandising section can take the user to a subcategory page 800, such as is shown in FIG. 8. For this example, the user has selected the subcategory “Charlize Theron” from the merchandising section of FIG. 7. In the editorial content section 802, the page editor can choose to display information about the subcategory, here including photos and a description of Charlize Theron. Additionally, the editor may choose to include information such as the actress' latest projects, current gossip, personal appearances, or any other information that is related to the actress (or other subcategory) that might be of interest to the user. Again, one of the main reasons for the appeal of the site is that the site is enjoyable and has entertainment value for the user. Including information and pictures similar to a fashion magazine, entertainment show, or gossip magazine helps to increase visitation to the site.

In the merchandising section 804 can be displayed items related to the subcategory, here items that are in, or close to, the style of Charlize Theron. The merchandising section also can include images of the actress wearing similar items in order to show further examples of her style or to show how these items might look on her. The merchandising also can include other sub-subcategories, as selected by a person or persons, which can include sub-categories such as boutiques that sell clothes in her style or that she frequently shops, or designers that she frequently wears for specific events. The ad shown in the advertising section can include items related to this subcategory, such as items in Charlize's style or items that she has purchased, or can include ads that pay to be associated with Charlize Theron.

When a user wants to see more information about one of the items displayed in the merchandising section, the user can simply click on (or otherwise select) the desired item 902 in the merchandising section. As shown in FIG. 9, this will bring up a page wherein the item is displayed in the editorial content section 904. It should be noted that this display technique is exemplary, and it should be understood that other methods of displaying the item, such as in another section or panel of the page, in a pop-up window, or in other appropriate display techniques, can be used within the scope of various embodiments of the invention. This allows the user to see the item, which provides the option to enlarge, zoom or rotate the object in various embodiments, while still seeing the other items in the merchandising section. The user also can see information for the item, such as the designer, retailer, price, sizes, a physical description, and/or an editorial description. The user also has the option to mark the item for purchase, such as by selecting an “Add to Bag” or other appropriate selection device. The user also has the option to add the item to a “Favorites” list or section. The shopping bag and shopping book corresponding to these options are discussed below. The ad displayed in the advertising section can be changed from one selected for, or associated with, the specific subcategory to one selected for, or associated with, the specific item being viewed in the editorial content section.

By navigating directly to Charlize Theron in the Red Carpet section of My Style File, the user has not had the opportunity to view other items for that style category. By selecting the “Classic Siren” link on the header bar of the page, the user can navigate directly back to the “Classic Siren” result page 1000 shown in FIG. 10, which allows the user to then view other subcategories for that style category or view other results categories, such as “polished perfection” if the user feels classic style is not appropriate for a particular event, or simply wishes to see what is new or available for the other styles.

Another way to present information and merchandising through a user is shown in the example of FIG. 11. On this page 1100 is shown information available when a user selects a “People” option, such as the People tab shown on the header bar. Such an approach allows a user to view the site in a way that is similar to a celebrity, people, or fashion magazine. For example, the targeted content section 1102 is shown to contain images and blurbs on a “What's New” page that link to articles, pages, items, and other information related to various people. These people can include celebrities, designers, stylemakers, editors, other users, or any other class or group of people for which information can be displayed advantageously. These categories of persons also can be reached through appropriate links or other selection options in the header bar. Using this approach, the first thing the user sees is a layout that is similar to the cover of a women's magazine such as People or InStyle, where photos of people, items, places, events or other categories are displayed in a visually appealing way with text and other content that is of interest to the user, and makes the user want to browse through the various sections. The “What's New” section can be updated regularly in order to maintain a high level of interest in the site. As shown in FIG. 11, the page may include virtual screenshots for some of the categories, allowing a user to preview what will be shown for those categories. In this way, merchants and editors can catch the eye of users who might otherwise not select an option based on a personality. For instance, a user might not associate her style with Holly Hunter, but might be interested in the handbag shown on Ms. Hunter's preview page. This is another way to allow a user to quickly “flip through” the site without having to navigate through each page or guess what will be shown if the user follows a link, as in many existing sites. Another way to display content on such a page is to include articles about cities or celebrities, such that when a user wants to read the story, the user will also see items for those people or places, or at least links to items for those people/places. For instance, the item on the page for Diane Lane might instead include an eye-catching phrase such as “Diane Lane's Secret” which, when selected by the user, opens a page where the story is displayed in the editorial content section, while items or other content associated with Diane Lane is displayed in the merchandising section. Alternatively, the “What's New” page might have an item on Mississippi that, when selected by the user, links to a story on Mississippi in the editorial section, but includes Mississippi-related links and content in the merchandising section, such as a link to Faith Hill and her “country-inspired eclectic styles.”

Since a user might be interested in other people not featured on the “What's New” page, the user can click a link on the header bar of the “People” tab to show a category of related persons, such as is shown on the celebrity page 1200 of FIG. 12. This page can display a view of every celebrity for which the site contains content. As shown, the list can be sorted through alphabetically by scrolling or by selecting the appropriate alphabetic tab. There also can be a number of other ways to go through the celebrities, such as a search function based on name, hair color, occupation, or any of a number of other search options. Also, there can be a list of categories in the editorial content section or merchandising section that allows celebrities to be displayed by category. The list of categories also might be expandable to include subcategories. For example, the list might include an option for “Red Carpet Styles,” which when selected shows subcategories such as “Classic Siren.” The user then can go directly to a page displaying celebrities (sub-subcategories) for the Classic Siren (subcategory) Red Carpet style (category). When a user selects a person displayed for the selected category/subcategory/etc., a page will be displayed that is related to that person, such as the page 1300 displayed for designers Dolce & Gabbana shown in FIG. 13. This page can be used to display images and editorial content, related categories and subcategories, related items, merchandise from those designers, or any other appropriate material or information related to those designers. As shown in FIG. 13, the page 1300 can display the current “look” or current items from these designers, which can be assembled or purchased through the site.

While some users may be interested primarily in celebrities and other people, other users might be more interested in fashion first. These users might be interested in a site that appears more like Vogue or InStyle than People or Vanity Fair. Obviously, for other industries and applications, the content can be arranged by categories that make sense for the particular users and target audience and the arrangements presented herein are merely exemplary. For these users, selecting a “Fashion” tab on the header bar can take the user directly to a “What's New,” “Current Trends,” or other appropriate first page 1400 for fashion, as shown in FIG. 14. For users who have indicated a particular preference, or for whom their viewing history suggests a particular preference, the site is designed to open directly to a page such as the fashion page as soon as a user logs in. If the user chooses to remain logged into the site, as is known in the art, the site automatically opens directly to this page when the user opens the site.

The initial fashion page 1400 is arranged similarly to the People page discussed above, in that it can include images, items, stories, and other information related to the specific category, in this case fashion. The page can display fashion categories, fashion style questions, specific products or product lines, or any other type of information that can be displayed in an aesthetically pleasing way, can be entertaining or appealing to the user, and/or can lead the user to specific categories or products. As shown, the page can show previews of certain categories, such as the preview page for lingerie, or can show specific items, such as the image of slippers shown. The ad shown also can be fashion related.

When clicking on a featured item or category, such as the “Floral Scents” category, a page 1500 will be displayed showing featured items related to that category as shown in FIG. 15. As can be seen, a blurb on what is new or hot in the area of fragrances is displayed in the editorial content window, along with any appropriate images or design, and a selection of those hot fragrances can be displayed in the merchandising section. As discussed before, the images of the featured fragrances are arranged in a way that is not only visually appealing, but uses different image sizes and placements to feature specific products on the page, such as by using a larger image, a more interesting description, or placing the item near the top or center of the section. As can be seen in FIG. 15, arrows or other appropriate selection devices can be used in the header bar (or elsewhere) to allow the user to page through the other categories contained in the “What's New” section for fashion.

Another way to help guide a user through the fashion (or other) section is to allow a user to select a “Category Guides” or other appropriate option from the header bar (or elsewhere) that brings up a category guide page 1600 as shown in FIG. 16. On this page can be displayed a number of fashion categories in the editorial content section, as well as images or other visually appealing selectable devices in the merchandising section. Such an approach allows a user to quickly and easily navigate to items that might be of particular importance to a user at that particular moment. For instance, the user might be looking for a belt to match an outfit. By presenting a belt category, the user can navigate directly to a page containing only belts. Instead of displaying every available belt, however, the user can be presented with a visually appealing display of selected belts, which can be displayed based on user preference information. Alternatively, or in addition, the belt page can display an assortment of subcategories, such as “Formal,” “Business,” and “Casual” that can direct a user to a virtual display of belts that are more appropriate for the user at this point in time. The user also can select other categories, such as specific designers or boutiques, which might be useful when buying a gift for a person who has a preference for a specific type or brand of merchandise. As shown, this page (or any other appropriate page) also can feature a link to a test or other information gathering page that might be useful in displaying targeted content to the user for this category. For instance, if the user is shopping for handbags, a test might be displayed that figures out whether the user is more likely to buy a high end designer bag, a custom bag from a private designer, or a practical and inexpensive bag, such that an appropriate selection can be displayed to the user. A test or questionnaire also can be included to determine the type of event/item/etc. for which the user is shopping, in order to present more targeted options, which might not necessarily fit into the user's typical style, wants, or needs. For instance, a typically frugal shopper might be looking for a designer item after receiving money for her birthday. By obtaining this information, the merchandisers can more easily present items that will be of interest to the user at this point in time.

Another option can be to provide a link to a test that determines the mood, feelings, and/or attitude of the user at this point in time. For instance, a user that is happy or celebrating might be more likely to splurge, or follow another shopping pattern as indicated by the user's profile, such that more extravagant items should be displayed. The ability to determine not only the individual style, habits, and preferences of the user, but the present condition of the user, can allow items to be selected using dimensions that have not been used before to classify and/or select items to be presented to a user in an online environment. The closer the user's profile can become to the wants, needs, desires, feelings, and mood of the shopper at that point in time, the more the site can act as appropriate entertainment and a personal shopper for the user. The site can better determine the content and/or categories to present to the user. This virtual intelligence can greatly improve the overall user experience.

Another dimension by which to display items to the user is to group items by trends, feelings, emotions, colors, or any other way in which user might select, identify, or desire to view items or other content. For instance, the page 1700 shown in FIG. 17 allows a user to view items in some of the latest fashion trends, such as “Bohemian” or “Velvet.” As shown in FIG. 18, selecting one of these categories will bring up a page 1800 displaying items related to that trend, such as the velvet-related items displayed in FIG. 18 for the “Best Velvet” trend. By associating items by trends, and by emphasizing the latest trends, merchants can get users interested in items, such as velvet Dolce & Gabbana hats, that the user might not have otherwise considered, or even viewed simply when presented in a list as on other sites.

The selected trends can be even less conventional, such as “Happy,” “Flirty,” “Revenge,” or any other category that can have items associated therewith but can be eye-catching and/or of interest to the user. For instance, if the user selects a category such as “Flirty,” the user might be directed to a page with articles about flirting, a flirting-related quiz, links to places that are good for flirting, items that would be good to wear when flirting, or any other associated content. This allows a user to view content related to the user's mood, or simply to present interesting content, while still allowing merchants to display relevant merchandise to the user. In this way, a user who might not intend to shop for shoes at all might instead take a quiz on flirting, but then take an interest in the high heels that are displayed with the results of the flirting quiz.

While some shoppers might be up on these latest trends and fashions, other shoppers might not be sure what is currently “in style,” or even know which style would look the best on them, is within their budget, is appropriate for an event, or any of a number of other questions. As such, the site can present an advice option such as is shown in the “What's New” advice page 1900 shown in FIG. 19. While some women might like celebrity magazines, and other women might read fashion magazines, still other women might enjoy advice columns and other more informational content. In order to present entertaining and relevant content for these users, the advice section includes columns, advice, how-to's and quizzes that present information that is relevant and helpful to the user. As shown in the targeted content section of FIG. 19, the advice page 1900 features categories or items such as advice on which lip products “not to wear,” how to fight sun damage, how to “add some pop to your neckline,” or advice on how running can improve the health of the user. Each of these categories then can lead to pages with relevant content, as well as items related to that content that might be of interest to the user. For instance, selecting the “neckline popping” advice item can bring up an advice page 2000 such as is shown in FIG. 20(a). On this page 2000 is displayed an article on pendants, and what currently is the trend in necklaces. Also shown are a number of items that fall within this style of neckwear. In this way, the user is shown “hot” items selected by merchandisers or other fashionistas that the user might not have known about or otherwise considered. Further, the user might not otherwise have known if such items were in style. In this way, the site provides a service to the user while also allowing merchants to present their wares to the user.

Another way to present these advice options to a user is shown in FIG. 20(b). On this page 2002, a number of popular categories are displayed, whether all or a selected subset, whether or not the categories are new. This allows a user to browse specific items, as well as to return periodically to see the latest trends. For instance, a user might check the “Lip Service” category periodically to see what the latest trends and products are in lip wear. Other categories such as “Pretty in Pendants” might not be featured very long, as a pendant trend might die out such that pendants are no longer featured on the site. In its place might be a new category of neckwear that allows the user to view and shop the latest trend in neckwear. As shown in FIG. 21, selecting one of these categories brings up a page 2100 for that category that can contain articles, items, subcategories, or other content for that category. The user also can use arrows in the header bar, or other selection devices, to page through the other features trends or categories.

While many of the above approaches are entertainment oriented, in order to provide content of interest to the user in addition to merchandise, still other users may simply wish to browse online catalogs for their favorite stores of boutiques. For many designers or boutiques there is nothing available like any of the sites described herein. For instance, someone wishing to purchase an item from Donna Karan can go to the Donna Karan Web site and will be presented with a series of items in different collections. If a user actually wishes to see the cost of an item or shop for that item online, however, the user is currently directed to another Web site (currently eLuxury.com), which simply presents available Donna Karan items in the array-organized, search-oriented style of other existing shopping Web sites.

A site in accordance with various embodiments of the present invention, however, can utilize a “Stores” tab, or other appropriate selection device, for directing a user to online catalogs for a variety of stores. An example of such a page 2200 is shown in FIG. 22. The page 2200 includes in the targeted content section a number of items related to featured brands and stores, such as Anne Klein and Ellen Tracy. The page 2200 also can include links or other selection devices allowing a user to browse by brands or stores. For instance, selecting the “Stores” option can bring up a page 2300 such as the one shown in FIG. 23, which displays featured stores and has an option to display all stores contained on the site. The featured stores, as with other pages and categories, are selected by an editor, based on the user profile, or selected based on any of a number of other selection approaches. Selecting a store brings up a page 2400 that is specific to that store, such as is shown in FIG. 24. This page 2400 can include items that are selected to be featured for that store, arranged in a visually appealing way and containing content and text that is relevant for the user. The page 2400 also can contain a description of the store, or a story related to the store, for users who might not be familiar with the store. The page 2400 also can include arrows in the header bar (or other appropriate selection means) allowing the user to page through the virtual displays for the various stores (whether featured, selected, all, etc.) to browse the types of items available from the various stored and see stores that the user might not be familiar with but offers merchandise that is desirable to the user.

When a user sees an item in which the user is interested, the user can click on that item to obtain more information. As shown and described with respect to FIG. 9, this additional information can be displayed in the editorial content section (or other appropriate location). If the user wishes to purchase the item, the user can select the “Add to Bag” option, or another appropriate selection option, to add the item to a shopping bag, or shopping cart as known in the art. The methods used for selecting the option can be any known or used in the art, such as through manipulation of a computer mouse, keyboard entry, stylus selection, touch screen selection, or voice recognition. The system also can be setup with user information, such as address and credit card, such that selecting an option such as “Buy It Now” will transmit the purchase information to the merchant when the option is selected by the user, with no other steps necessary on the part of the user.

For those embodiments of the invention where the items are placed in a shopping bag, the user can look at a shopping bag page 2500, such as is shown in FIG. 25, at any time by selecting an appropriate shopping bag option. One such option is a shopping bag icon 2502 displayed in the header bar. The shopping bag page displays a listing of all items selected for purchase, and can include any other relevant information, such as images and/or descriptions of the item(s), categories from which the items came, suggested accessories or related items, lists of items other people who bought this item have bought, of any other information that might be relevant for the user. The page also can include an option for each item indicating whether the item is being purchased for the user or for another person, such that the site can update the user profile appropriately. By tracking the items that a user purchases for himself/herself, merchants can better suggest items that might actually be of interest to the user. The site also can track the type of items that the user buys for other people, in order to suggest more appropriate gifts. In some embodiments, the site allows the user to specify which person is receiving each item, such that the site can develop a profile for each person for whom the user buys gifts. In this way, merchants can better recommend items when the user specifies that a gift is being sought for that particular person. The site maintains a list of these friends (in a social network as described below), such that items can be suggested when that friend is selected. The site also can allow the user to take tests with the friend in mind in order to better develop a profile for that friend. Alternatively, the user can specify the profile of another person as created by that person, as will be discussed below.

As shown in FIG. 25, the site can provide a “Buy Now” link for each item in the shopping bag. This allows the user to only buy those items that the user intends to purchase at this instant, while retaining the other items in the bag for later purchase (assuming later availability). The shopping bag also can provide the ability for the user to put an item on hold. By selecting the “Buy Now” or other appropriate option, a new panel or window can be displayed, such as the window 2600 shown in FIG. 26. This window contains purchase information directly from the merchant offering the item. This allows the user to see what is in stock, what sizes, colors, etc., without cluttering up the main site. Further, this allows the main site to act more like a portal without actually having to be a merchant site itself, which must accept payment and/or maintain inventory. As can be seen in FIG. 26, a header bar is presented in this new window that allows the user to scroll through the items in the cart so that they can be purchased individually without having to go back and forth between the main site and the merchant site(s).

In alternative embodiments, the shopping bag can allow the user to buy each item through the site without being directed to another site. The user can simply select which items to buy, such as individually or using a “buy it all” option, and then enter payment information directly into the site, which can be submitted to finalize the transaction. As discussed above, the user can have the option of storing payment and/or shipment information on the site (actually in a database, data store, or other storage device that is accessible to the site, or alternatively in a file such as a cookie stored on the client's device), which can allow the user to purchase an item simply by selecting the “Buy Now” option. The site can still present a confirmation screen that allows the user to confirm the shipping address, etc., and/or that allows the user to select the person/address/etc. to receive the address and the method of payment (stored or otherwise) to be used for the transaction. There are any of a number of other ways known and/or used in the art for collecting payment and enabling transactions online, any of which can be used in accordance with various embodiments of the present invention.

Instead of adding an item that the user does not intend to purchase immediately to the shopping bag, the user can instead choose to add the item to a shopping book or other appropriate item saving/tracking device. When a user selects an item to view, such as is shown on the page 2700 of FIG. 27, an icon (or other selection mechanism) can be shown that allows the user to add the item to the user's favorites, and/or store the item in the shopping book. Such an icon 908 is shown in FIG. 9. Once an item is stored to the shopping book, or another appropriate storing location or mechanism, a second icon 2702 can be displayed, as shown in FIG. 27, that indicates that the item (or category, content, or other object) is already stored in the shopping book.

An exemplary shopping book is shown on page 2800 of FIG. 28. A user can access the shopping book by any appropriate selection mechanism, such as by selecting a shopping book icon 2802 from the header bar. This particular shopping book is broken into two sections, although any of a variety of sections or displays could be used as appropriate. On the left “page” is displayed information about the user 2804, which can include a picture or avatar for the user, along with personal information or any other appropriate objects. The left page also can include links to any profile information for the user, as well as categories 2806 in which the user has added items to the shopping book. The left page also can include any of a number of other types of information, such as friends, other profile, saved content, a calendar of important dates for which gifts need to be purchased, or other appropriate information. The right page is shown to display those items 2808 the user saved to the shopping book. The right panel can display all saved items, or items saved for a particular category. The user can select a category from the left page to be displayed on the right page. Alternatively, the user can use the alphabet tabs to locate specific saved items. The shopping book also can have other locations mechanisms, such as search tools or other devices known or used in the art for locating information online. The shopping book can allow the user not only to store items of interest, but to store content, test results, people, places, or anything else on the site that the user might wish to revisit or share on a subsequent visit. The user can keep this shopping book private, or in some embodiments can select to make the book (or portions thereof) accessible to friends or publicly available.

When a user finds a page that might be of particular interest to a friend, acquaintance, or other person or organization, the user can share that page with a user using an appropriate selection device for that page, such as the “Email this page to:” option shown in section 112 of FIG. 1. Using this device, a user can enter an email address and select a send device, such as the page/book icon shown in FIG. 1. Alternatively, there may be a dropdown list, selection list, etc., of others to whom the user has selected to send pages (for instance, those friends included in the user's contacts or shopping book). If others are listed, simply selecting the listing, image, or other device for that user can send the page to the user. By “sending the page,” a number of things can be meant, such as sending the person a link to this page, sending the person an HTML-encoded email containing a version of this page, sending the person a screenshot of this page, or any other appropriate way to present or direct the person to the information on this page. In one embodiment, selecting the “Send” icon, whether or not an email address is submitted on that particular page, opens up a new page 2900 (or new panel, section, or window) as shown in FIG. 29. On this page 2900, the user is presented with a standardized-looking email messaging option that includes the user's return address (which may or may not be able to be changed for a number of privacy and security reasons), the address(es) of the person(s) to receive the page, and a message field allowing the user to send a message to the person. A default message can be included here for the user, as well as to allow the site editors/publishers/etc. to include more “marketing-friendly” language to attract this person to the site. There can be any of a number of other options on this page, such as the ability to add links to other pages or items, include links to the user's shopping book, or any of a number of other appropriate options that would be known to one of ordinary skill in the art. The user also can have the option of sending a duplicate message to the user (cc'ing himself/herself), or this can be done automatically. Alternatively, the site can retain a listing of sent messages, pages, or links. The messaging can be done using any appropriate messaging technology known or used in the art, which may be part of the software or hardware for the site, or can default to use the user's own default mail program, such as Microsoft Outlook or Gmail. The ability to use a default mail program is well known in the art and will not be discussed herein in detail.

An option that provides another marketing opportunity, while keeping the home page (or other user default page), fresh is a “Daily Treat” or featured content/item, such as is shown in the targeted content section 104 of FIG. 1. Such an option allows items, merchandise, or other content to be displayed to the user initially upon visiting the site. Although shown in the targeted content section, the “Daily Treat” can be placed anywhere on the page, such as in the header bar or in a separate section. The daily treat also can be placed in a pop-up ad or other advertising device, although this may be less desirable for the user. By selecting the “Daily Treat” option, the user can be directed to a “Daily Treat” page 3000 such as is shown in FIG. 30. On this page is displayed content 3002 for the treat in the editorial content section, which for a product can include a picture and description of the item, the price and store offering the item, and the ability to add the item to the shopping bag or shopping book. Displayed in the merchandising section is content 3004 that is related to the item in the targeted content section. This can include items selected by the editors/merchandisers/etc. specifically to be featured with that item, or other items in a category or subcategory containing that item. If other category or subcategory items are presented, the user again has the ability to page through other related subcategories, etc. The user also has the option of paging to other featured items, if they exist, or to scroll to past featured items.

The item or content featured as the “Daily Treat” can be selected in any of a number of appropriate ways. For example, one item can be selected each day to be presented to all users. A number of items can be selected, with the item shown to the user dependent upon information such as the profile information about the user. The item also can be related to items or persons in the user's shopping book or shopping cart. Any of a number of appropriate algorithms can be used that use factors such as these and others to select and target items to be displayed to the user as the daily treat. Examples of item selection algorithms will be presented later herein. In another embodiment, the item is not switched daily, but is set to change each time the user logs into the site. For example, the site can track those items that have been displayed to the user, and can use an algorithm to select a new product each time the user logs in. Alternatively, there can simply be a list of featured items, and each time the user logs in that user views the next item on the list. Any of a number of other selection approaches can be used accordingly.

The “Daily Treat” also can include an option, whether on this page, the shopping book, the header bar, or any other appropriate location, that allows the user to select to receive the “Daily Treat” in the form of an email message, text message, or any other appropriate mechanism that can be delivered to a computer, cell phone, mailbox, or any other appropriate way of receiving such content. The site also can include the ability for the user to receive any other such content, such as a daily message including new content or merchandise, reminders of new looks for the seasons, notifications of new lines or products for any of the designers or brands saved in the user's shopping book, new style tests, or any other appropriate content for which the user might wish to be notified.

One advantage to the story-based approach used in various embodiments of the invention described herein is the ability for the user to view “Sub-chapters” in the story. This is a fundamentally different approach to content navigation than traditionally has been presented to users on the Web. Using an example such as is described above, a user can navigate to a category using any of a number of approaches. For any category, there can be a number of subcategories that can be paged through by using an appropriate paging device, such as the arrows discussed with respect to the header bar. Once the user navigates to a subcategory of interest, the user can have the option of paging through subchapters in that story. An example is shown on the page 3100 in FIG. 31. Here it can be seen that the user navigated to a “What's New” page, such as by selecting the “What's New” link 3102 on the header bar. The user then navigates to the “Fresh Fragrances” page through any of the means described above (or otherwise), such as by taking a style test, selecting an option from the “What's New” page, or paging through the “What's New” chapters using the paging arrows 3104. Once here, the user has the option of flipping to other pages or subchapters in this category, such as by selecting a “Turn the page” icon 3106 as shown in FIG. 31 (although any of a number of page navigating approaches can be used to move to the next subchapter).

As can be seen in FIG. 32, a new page 3200 can be displayed showing the next subchapter for this chapter. In this case, more fragrance merchandise 3202 is displayed that has been selected for the “Fresh Fragrances” section. Again, it should be recognized that when the present disclosure uses a term such as “a new page is displayed,” it should be understood that this does not necessarily mean that an entirely new page is displayed, but could include simply the presentation of new content in one or more of the sections, such as by using a frames-based or other approach capable of refreshing or displaying new content on only a portion of the page. As seen on the page 3200, the category content is still displayed in the editorial content section (although this could have been changed), and the category paging icons 3204 are still displayed, such that the user still page easily page to the next category or chapter. The page also displays another “Turn the page” icon 3204 that can allow the user to flip back to the previous page or subchapter and/or to any additional page(s)/subchapter(s). This is similar to allowing a user to easily flip to a section or chapter of a magazine, catalog, or book, and be able to flip through the section subchapters/sections of that chapter without losing his or her place in the magazine, etc. Such an approach is not typically used on the Web, which relies predominantly on tree- or link-based navigation systems, and can be advantageous and desirable to the user, editors, designers, merchandisers, and anyone else associated with the site. The story-based navigation system in many of its embodiments will be discussed in detail below.

Relating to such a site or content repository, which cannot only be Web-based but can be setup for any other appropriate display and/or communication approach, such as wireless networks, intranets, extranets, cell phone networks, handheld device networks, or other appropriate approaches, many of the features discussed above with respect to the fashion example and various embodiments will be described below in greater detail. These sections are not meant to limit the scope or number of patentable inventions herein, but are merely meant to provide further details for specific sections or technological areas.

Improved User Experience

One of the primary advantages of the layout and navigational aspects of the present invention is the improved overall user experience. By utilizing three panels (in one embodiment) of targeted and related editorial content, the site presents the user with different types of related information that is of interest and visually appealing to the user. Further, including these sections in a story-based approach with pagination control and other navigation approaches discussed herein, allowing the user to “page” through the site as if paging through a magazine or catalog, provides the user with a comfortable and friendly feeling such as the user would get if browsing a favorite magazine instead of an existing Web site. The Editorial Content panel is used to present the user with content for the chapter/subchapter/page of the story in a way that is concise and visually appealing, and that ties in directly with the story line. The merchandising panel presents the user with a pre-selected, organized, and stylized/designed collection page, related to the editorial content, that includes items and content that is relevant and of interest to the user based not only on the story line, but on the profile, preferences, tastes, and/or styles of the user as obtained through fun quizzes and interactive tests or games that the user might tend to take anyway for entertainment purposes in magazines such as Cosmopolitan.

The advertising panel is used to allow advertisers to target users based on the content and collections displayed in the other panels, as well as the preferences of the user, the profile of the user, and/or branding rules as discussed herein. The overall appearance of the three related content panels then can be more like a prearranged and selected visual design that might be found in a magazine than a standardized, search-based presentation on most standard Web pages. The overall visual style, along with the ability to page through these collections and follow a storyline, provides a user experience not before seen in an online environment that greatly changes the way people shop and browse online, as well as the way content providers target information and merchandise to users. The information contained in these panels, the way these panels fit into the storyline, and how a user can page through these stories is discussed in other sections herein and will not be discussed here in detail.

Editorially Generated Online Category Guides

As discussed above, the site presents a user with online category guides that are selected by a person such as an editor, designer, merchandiser, stylist, or other person knowledgeable in creating and selecting related items and presenting them to a user in an entertaining, informative, and visually appealing way. These category guides include a number of Editorially- and/or Merchandise-based groupings of products that are presented in a desirable way, instead of a generic set of search results as is obtained on the majority of Web sites today. As discussed elsewhere herein, a group of editors get together to come up with interesting and relevant category guides. The editors (or other appropriate persons) then determine what type of user would be interested in these guides. A number of sub-pages and sub-sections are then created in each guide, with each level of the guide including sections that are of differing relevance to a user. As a user is navigating or paging through a guide, the user is guided only to those pages, chapters, or sections that are determined to be relevant to the user. This is appealing to persons without much time, who prefer to see only specific types of items, or who appreciate a more tailored experience. At each level, however, the user has the option of paging to other pages/sections/chapters of the guide in order to browse other areas, which may or may not be as relevant but might be of interest to the user. In this way, the user receives as little or as much tailoring as desired, and is presented with as little or as much information or content as desired, without using a clunky link- or tree-based interface that has little visual style and that cab be frustrating to navigate.

Matching Using Connectors

One of the ways in which content, such as merchandise and service offerings, is targeted to a user, or “matched” with a user, is through a matching system. A matching system can be a combination of hardware and software, which can reside on a server, client, remote server, remote network, networked server, or any other appropriate location wherein queries, commands, reads, writes, calculations or other necessary operations might be executed for an input signal or information in order to generate a match profile, match suggestion, match list, match table, or any other appropriate place for placing and/or storing matched results, such as matched content, for a user. The matched content, or at least identifiers for that content, can be stored for a user using any appropriate technique known or used in the art, such as by writing the information to a file, a data table, database entries, cookies on a user/client machine, or a temporary object on a content server.

A matching engine is used to match a user to specific content. This engine can use any appropriate rules, algorithms, or other methodology for matching a user with content. For example, the matching engine can look at results obtained through various style tests as discussed above. The engine can use these test results to match the user with content, such as pages, categories, or chapters of merchandise that have been identified to be of probable interest to someone with those test results. The matching engine also can look to other test results or information about that user to match the user to specific content.

As an example, the engine might look to a “Red Carpet Style” test result to determine that the user has a classic style when it comes to formal wear. The test engine might also look to the age of the user to determine which items of the classic style are most likely to appeal to a user of that age group. Further, the test engine might look to a budget profile in order to recommend items that the user likely can afford, or at least might have an interest in purchasing. Further still, the user might look to a color profile for the user to select items of a particular color. The algorithm to be used to match items to a user can be specified by an editor or merchandiser, and there can be several algorithms used to match the user to specific content. For example, an algorithm used to suggest fitness wear to a user might be much different than an algorithm or rules used to suggest handbags or skin cream. Further, certain types of information might be much more relevant for some categories than others. For example, whether to match the user to acne medicine or anti-wrinkle cream might be dependent upon age, but may not be affected at all by the color preferences of the user.

An algorithm can be setup using a front end or interface for the matching engine. In such an interface, an editor or merchandiser selects an item or category of merchandise. The editor or merchandiser then sets up rules to be used in matching the user, such as by selecting specific profile criteria or test results that are related to specific items in that category of merchandise. Means for selecting rules or criteria to be used in an algorithm are known in the art and will not be described herein in detail. Further, software and hardware used for creating and executing such an engine would be obvious to one of ordinary skill in the art. Once the merchandiser has selected the appropriate matching criteria for each item, the merchandiser publishes or “activates” that algorithm for use in matching users with products. The merchandiser always has the option of updating these criteria/algorithms as additional information becomes available. Content and matches also can be updated as items go out of stock, as new items can be displayed and new matches created. For each user, the content matched to that user might also change as the profile for that user includes more information. As the profile gets closer to the style of the user, and includes more criteria that can be used for matching, the results of the matching engine can be improved.

As discussed above, products can be linked to the user as soon as the user inputs profile information and/or takes a test. The links to the matches will be referred to herein as “connectors.” These connectors are virtual links that match a user to specific products or other content as soon as any information is obtained for that user. Each time additional information, such as a test result, is obtained for that user, additional connectors are automatically generated for that user. These connectors can be generated when the profile is updated, such as by adding identifiers to a data table, or can be generated using the profile when needed. For example, a connector or set of connectors can be generated when a user identifies which type of shoes that user prefers. Alternatively, the result of that style test can be stored in a data table and the connector only generated when shoes are to be shown to that user. In another embodiment, the test result itself is the connector, linking the user to a specific category of items based solely on the result. There are any of a number of other ways for maintaining these connectors or matches for a user as would be obvious to one of ordinary skill in the art. These connectors can be explicit links or implicit links. Further, a user might have both implicit connectors, created by obtaining a test result, and explicit connectors, created by the user actually selecting an item or category, for example. By obtaining a connector to an item, category, or other content, the user also can be matched or connected to other categories, items, or content as discussed later herein.

Story-Based Online Navigation

As discussed above, one of the unique and advantageous aspects to many of the embodiments of the present invention is the story-based online navigation approach. Presently, online content is displayed using a flat tree or link structure, where a user viewing a page is capable of going to a new page using any of the links on that page. On the new page, the user is presented with a new set of links that links to a new set of pages. Oftentimes, it is difficult for the user to navigate back up the tree to find a previous page. While browsers typically offer “back” and “history” style options as known in the art, a user might not remember exactly where an item was found, or may have viewed many pages that are difficult or at least time consuming to navigate through. Further, a user might be viewing the pages on a cell phone or other device with (currently) limited memory that might not be setup to store a long history of links. While the user can always open the pages in new browser windows in order to keep his or her place on a previous page, this has proven to be undesirable to a user, is difficult or unnatural to navigate through, and consumes system resources such that the overall user experience can be slowed to the point of frustration.

Systems and methods in accordance with embodiments of the present invention overcome these and other deficiencies in existing approaches by using a story-based online navigation approach. As mentioned above, the content on a site is set up using different levels, such as:

Story
Chapters
   Subchapters
      Pages
         —or—

Content
Categories
   Subcategories
   Sections
      Any of a number of other names or level breakdowns can be used for such a navigation structure. Benefits to such a navigation system include the ease of finding and navigating through content, ease of presenting content of interest to a user, and a more pleasant and entertaining user experience. As discussed above, it has been found that a magazine or other story-based approach can provide more entertainment and a more pleasant user experience for users, particularly female users, on the Web that is more like a magazine or catalog that the clunky search and link based sites currently available.

A navigation section, pagination section, or story-based navigation module can be displayed for any pages on the site containing editorial content. As shown in FIG. 33, the header bar 3300 can include a main navigation bar section, which can include tabs 3302 and/or links 3304 to allow the user to page to specific stories. The header bar also can contain a sub-navigation bar 3306, or sub-navigation section, that allows the user to page through the various chapters, subchapters, and pages of that story as will be discussed below.

A “Story” is defined in one embodiment as a featured content element for a site that contains multiple related pages that are organized to lead a user along a storyline. A “story” can be, in at least one embodiment, any of the following examples: a test, a stylist interview, a feature section (e.g., “Featured Stars,” “Featured Stores,” or “Featured Occasions”), any “Advice” section (e.g., “Trendwatch” or “Top Ten”), a featured or system-generated person “list” section (which can include Celebrity, Designer, Expert, and Stylist pages), a featured occasion, a featured wedding, a featured maternity article, a featured celebration article, any featured link off a “What's New” page, or any of a number of other such sections.

Stories generated for such use have a set of particular characteristics. For example, stories can be defined as “silos” of pages within the structure of a site. A story can allow a user to remain within the same story or chapter of the site while still being able to “flip” through the pages and/or sub-pages of that story as described above. As mentioned, this is much different and can be a pleasant change from the link- and tree-based structures currently used on the Web. The user can flip through these pages without having to leave the story or chapter. In previous sites, for example, a user wanting to view a product related to a celebrity would have to navigate, or be taken to, a “Things” or “Collections” area of the site because that is where the products reside when displayed to a user. Using the story navigation model, the user can access the relevant content and/or object types and remain within the same story, chapter, and/or subchapter. This story-like approach, which is more like a magazine, is much more appealing and effective than exiting approaches.

Further, using the concept of “stories” allows a visual “theme” to be carried throughout the story, providing a consistent and visually appealing user experience. Many sites have an interesting front page, and may have an interesting look to various frames or panels throughout the site, but eventually devolve into lists or arrayed displays of search-based item results. The continuation of a story, and the ability to easily navigate through and follow the story, allows a graphical element to be carried through the site. This not only provides appealing visuals, but allows the user to ensure that the user is still in that story, and can easily flip to the next page or chapter, or at least knows how to go on with the story, or where to pick up if the user has to leave the story at any point. The location of the graphical elements can vary, allowing for maximum design flexibility, or can be located in a relatively consistent location, providing a level of comfort with the site and easing page design. For example, a graphical element can be located within the story based navigation module in an appropriate location, such as in the left corner before the text string begins.

A “Section” or “Chapter” of a story can refer to any set of pages that contains a discrete portion of content within a “Story.” A section or chapter in one embodiment can be a test result, such as a “Polished Perfection” or “Understated Glamour” section for a “Red Carpet” story. A section or chapter also can be a product category, such as “recommended makeup” or “shoes I suggest” for a featured stylist story. A “Subsection” or “Subchapter page” can refer to any related page within a particular article, article section, or article chapter. A subchapter, for example, can include a page such as a person profile page (e.g., a celebrity, expert, or editor page) within a test result, a store detail page, or a brand detail page. A “Page,” here referring to a page of the story as opposed to a Web page in its common usage, refers to any fourth-level page in a set of story pages (a (4) page of a (3) subchapter of a (2) chapter of a (1) story). A fourth-level page can be, for example, a product detail page that one accesses from a collection within a page relating to a test result.

There can be a number of display rules used for story-based online navigation. In one embodiment, a story-based navigation element can appear in an appropriate location in the user interface, such as in a sub-navigation section of the header bar, which can appear on every page in the site except any non-editorial page. Non-editorial pages can include pages such as the shopping bag, a profile page, a “My Shopping Preferences” page, a “My Account” page and related pages, and any privacy, security, and/or “Code of Conduct”-related pages.

The visual theme of a story can be carried through all levels of a story navigation path until the user decides to leave the story. A visual theme can include items such as the name of the story, or a reference to the subject matter of the story, as well as graphical or other elements that tie in to the subject matter or story line. These elements can be placed at any appropriate location, such as in the editorial content or merchandising sections. A user can remain in a story until the user decides to leave the story. Actions defined as leaving the story can include, for example, selecting a “related pages” link, a “recently viewed” page that is not part of the story being viewed, a “411” link on the page, a tab or sub-tab menu item, any link within the page footer, or any other selectable item on the page (or throughout the interface) that takes the user away from the storyline.

The way a user navigates or “pages” through a story will be referred to herein as “pagination.” Pagination within a story can use selection or navigation elements placed at any appropriate location, such as next to a Story navigation area in a sub-navigation portion of the header bar. Pagination controls can allow the user to flip to the next page, or the previous page within that level of the story and remain within that section of the user interface. For example, if a user is on a celebrity profile page within a Test Result (e.g., Polished Perfection: Cate Blanchett) and clicks the “next” button, the user can flip to the next celebrity, brand, store, designer, or other category featured within that test result/story. If the user is at a higher level, such as a test result page, the “previous” and “next” elements can take the user to the previous and next test result pages within that test. If a user clicks on a product within a collection for a chapter in the merchandising section, such as by clicking on Christy Turlington's collection on her profile page, the user can be directed to a Product Detail page/subchapter, where the “previous” and “next” buttons can allow the user to paginate within the other products in that collection.

There can be any of a number of rules used to control pagination for such a site. For example, the order of pages within an “editorial feature” story can be pre-defined by an editor or editorial group. The term “editorial feature story” as used herein refers to anything that is not system generated, and that is visually-designed and created for interest, entertainment, information, or other such purposes. The only stories that are not “editorial features” can be system-generated features, which can include items such as lists and query results. For example, a user landing on a particular test result within a test “story,” for which four test results are available, might be viewing page “2 of 4.” This result page and its location in the story can be determined when the entire story, or at least an outline or portion thereof, is defined in the site by “Editorial.”

By contrast, the order of pages within a “system-generated” story can be dynamically generated based on, for example, a sort-order of items in a list. For example, a user viewing a system-generated list or array of celebrities can receive pagination that is determined, at least in part, by the total number of objects contained in the list, array, etc., as well as the place of any object in that list that is selected by the user. A user also can select specific ways in which to view these items. A user might decide to view the list by “Most Popular,” whereby the backend system/remote server/etc. can filter the item collection to display those items, for example, that have been viewed most often over a given point in time. The user then might decide to view these items alphabetically, wherein the system can sort the result list by A-Z. The pagination for the final result set then can be reorganized automatically by the backend system to relate to those filtered objects. It should be understood that when the disclosure refers to “backend system” that the system can include any of a number of components known in the art, such as Web servers, data servers, databases, data repositories, content servers, or any of a number of other hardware and/or software components capable of receiving requests or queries, executing those requests or running those queries against the relevant data, then sending the resultant content back to the user, either directly or indirectly.

The behavior of a story navigation module, which can be a software module used to create, control, and/or adjust the navigation for a story in reaction to changing elements in the story or changing requests or preferences of the user, can be similar to that of a breadcrumb trail. For example, a text string can show an informational hierarchy that allows the user to click on “levels” above the page that the user is viewing. A significant difference between the story navigation schema and a traditional breadcrumb, however, is that a breadcrumb trail shows the “absolute” information architecture (IA) of the site, whereas a story navigation module can show a “relative path” IA based on information levels within a story.

In one embodiment of the invention, arrow buttons displayed before and after the page numbers in the navigation area of the header bar allow the user to click on, or otherwise select, the arrow buttons in order to page forward or backward within the pages in that level of the story, such as between chapters, subchapters, or story pages when the user is at that level in the story. A “previous” button can be inactive when a user is on the first page of the story, or can be displayed only when the user is not on the first page. If the user is on the last page of the story, the “next” button can be inactive or not shown. The page that the user is on, as well as the page number, can both be highlighted, bolded, or otherwise emphasized. A graphic located to the left of the story navigation module, pagination section, or navigation portion of the header bar can be user selectable, allowing the user to page directly to the top level of the story. When the user is on the top level of a test story or a feature story, for example, there may be no “previous” or “next” buttons available. Only after a user either completes the test or clicks on an item on the first page of a feature can the pagination area begin to be displayed and/or active.

If a story navigation space or section cannot accommodate all the levels of story navigation that are needed for that particular story, the system can be set up to automatically truncate the names for at least some of the various levels and place a “. . . ” or other appropriate trailer at the end of those names. In one embodiment there is a maximum of 90 characters possible in the navigation space, counting the spaces before and after the colon as well as the colon between the “levels.” The appearance of the sub-navigation bar in at least one example can be in a form such as:

<STORY NAME>: <STORY SECTION>: <SECTION PAGE>: <PAGE NAME>

An example of story navigation is described with respect to FIG. 34. When the user is at the top level of a story, such as a style test called “Red Carpet test,” the pagination module or navigation section 3400 of the header bar displays simply the name “Red Carpet test.” When the user finishes the test and is directed to the test results page, the pagination module or navigation section 3402 of the header bar displays the name of the test as a link, followed by a colon (designating a switch between levels) and the name of the test results page. The linked test name allows the user to easily page back to the beginning of the test (the top level of the story). Also, a pagination section appears showing that the user is being shown test result “1 of 6” and allowing the user to page to the other 5 tests. It can be seen here that the right arrow button is bolded to show that there are further test results that can be paged to by the user, while the un-bolded left arrow shows that the user cannot page back to any previous test result pages (categories) for that test. From the test result page (category), the user might select a specific item or collection to view. By the user paging to this collection, here the “Halle Berry collection,” the pagination module automatically knows to update the header bar 3404, converting the test result title to a link, adding another colon to designate another level shift, and displaying the name of the collection (subcategory) in the navigation section of the header bar. The pagination section also can be updated to correspond to the available subcategories or subchapters of this story, here also allowing the user to page between six pages at this level. Header bars (3406, 3408, 3410) for another example, namely a feature story with related product pages, are also shown in the figure, such as may be displayed when the user selects to view a feature story and navigates through that story.

Contextual Online Searching

One of the primary advantages to approaches discussed herein with respect to various embodiments of the invention is the presentation and use of “Contextual Searching.” Contextual searching allows a user to be presented with content, such as styles or information that is related to, relevant for, or likely to be of interest for a particular user. As discussed above, information can be obtained for a user that is relevant for that user. This information can be obtained through various tests, questionnaires, and other interactive processes to develop a profile of the user. This is different from existing sites that develop a profile through tracking the user's purchasing or viewing habits, which might include items or content for friends or acquaintances of the user that have no relevance to the user's personal style. Alternatively, or in addition, some sites develop a profile by having the user fill in personal information. This information typically is obtained through a non-interesting list of objective questions. Users typically would not like a site where each time the user visited a site the user had to answer a number of questions on a standardized form in order to obtain content that may be of interest. The style tests and other interactive experiences presented to a user in various embodiments described herein allow information to be captured for a user in many more dimensions, and in fun or entertaining ways that entice a user to keep updating or providing information. These additional dimensions that can be used to develop a profile of the user can be limited only by the imagination of the editors of the site. For instance, a style test that asks fun questions about how a user enters a room, or a test where a user selects items that the user is most likely or least likely to buy, enables information to be obtained for that user that would be difficult, if not impossible, to obtain simply through a list of questions presented in black font on a white screen.

When a user profile is created, and as the profile is updated, the user can be presented with items or content that are likely to be more relevant or of interest to the user. These items also are not simply pulled from a database as a result of a query as in existing sites (such as where a user has purchased a wrench for someone else so the user is presented with other hand tools). The user is presented with content and collections of items that have been selected by an editor, advisor, merchandiser, or other person(s) in charge of assembling those collections based on certain dimensions (such as test result categories). These collections also can be visually assembled and organized by a designer, who also can add other graphical or editorial comment to present the collections in an interesting and visually appealing way. This approach to continually providing the user with interesting and visually appealing site content can carry across all object types, including pages, guides, vendors, people, and any other categories, subcategories, sections, items, collections, or other content presented to the user. Even the colors of the pages of the site, the font, the appearance, the organizational or navigational style, or any other presentational or information aspect of the site can be customized for the user based on the user profile. The more the site is personalized to the tastes, styles, and/or preferences of the user, the more the user is likely to come back and spend more time at the site. This is not only beneficial for the user, but for the creators and owners of the site and for the merchandisers and advertisers featuring items, collections, and other content on the site.

The ways in which collections are selected to be displayed to a user can be based on any of a number of rules or algorithms, such as those discussed elsewhere herein. For each category or collection, rules can be setup where a user is matched to categories/collections/etc. based on a hierarchy of test results and/or profile information. For instance, an editor or merchandiser might select those test results and informational pieces that most align with a particular category or collection, then rank those results relative to one another (since it is highly unlikely that every user will have a profile that exactly matches a target profile for one of the selected categories or collections). A merchandiser might decide that a user's style result might be most important, followed by the user's budget and then the user's age. Using this set of rules, a user with this style that was a little younger or older than the target group might still be displayed this collection, while a person of the target age and budget range but with a different style result might not view this page. A determination can be made by the appropriate algorithm which looks at all the selected variables and their relative importance, which then selects a collection that most matches that user. The more collections available and the more information available for the user, the more relevant the collection can be. A balance can be made, however, as a higher number of collections or greater number of tests can provide much better targeting results, but can become unwieldy to manage and can be overwhelming for the user. Information such as user feedback and/or viewing patterns can be used to adjust this balance.

Shopping Book

Another feature available in accordance with various embodiments that can be desirable for the user is a shopping book. The shopping book, as discussed elsewhere herein, can allow a user to select those items that are wanted by the user, are of interest to the user, represent the user's personal style, or any other appropriate reason for saving an item, collection, person, store, or other content item for later viewing by the user or a person wishing to view the shopping book of that user. The user can select a sharing or privacy level for the shopping book, either for the book as a whole or for a section/sections of the shopping book. For example, a user might wish to only allow herself to view the shopping book, only specified persons, only persons in her network, or anybody viewing the site. Further, a user might allow the public to view a portion of her shopping book, such as her favorite designers, but might choose not to share her lingerie or other more personal/private preferences.

A “View Only” mode for a Shopping Book can be presented in a “Shop Together” or other similar section of the site. In one embodiment, a user can view her profile page as other Shoppers see the page by selecting a “Me” sub-navigation element under a Shop Together tab, or by visiting a “Shoppers” list view located under a “Shoppers” sub-navigation element. A user (or “Shopper”) can access other users' Shopping Books by selecting their names, thumbnail images, or other selectable indicia located in the Shoppers area. The user might be see all shoppers who have a profile, only those user for whom the user has permission to view at least a portion of their profile, only persons in the user's network, or only persons explicitly identified by the user. A number of other options and selection criteria can be used as well. An example of a Shopping Book View Only Mode page 3500 is shown in FIG. 35.

As can be seen in FIG. 35, this page 3500 can include a Conditional Image that may not be displayed in “view only” mode. A My Profile selection menu item also may not be displayed in “view only” mode. An ad may be available only in View Only Mode. A “Favorites” section can allow the system to randomly pull a selection of a number (here 2) of items for the user, such as favorite celebrities from favorite celebrity list. If user has not selected any celebrities in her favorites, the system can display any other person object found in her Favorites Lists. If the user has not selected any favorites, the system may not display anything in this space, or may display persons related to items in the list. The page also can have an edit button that is available in an Edit Mode for the book, allowing a user to edit the selections such as by adding or removing items.

Toolbar Shopping Book

Another feature that can be used with sites and systems in accordance with various embodiments of the invention is a Shopping Book feature that can be used with the toolbar in the browser of a user. An example of a Shopping Book toolbar 3602 is shown on the page 3600 shown in FIG. 36. The toolbar can be installed by the user using any appropriate download and/or installation technology known or used for such purposes, allowing the user to select to install the option and approve the installation. Other alternatives are possible, such as a toolbar icon or toolbar button that can be installed to be displayed on one of the existing toolbars of the browser. Such an icon can include a dropdown list (viewable by selecting a down arrow portion of the icon or “right-clicking” on the icon, for example) from which the user can select various options.

A major use of the toolbar, however, is the ability of a user browsing any page on the Web (or other network, site, or page) to have available a number of elements providing options relating to a site in accordance with the embodiments herein. For example, as shown in the example, the user can have “Glam Icons” available from a “Glam Toolbar” that is related to the “Glam” Website, regardless of the page being viewed in the browser. One such icon is a book icon 3604, or “Add to book” icon, which allows the user to add an item from any page on the Web to the Glam shopping book, as will be discussed later herein. Another such icon is a bag icon, “Add to bag” icon, or “Add to List” icon 3606, which allows a user to add an item from any page on the Web to the Glam shopping bag. Another such icon is a heart icon, or “Add to favorites” icon or element 3608, which can allow a user to add and/or view any item on the Web on the Glam Favorites page. Another such icon is an envelope icon, or “Email to a Friend” icon, which allows the user to easily email any produce on the Web to a friend. The user can have the ability to grab some elements as an image of the item, a description, the price, the sizes, the store, and any other relevant information.

Through the user selecting an icon or element such as a “My Little Shopping Book” icon, a section, panel, or window 3700 can be opened such as is shown in FIG. 37. The new window can show a version of the shopping book, described above, which allows the user to paginate through the user's shopping book using “next” and “previous” buttons or any other appropriate navigation elements known or used in the art. This allows the user to view any items, collections, or content that is saved in the user's shopping book. These elements can be added through drag and drop, cut and paste, automatically, or any other appropriate selection mechanism.

Items that were added to the book or added to favorites using the icons discussed above can be displayed in the pages of the book 3800 as shown in FIG. 38. In this example, a pair of Gucci loafers to was added to the “Favorites” section from Amazon using the “Favorites” icon on the toolbar. The Gucci loafers now can be seen in the “My Favorites” section of the shopping book. This item has been saved for the user, and any item in the shopping book can be purchased at a later time by the user simply going back to the shopping book. This is advantageous because the user always has one-click access to the shopping book from the browser, and does not have to remember and navigate to all the sites where the items were originally found.

Brand-Based Online Advertising

Another advantageous aspect to systems in accordance with various embodiments of the present invention is the ability to user brand validation with targeted advertising. As discussed above, ads can be displayed to the user in at least one location, such as the advertising section discussed with respect to FIG. 1. Also as discussed, these ads can be relevant to the content displayed on the page. Other existing sites can display ads based on criteria such as keywords or items purchased by the user. Problems exist with such an approach, however. By simply looking to items purchased by the user, which can include items purchased for other persons, the ads might not be at all relevant to the user. Further, the ad might not have any relation to what is displayed on the page. A user browsing for high-end couture could be shown an ad for dog food or motor oil. Further, there are no (or at least very limited) branding restrictions used for online advertising. For example, a user shopping for Gucci handbags might see an ad for Christian Dior handbags, which can be undesirable or even offensive to Gucci and/or Christian Dior. Branding rules exist for magazines and other static content-delivery mechanisms, and systems and methods in accordance with various embodiments herein can utilize branding rules in an online environment, and can combine this with targeted advertising to generate an ad selection approach that presents ads that are relevant to the user but does not offend advertisers on the site. A Brand Validator can be a software module or other computer-oriented object capable of using both the ad rules and the brand rules to select ads to be displayed next to specific content/collections/brands/merchants/etc. For example, a user browsing designer dresses might see an ad for Jimmy Choo shoes, where the Brand Validator has selected the shoe ad as possibly advertising an item/items that might also be of interest to a user shopping for formal dresses. The Brand Validator might have also had the opportunity to select an ad for Manolo Blahnik shoes, but such selection might have been prevented by a branding rule. For example, if the user was browsing a dress by Gianni Versace, there might be no problem displaying Jimmy Choo shoes alongside the dress, but a branding rule might prevent Gianni Versace and Manolo Blahnik items from being displayed on the same page. Ways for implementing these rules would be obvious to one of ordinary skill in the art in light of the disclosure herein and what is known to one of ordinary skill in the art, such that these ways will not be discussed herein in detail.

FIG. 64 shows a screen 6400 of a layout editor that can be used for brand validation in accordance with one embodiment. As can be seen, the editor (or merchandiser, etc.) can select a product or brand, here Prada. The editor then can navigate to the “Rules” section for that brand using the header bar or other navigation mechanism. The editor can be presented with a number of rules settings (here 5) that can be set or adjusted for this brand. Here, it can be seen that a rule exists wherein any Prada item cannot be displayed next to a BCBG item. There are additional rules settings that allow other rules to be set for Prada. An “Add more rules” option can be used to allow the user to apply as many rules as necessary. There can be a preset limit to the type of rules, such as is shown in FIG. 65. In this screen can be seen the available options for rules in this exemplary system. Any of a number of other branding options can be used as known in the industry. The layout editor can also have any of a number of other options, such as a notes field or work area as shown. When the rules are set, the editor can select to save and apply the rules, which can bring up a window 6600 such as that shown in FIG. 66. The editor then can use a collections view (or similar option) to validate the individual grid collections.

Online Content and Merchandising Tool

In order to generate sites in accordance with the various embodiments herein, it is desirable to have a simple tool that allows the content and pages to be easily and quickly created, updated, and maintained, without the need for HTML or other coding or technical expertise. A system in accordance with one embodiment will be referred to herein as an “On-line Merchandising System Layout Editor.” Such a system can be a live data feed layout editor, used for ecommerce, which can be an “HTML generated” tool. The tool can be used by a designer to create layouts based on data feeds given by our merchants or other entities, which can then automatically generate the code needed to generate the appropriate page(s) for the user.

Such a tool can create a Layout Editor that allows a collections builder, such as an editor, buyer, associate, or other appropriate person, to build collections of merchandise or other content. In one embodiment, a collections builder can locate images for the items to be included in the collection from an image repository such as a Design Handoff folder in a sub-folder related to the type of page (e.g. GUIDE, SIGNATURE COLLECTION). The images for the items or content can be selected by size, resized, colored, rotated, stretched, cropped, split, or otherwise manipulated in any appropriate way in order to display the item or content on a page in a location and way that is functional and visually appealing. In one example, graphics can be cut to allow portions of the image to be grouped with portions of other images, or to place only a portion of the image on the page. Cutting the graphics can include flattening the image and setting up guides so that the collections editor can cut apart the Collection area on the page like a puzzle. The images can be displayed to a user exactly as the images are seen to the designer, so actions such as cutting backgrounds can be acceptable. FIG. 39 shows an example of image cutting for use in a collection. In the case of product images overlapping, such as the handbags shown in the Figure, it may be desirable to cut the images into multiple pieces, such as is shown in FIG. 40, so that all the pieces can be selected to access the proper product or content.

In one process for building a collection, a user creates a new collection using an appropriate screen 6700 in a layout editor or collection building program, such as that shown in FIG. 67. The collection builder can create a new collection, then can enter various information for that collection, such as a main image (logo, etc.), the editorial and internal names for the collection, a description, and other relevant information. Here, the editor has created a collection called “Saks Fifth Avenue Collection.” Once the information is entered, the editor can be presented with an assortment of items 6702 related to that collection. From here, the editor/designer/etc. can select items to be featured in the collection, such as by clicking a checkbox next to an image of the item. The editor can also select an appropriate template for the collection as discussed elsewhere herein. Once the collection builder has created a collection, the builder can select a “Validate Rules” 6802 or other option as shown on the screen 6800 of FIG. 68, in order to determine whether or not the collection is valid. Results for the validation can be displayed to the builder, such that changes can be made where necessary. Once the collection is valid, and the design and layout are complete as discussed later, the collection can be set to be “Ready to Publish,” such that when approved by a final editor the collection can be published to the site. There also can be other options, such as ready for review, etc.

Once the collection is built, it is necessary in at least one embodiment to associate the items/images/content to each product. The selected and processed images can be uploaded, directed, or saved to the appropriate location in the system (or accessible to the system) to be associated with the individual products in the system. By processing the images in this way, the published pages will look, work, and feel as the editor and/or designer intended. A user can select a product or item in the collection and go to the representative product detail page. For example, a collection builder can click on a “Merchandise” tab, followed by a “Products” sub-tab in the layout editor as shown in FIG. 41. The builder then can find the “collections” dropdown menu, and find the name of the collection on which the builder is working. The builder then can select the name and select a “Search by Filter” button. The builder then will see a list of products that should match the same products that were seen previously, and which can have been saved in an appropriate place such as a finished .PSD file on a production server. The builder then can select the first product to be included, which can be displayed in a page such as is shown in FIG. 42. The builder can select a “Click here to Modify this record” or similar button, and scroll down to the bottom of the page until an area called “Editorial Images” is displayed as shown in FIG. 43. The builder then can upload all the images of that product that were selected from the .PSD to the Editorial Images area. The builder then can simply select a “Save Changes” option to finish the product update. As can be seen, this portion of the layout editor also allows a builder to enter or alter text and other information for the product, but in many environments the designer doing the image selection and layout will be different that the editor or other person generating the textual content.

The collection builder can follow the same process for each product in the Collection. When the builder is finished, the “Collections” sub-tab can be selected and the same collection can be located there. The builder then can do a keyword (or other) search for the collection, such as by typing a keyword into the appropriate field, selecting all the appropriate checkboxes (such as for “Don't Publish” or “Publish to Stage” options) and clicking a “Search by Keyword” button. This is also a good way to search for a collection that the builder is having a hard time finding using the Products sub-tab. Once the designer has located the correct collection, the collection can be selected and the designer can select an option such as “Click here to Modify this record.” The designer then can upload any images that are not related to products in the Collection area in the Editorial Images section, which can be the same area used to upload cut images to the Products found in the Collection, and can select to “Save Changes” when finished. The types of images that are uploaded can be items such as text slogans or other graphical elements that are not necessarily product-related. Screens showing steps in such a process are shown in FIGS. 44 and 45.

Next, the builder (or another designer, etc.) can build the collection. Once all the images are uploaded to the collection, the builder can scroll down to the bottom of the page (in this example) to find an area called “Available Layouts.” It should be understood that the scrolling, page breaks, page names, layouts, and other features of this editor are meant to be exemplary, and other ways of designing and laying out the functionality of such an editor would be obvious to one of ordinary skill in the art in light of the disclosure herein. In this particular example, the builder will see a box called “Page 1,” where the user can select an option such as “Edit” or “Edit New Page.” An “edit” link can be shown against a yellow or green background, with an “edit new page” displayed against an orange background.

Then, the builder can be presented with a “Templates” dropdown menu, where the user can select an appropriate template from the list, such as “testResultExtended,” which can point to a “.psp” or other appropriate file. The builder then can be presented with a blank box area and graphics that were uploaded to the collection, which can be displayed on the right side of the screen. The builder (here, most likely a designer) can add graphics from the right side of the screen to the desired locations in the layout area (the blank box area). For templates with specific areas designed to receive graphics, the builder can select graphics of the appropriate size/type for each desirable section of the selected template. If none of the templates match the look the designer is going for, the designer can select a blank or “free form” template, or can create a new template. The builder then can scroll to the bottom of the page to find a dropdown menu. The designer can select an option such as “Featured Product” in the dropdown menu, then be presented with a list of similar products that should be displayed in the collection layout. Screens that can be used with various steps in this process are shown in FIGS. 46 and 47.

The builder then can select the first product to be placed into the layout area, with the processed and uploaded images being displayed on the right side of the page. The builder then can select the images, such as with a computer mouse or stylus, and drag the images onto the layout area. When finished, the builder can do the same with all the products that are displayed in the layout until the entire image is replicated in the grid area of the layout editor. This can be seen for example, in FIGS. 48 and 49. There then should be a layout reproduced in the layout editor that is identical to what was originally designed or intended by the designer. The builder then can simply select an option such “Save Grid.”

An example of the layout editor for these steps is shown in the screen of FIG. 69. Here, the grid view of the collection being built is shown in the panel on the left 6900. In the panel on the right 6902 is shown the various images selected for the product being placed on the grid, as well as information related to that item. The editor module can include various options known to one of ordinary skill in the art, such as “hide grid,” “snap to grid,” “save grid,” and “preview” options. When the collection builder wishes to add another item, the builder can select the next item in the collection, which will be displayed in the right panel as shown in FIG. 70. The collection builder then can drag the image of the item, as shown in FIG. 71, and can place the image on an appropriate location in the grid as shown in FIG. 72. The designer then can manipulate the positions of the items, add content, change colors, and do anything necessary to achieve a visually appealing layout of the collection content.

Another function of the layout editor is the building of guides for the layout of merchandise. In such a process, a builder can locate images in a Design Handoff folder that can be found in a sub-folder related to the type of page (e.g. GUIDE, SIGNATURE COLLECTION). The designer then can drop the mask of each placed image into a trash depository (or simply delete the mask). Each placed image then can be saved in an appropriate folder, or a new folder can be created for a new Guide. An example of a screen for such a process is shown in FIG. 50.

The builder can create sub-folders in the Guide folder for the various pages of the Guide. The product images then can be uploaded. For a builder such as a merchandiser, the builder can access the content by logging into the system using appropriate login information, then selecting the Merchandise tab and the Products sub-tab. The builder then can find the Guide collection by selecting the Guide in the “Collection” dropdown menu at the top of the page, such as is shown in FIG. 51. The builder can select a product in the list that is also found within the layout being working on. The builder can select the product, then select a “Click here to Modify this record” button. The builder then can scroll down to the bottom of the page and find an “Editorial Images” field. The builder then can upload the image by clicking the “Browse” button, finding the image saved in the GRAPHIC ASSETS folder, and clicking “Upload New.” The builder then can enter the size of the image just uploaded, if not determined automatically, into a field called “Name (to the left of the “Image” field) by typing or selecting sizes such as:

a. 95×95

b. 111×251

c. 223×107

d. 223×251

When finished, the builder can select a “Save Changes” button at the top of the screen. This process can be repeated for all product images used in the Guide layout. A screen for such a process is shown in FIG. 52.

A builder (or other designer) than can build the guide, after all the images used in the layout are uploaded to the proper Product records in the system. The builder can click on a “Collections” sub-tab within the Merchandise tab, then enter a keyword of the Guide name into the “keywords” field at the top of the screen. The designer can choose to have all the checkboxes below the “keywords” field selected, then select the “Search by Keyword” button. The name of the Guide should be listed, as shown in FIG. 53. The builder can select the collection and open it by selecting the “Click here to modify contents” button, and scrolling down to the bottom of the page. The builder then can select an “Edit New Page”

The builder will be presented with a new page having a selection menu at the top of link under the “Available Layouts” area, such as is shown in FIG. 54. The builder can select an option such as “Bestof3” in the dropdown menu, such as is shown in FIG. 55. Once the proper template is selected, the builder can see the same layout on the page as is found in the file. The builder then can select “Featured Products” in the “Select” menu at the bottom left of the page, as shown in FIG. 56. The builder will see the same products as displayed in the PSD file. The builder then can select the first one to be used in the layout, and a rollover window will be displayed with a larger image and the associate product name, as shown in FIG. 57. The builder then can go to the upper right corner of the page, find the name of the cell on the left that corresponds to where the product is to be placed, choose the same name of the selection menu, and locate the product name in the list (as seen in FIG. 58).

Once the builder has done this for all the products in the layout, the builder can select a “Preview” option and the designer should see the same layout replicated in the browser window. If not, the builder can make sure the correct products are selected in the dropdown menus. If that does not solve the problem, the builder can make sure that images are uploaded to each product in the system, and that the images are associated with the proper “size” name on the left. Once everything looks right, the builder can go on to the next Guide. If the Guide being worked on has multiple pages, the designer can go through a similar process, but will see a Page Two (or other Page) in the Available Layouts area at the bottom of the Collection. This can be used to create the new page, as shown in FIG. 59.

The layout editor also can be used to build the home page and any content pages. Again, the can be located in the Design Handoff folder in a sub-folder with the date the new homepage will go live. The homepage assets can be located in a “home page assets” subfolder, in separate folders for each day the homepage will be refreshed, such as a “July 22 home page.” There can be a number of places that can change daily, such as seven places in the example of FIG. 60.

First, the builder can upload the necessary graphical elements. An “Editor's Pick” or other appropriate featured collection section can have an image uploaded to the Product, located within this related collection. Another section can include “Today's Featured Finds,” with the image uploaded to the PERSON to whom this collection belongs. Another section is the “Try this Test” section, which can be a module that is not changed every day. If there is an image in the folder, it can be uploaded to the corresponding Test. Another section is a “Treat of the Day” section, which can have an image uploaded to the Product, located within this related collection. Another possible section is a “Star with Style” section that can have an image uploaded to the Person related to the star name. Another such section is a “Get the Story” section that can be uploaded to the related object in the page name. For example, if the name is “story_brand_gap”, this image can be uploaded to the brand record named “gap.” Another section is the “Main Image,” which can be uploaded to the corresponding person.

The builder then can associate items to the homepage. Once all the images are uploaded to the proper location(s), the builder can make the images visible in the Homepage grid builder. In one embodiment, the builder can place Homepage in Lightbox. The builder can find the Home Page using a “site tools” tab and a “Pages” sub-tab. The builder then can click “Lightbox.” The builder then can the item drag into the area on left of screen, which can be called “Drop an Object here to add it to your work area.” The builder then can find all items that need to appear on the homepage. The builder then can associate each item to the homepage, such as by selecting an “Associate” button and dragging the item onto the box on the left of the screen named “Home page,” such that the item should appear in the list of thumbnail items at the bottom of the screen.

The builder then can associate collections to the “Treat” and “Editor's Pick” sections. In order for the proper collection to appear when the “treat of the day” or “editor' pick” product is clicked, the builder can associate the correct collection to these products. To do this, the builder can find the product (both the editor's pick item and the “treat of the day” item) and place them into Lightbox. The builder then can find the collection each item appears in, under the “collections” sub-tab, and can click the “associate” button. The builder then can drag the collection onto the product that belongs in the collection.

The builder then can build the home page grid. To do this in one example, the builder clicks on the “Site Tools” tab, the “Pages” sub-tab, then the Homepage icon. The builder then selects the “Click here to modify this record” button and can scroll down to the bottom of the page under “Available Layouts” and click the “Edit” button. The homepage grid should be displayed, as shown in FIG. 61, where the user can select the item type to be added to the page, such as from the “select” menu at the bottom of the page. The builder then can find the item to be added and select the corresponding thumbnail image as shown in FIG. 62. The builder the can add the item to the proper location in the grid. The builder can drag out the old image and replace the old image with the new image one that just was uploaded to each object type being selected. To finish, the builder can select a “save grid” option.

Another option for such a layout editor is a Merchant Data feed Integration option. Such a feature allows a merchandising team to easily manage inventory by allowing products to be selected from multiple vendors in one easy-to-use interface. These products then can be associated to one or many collections in the editorial side of the site. The merchandise status, price, url, and other related information can be updated daily (or as allowed by the merchant) on the live website, based on information sent in the data feed.

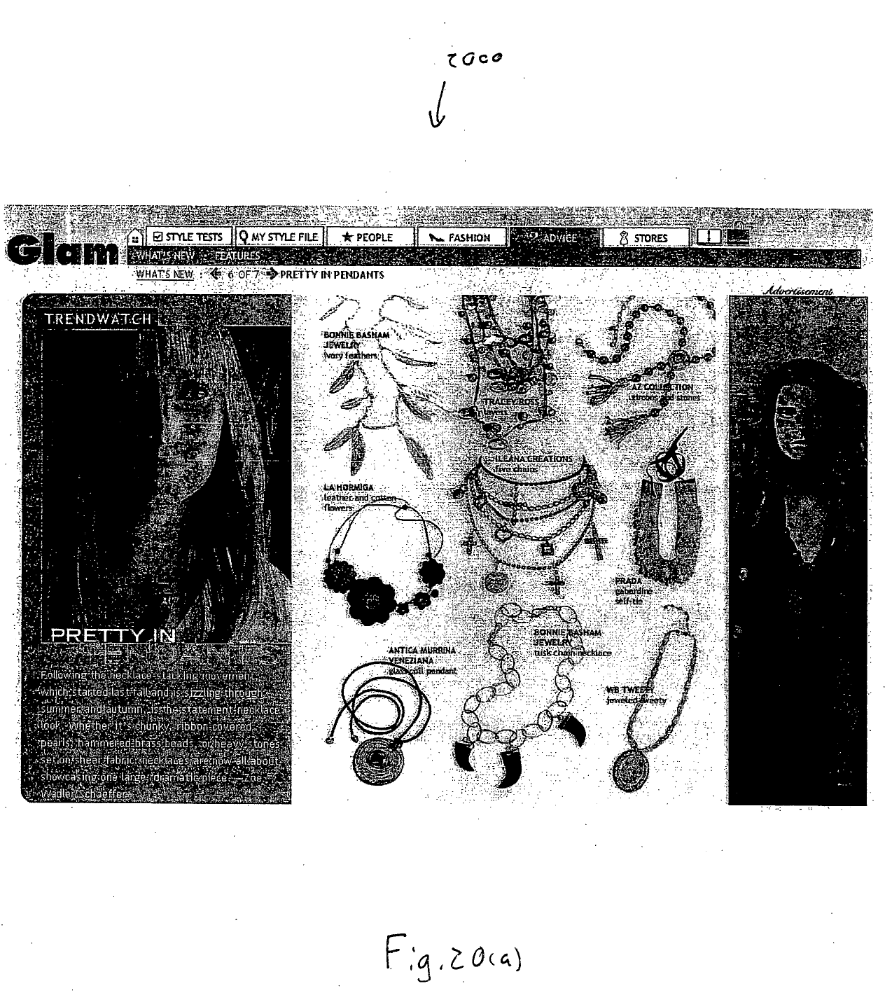

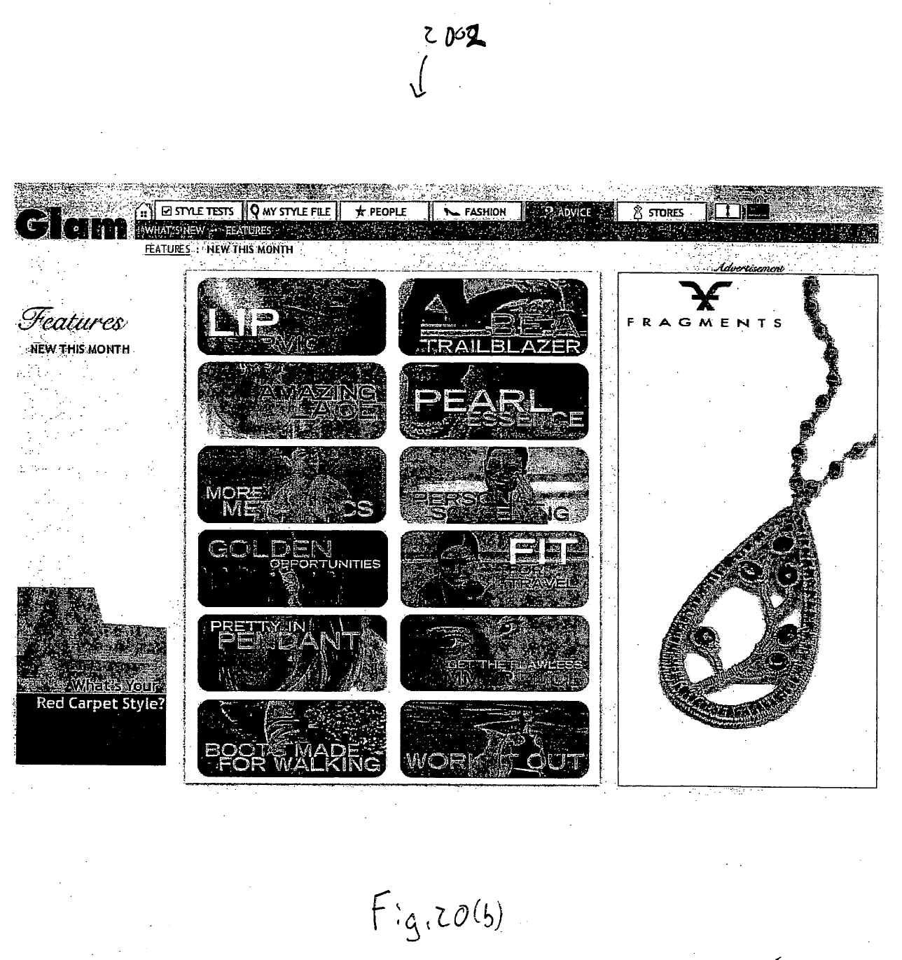

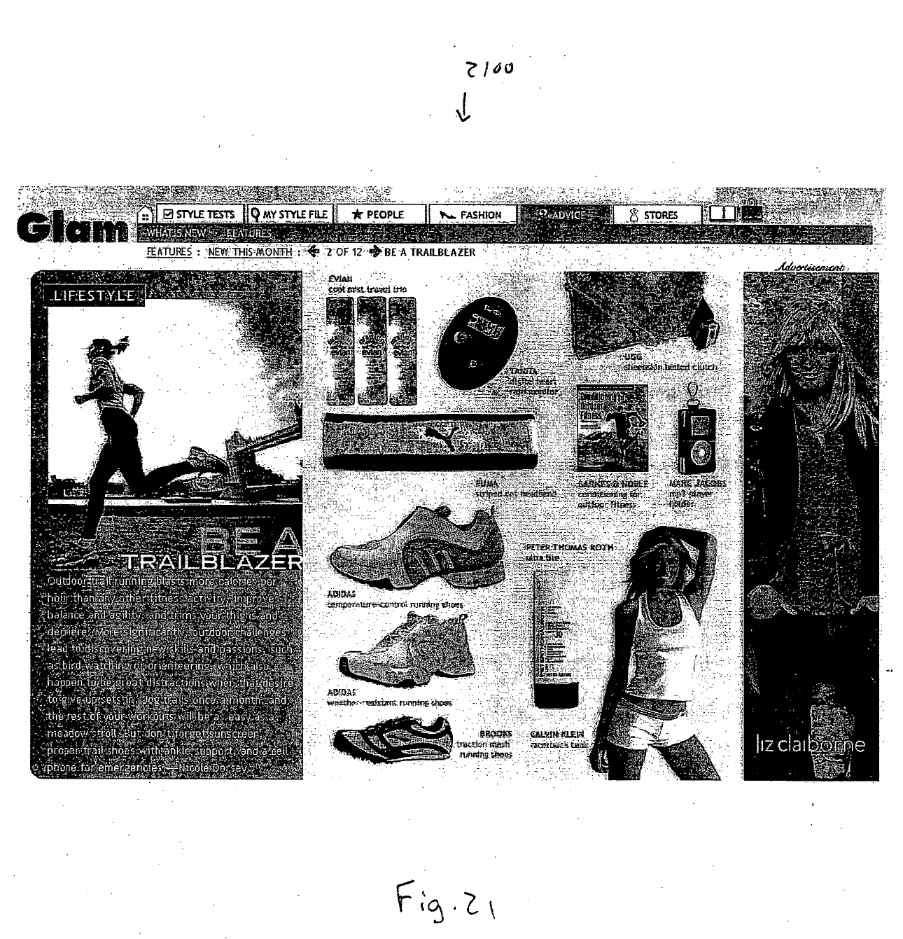

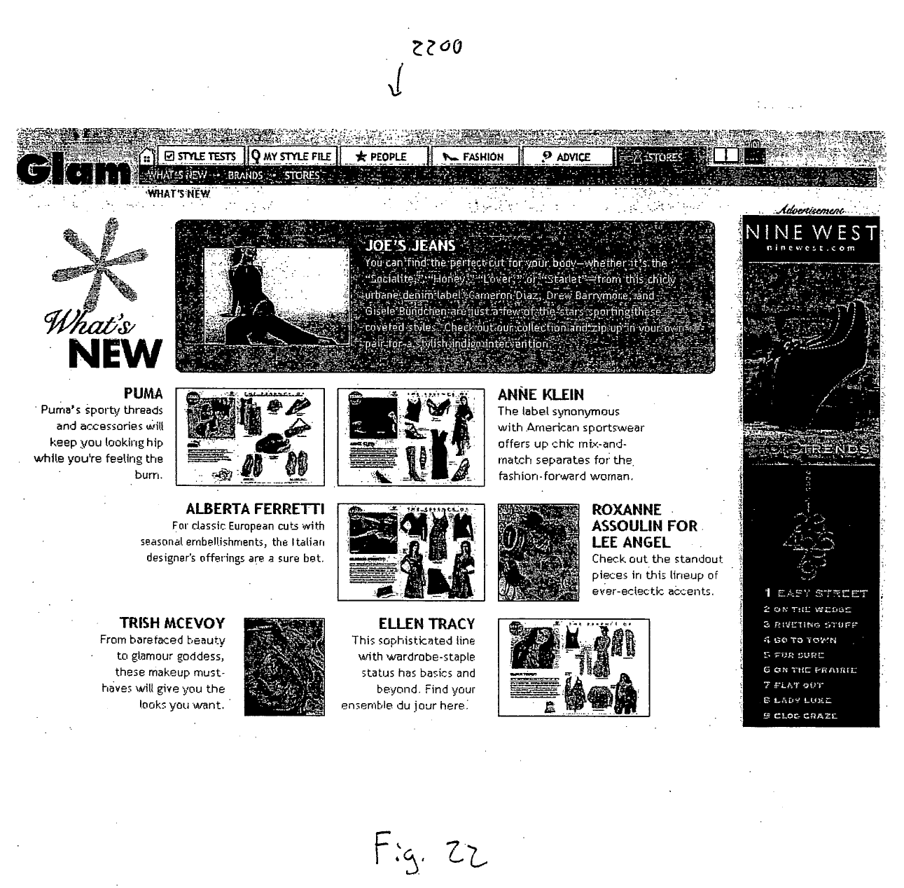

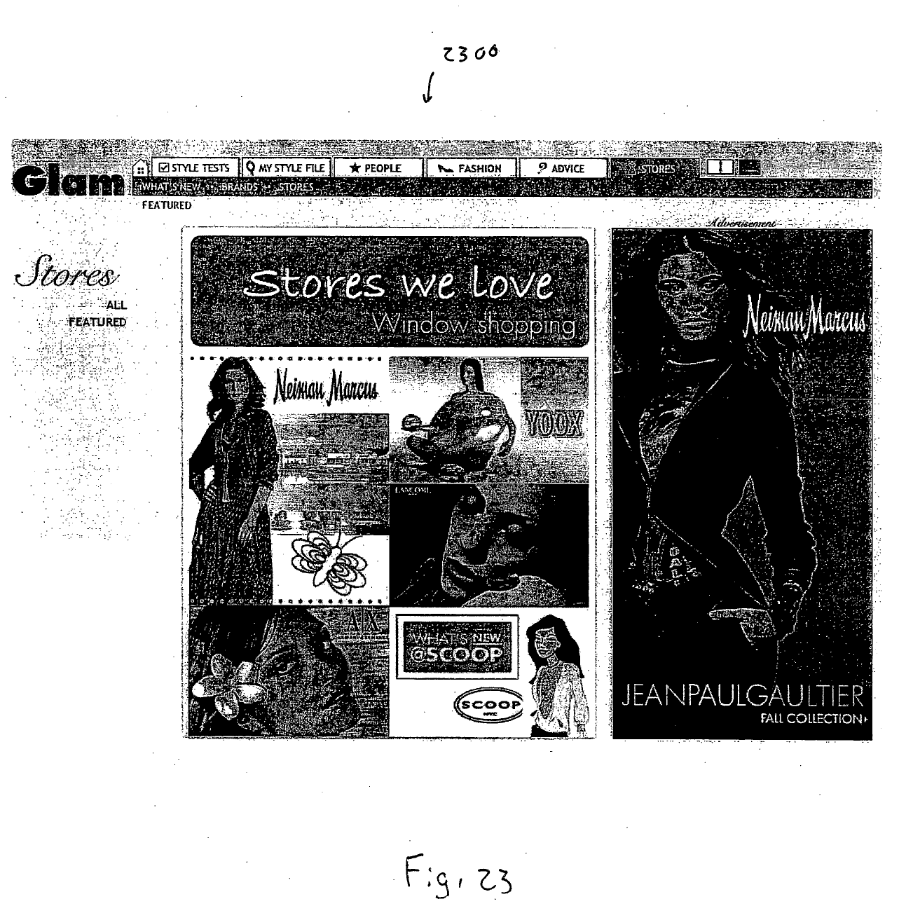

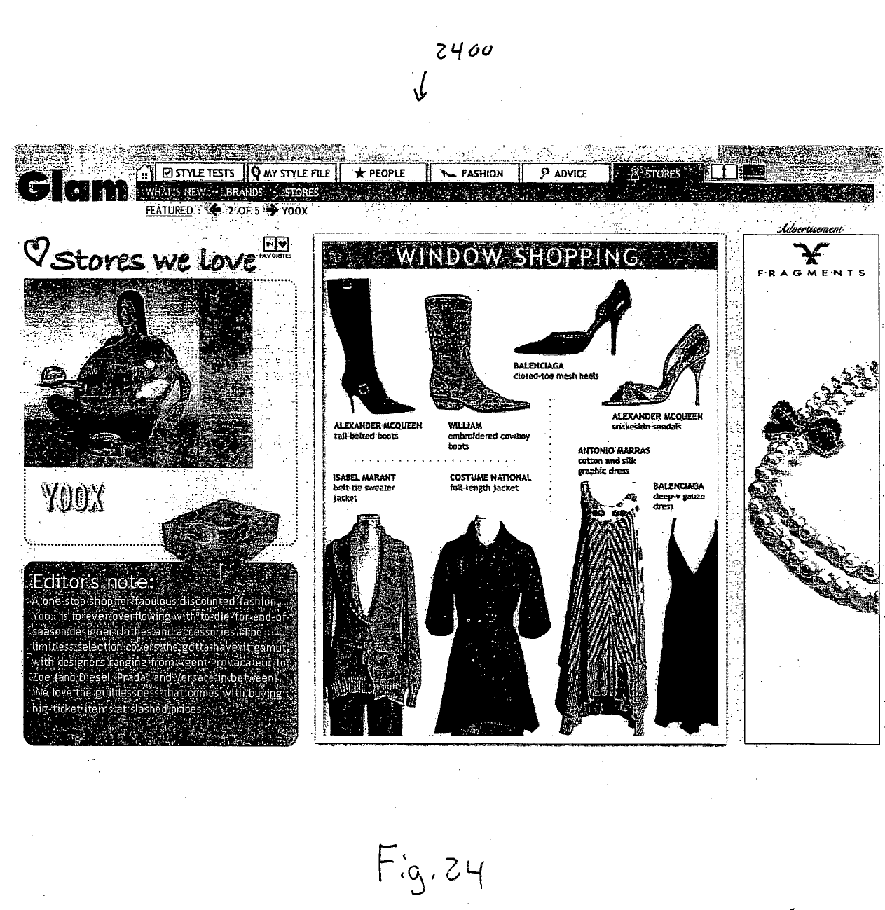

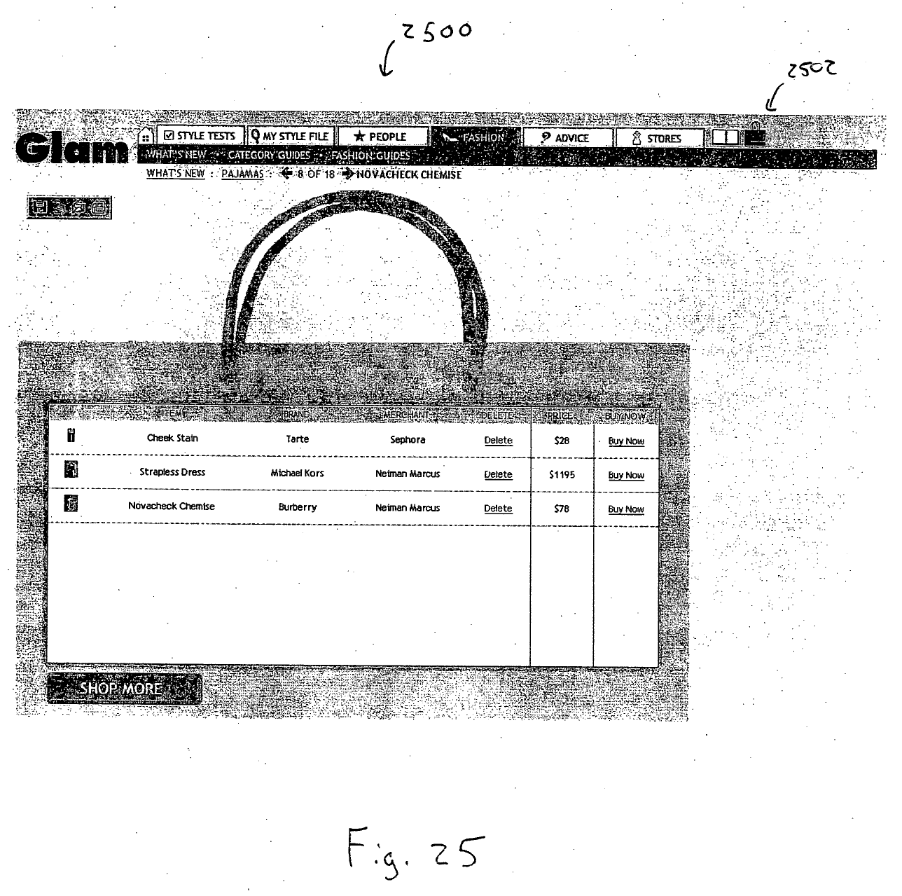

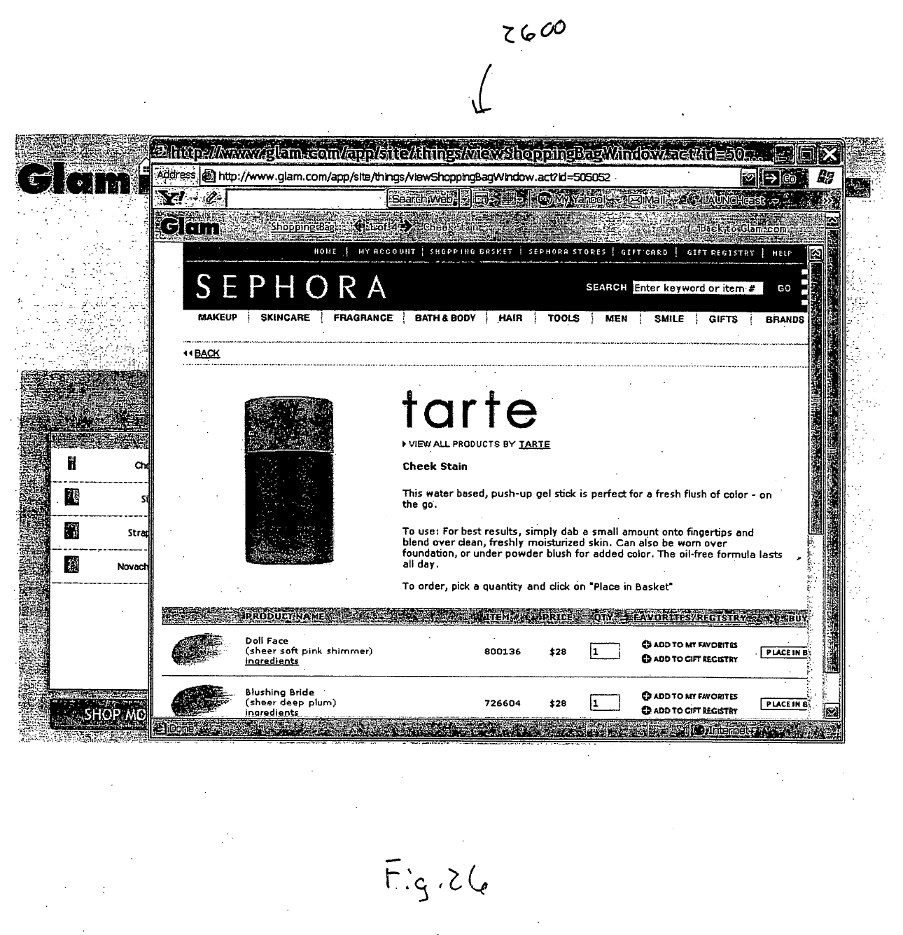

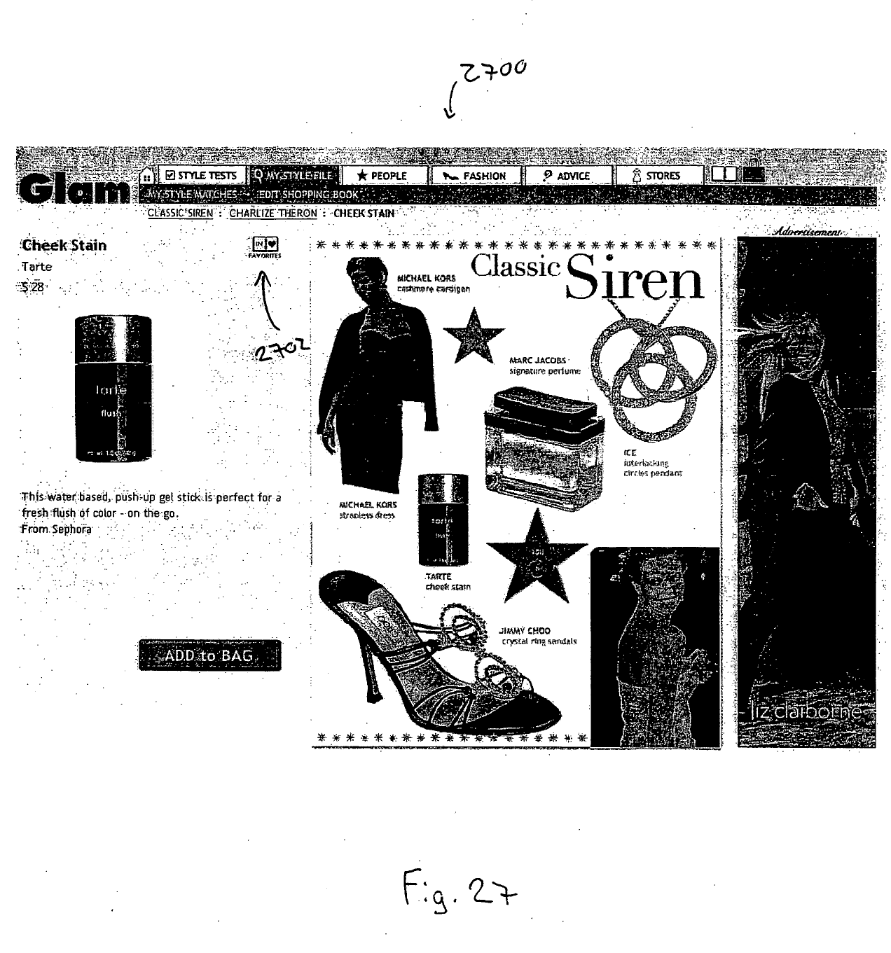

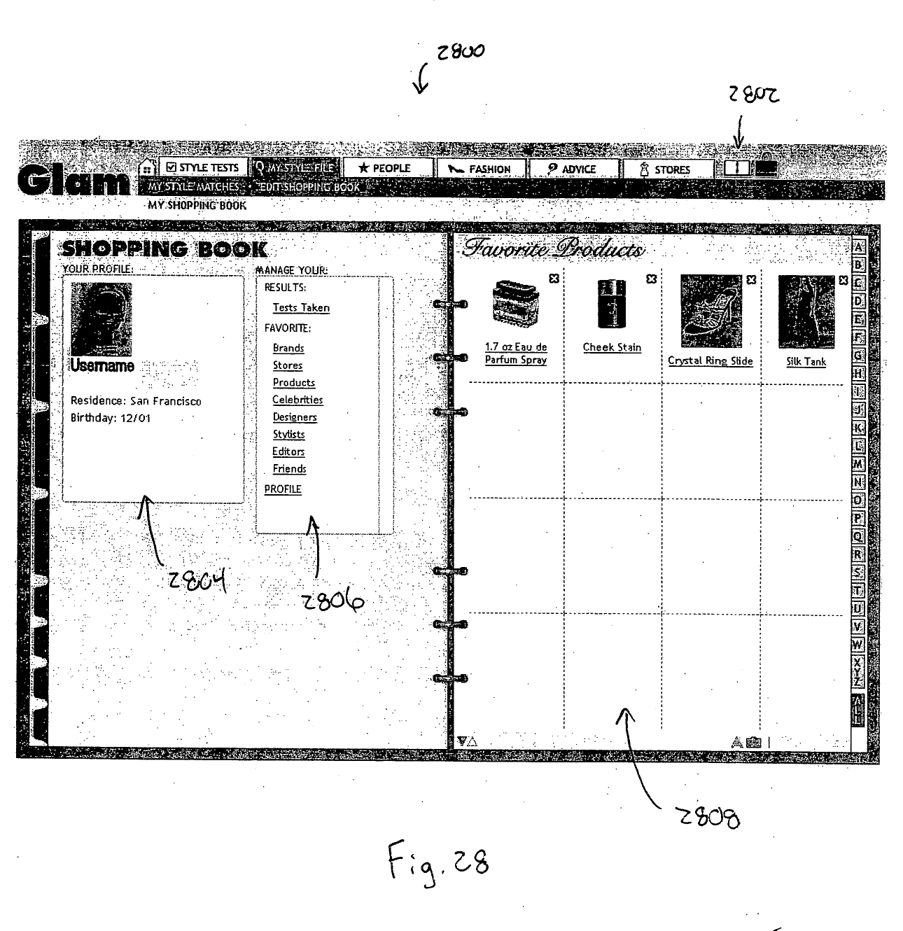

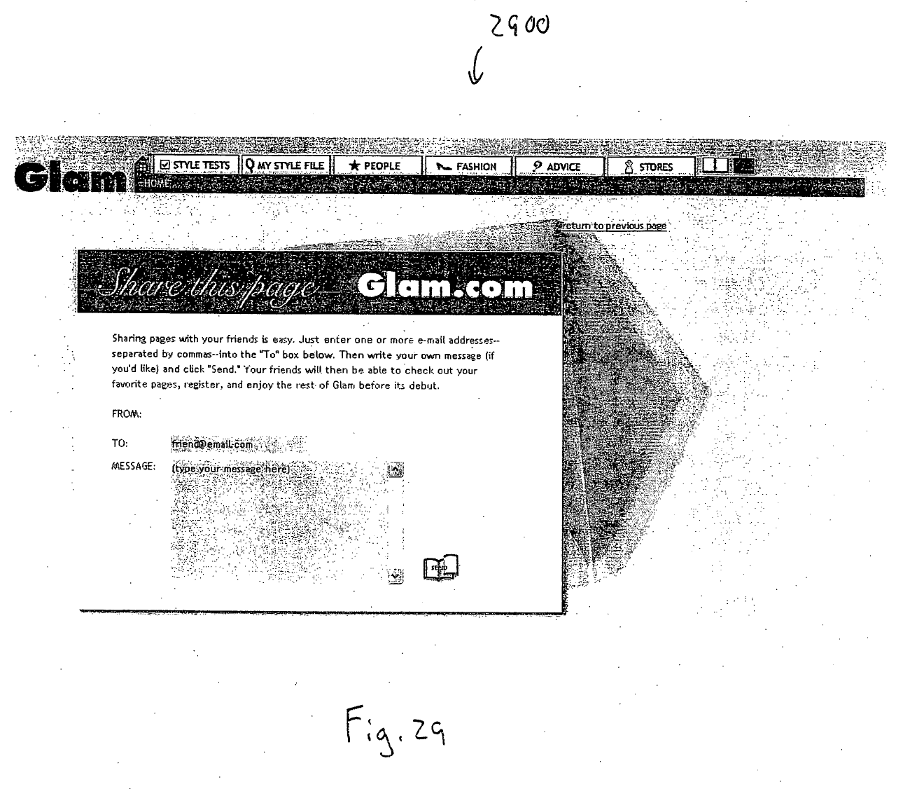

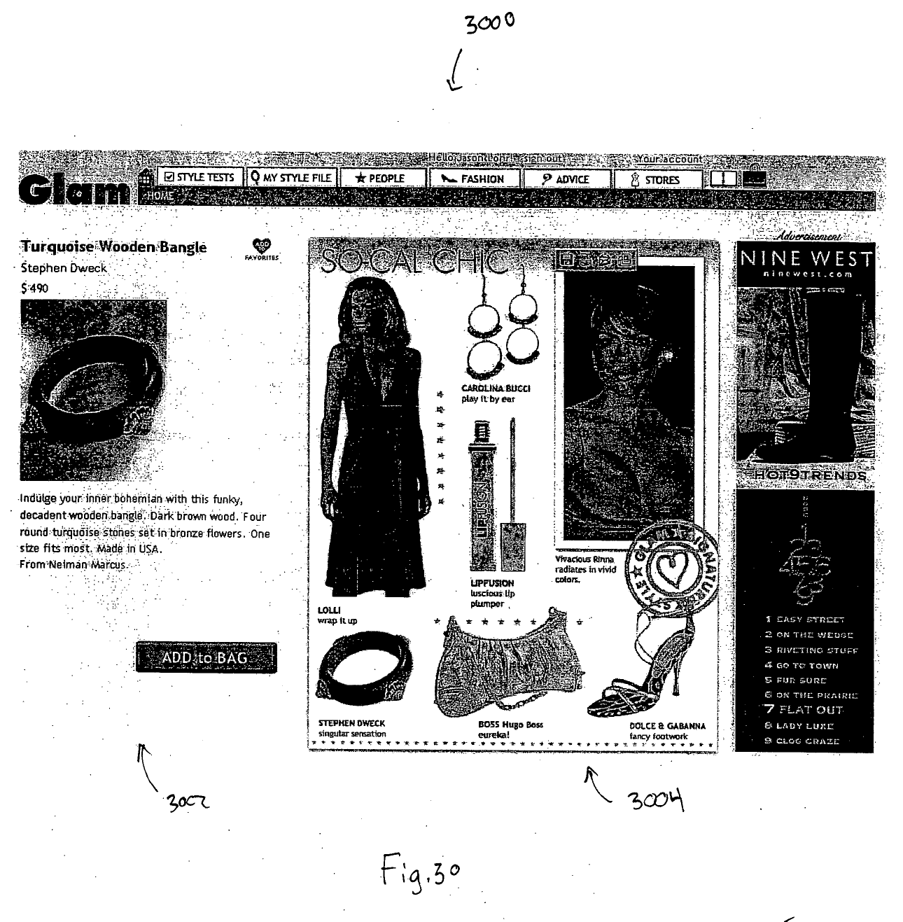

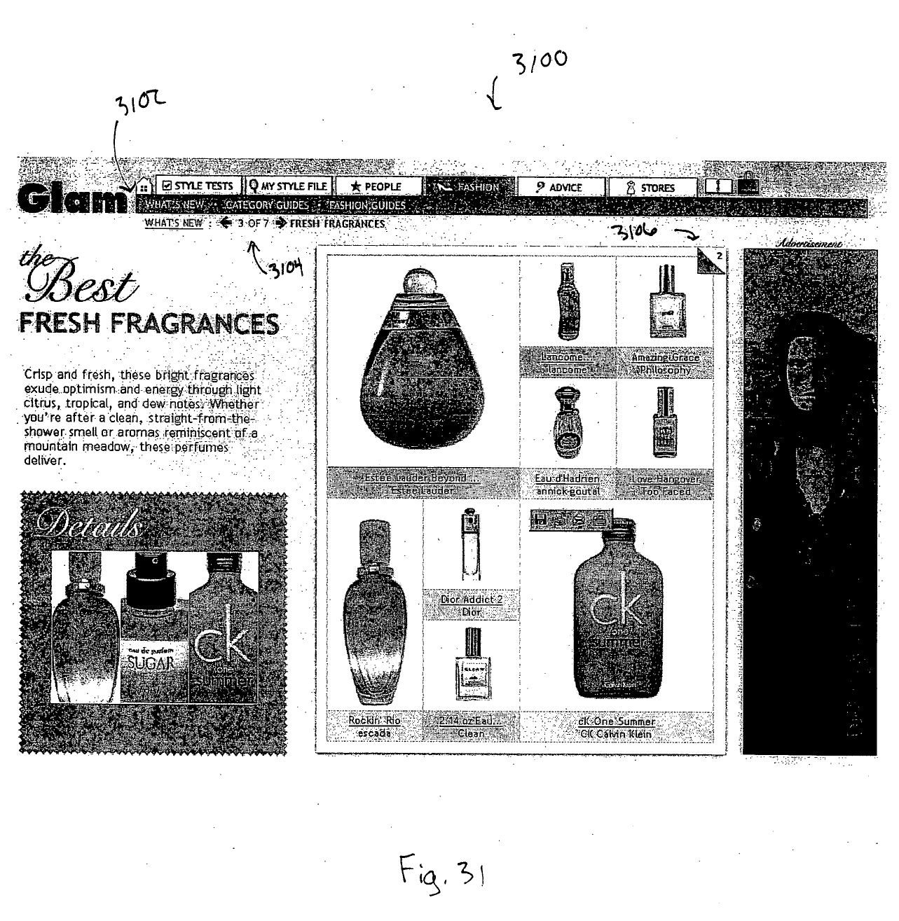

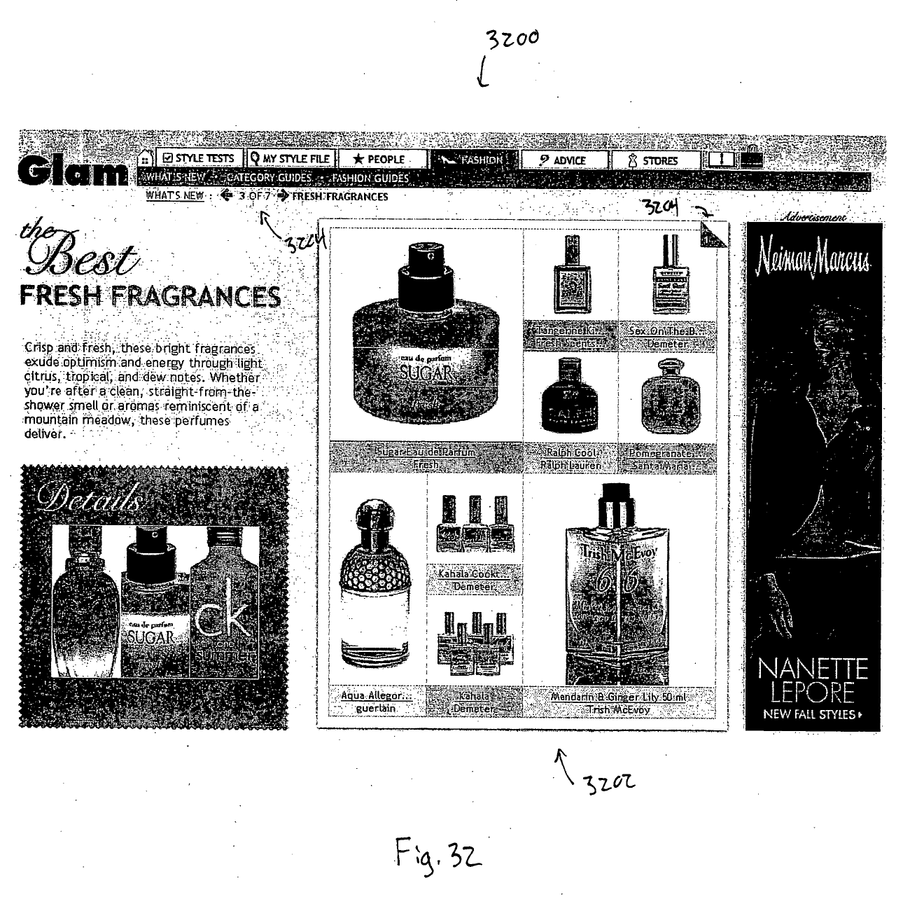

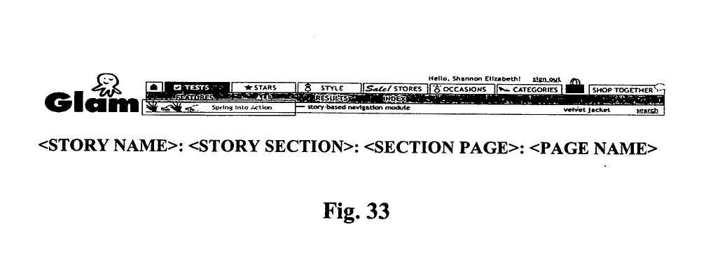

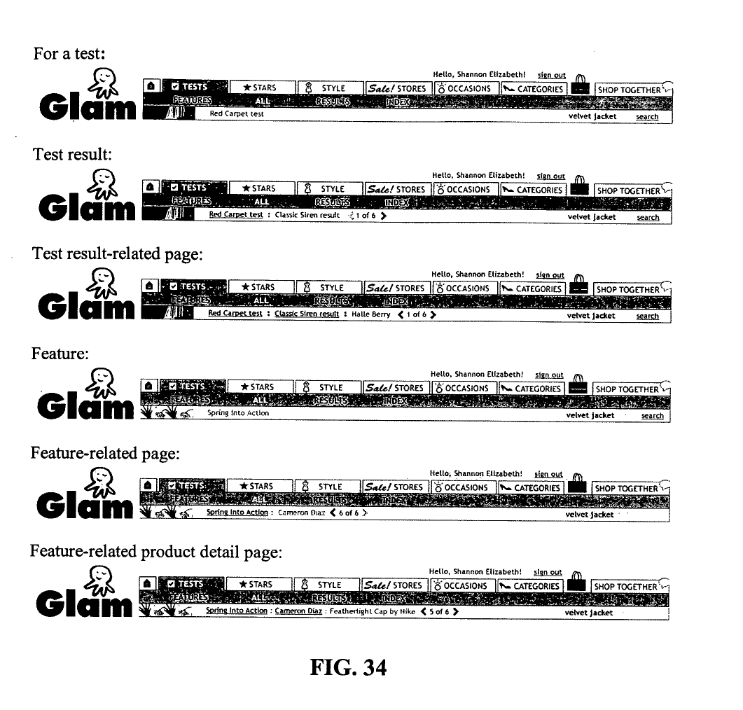

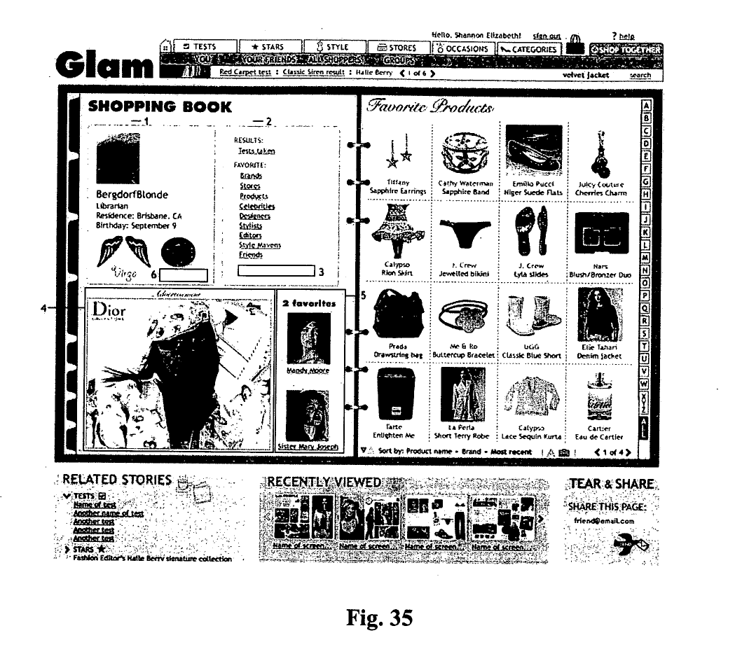

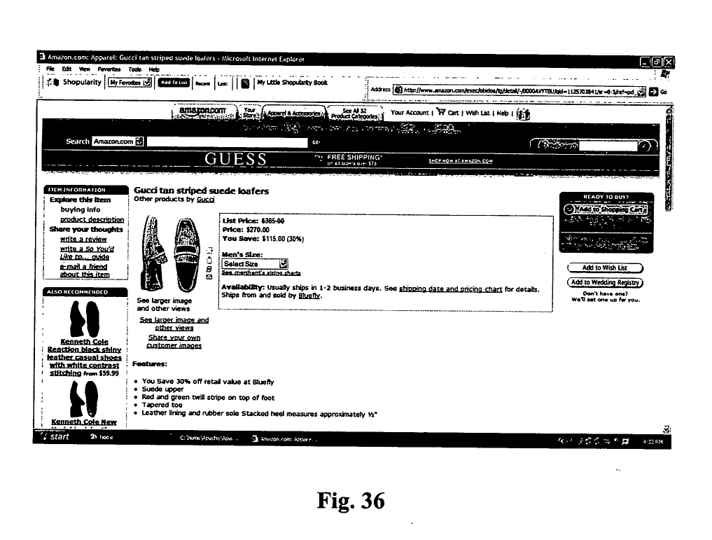

FIGS. 73-83 show additional personalized pages that can be created using such a layout editor.

Group Online Shopping Experience

Another feature that is desirable to many users is the ability to “Co-browse” the site. “Co-browsing” allows a user and at least one friend to simultaneously shop the site, with the ability to communicate during the shopping experience. This can include any of a number of technologies, as would be understood to one of ordinary skill in the art, such as video display or messaging, voice messaging, shared-screen display and/or control, split screen display and/or control, chat windows, instant messaging windows, or any other appropriate technology known and/or used to communicate online. In one example, the user can navigate the site while at least one friend can view (on a separate screen, computer, system, cell phone, handheld device, etc.) the site as seen by the user. In another example, the user and all friends viewing the site will see the same thing, but any of the friends can navigate the site. In still another embodiment, each user/friend can have a separate panel, window, section, etc. that can be seen by all the other persons who are co-browsing. For each of these examples, there also can be a way for the user and friend(s) to communicate, such as by using any of the communication technologies listed above. In one embodiment, an instant messaging window (which can be provided through the system or from an outside source such as AIM or Yahoo Messaging) can be displayed in addition to the viewing window, so that the co-browsers can communicate back and forth about what is seen on the screen. Each user can have the ability to add items to that user's shopping bag, shopping book, and/or favorites, and the appropriate icon can be displayed for each user (e.g., the user might see an “Add to Favorites” icon while the friend sees am “In My Favorites” icon, even though they are viewing the same screen). In another embodiment, the user might see an icon that says “Add to Favorites” along with another icon that says “In [friend]'s Favorites.” In this way, persons at remote locations can go through the site together, take tests together, etc., in order to improve the user experience, bring users back to the site, and promote a social aspect of the site.

Social Networking

As discussed with respect to the Shopping Book feature, a user can be linked to various items through various style tests and other options. Another feature of the shopping book is the implicit connection or association of a user to other persons or users through these style tests, etc. This creates a Social Network for the user that is different than other existing social networks such as Friendster or MySpace. On these existing social networking sites, a friend is added to a network explicitly. In other words, a friend has to specifically ask to be added to your network, and you have to specifically accept their invitation. You also can have an extended network, which includes the friends of the friends to whom you have given access.

A social network in accordance with various embodiments herein is different, however, in that it allows for both implicit and explicit networking. For example, a user can identify specific friends to be in their network, as well as the user's favorite “connectors” (i.e. celebrities, products, merchants, brands, stylists, editors, or other categories explicitly selected by the user, such as by selecting the “Add to Favorites” button. The user also can add persons or connectors implicitly, such as through the results of a test or other attributes that are learned or obtained about the user through interaction with the site. For example, Jennifer Anniston may be associated to a user based on a particular test result that she has been associated with by an editor, etc. Even though the user might not personally know Ms. Anniston, the user can have Ms. Anniston in the user's network simply because Ms. Anniston has been connected to the user through the site. Ms. Anniston and all of her connections now are associated to the user based on their implicit relationship. For example, taking a test that links the user's style to Jennifer Anniston's style also can connect the user to the stores Ms. Anniston prefers, the stylists Ms. Anniston uses, etc. This implicit relationship has not been done before in online social networking.

Products-Based Social Networking

Along with the explicit and implicit aspects of the social network described above, the network also provides for products-based social networking. For example, when a user adds a product to that user's “Favorites,” the user can be implicitly connected to any people, items, and other content associated to that product. This can implicitly link the user to other people who use or like that product, as well as other products that have been determined to go with that product, etc. This aspect of social networking based on product preferences also has not been done online in any appreciable way. For example, a user viewing that product in the “favorites” section might see the connections to other related products in the user's network, or other people that admire that product whose style might be of interest to the user.

The technology and way for adding favorites, extending the network, connecting persons, products and other content, and other aspects of product-based networking are discussed elsewhere herein or would be obvious to one of ordinary skill in the art, such that they are not discussed here in detail.

Personalized Online Magazine

As discussed elsewhere herein, but repeated here for emphasis, the ability to provide targeted and related content and/or merchandise to a wide variety of users in a way that is entertaining, easy to navigate, and visually appealing can be advantageous and desirable to users, content providers, designers, merchandisers, and any of a number of other people and organizations associated with such endeavors. The ability to present a user with information in a story-based way, where the user can flip through the story at her leisure and obtain as much or as little information about each chapter of the story and the user wishes, has not previously been done online and is a powerful way to present content to a user. The ability for the site to provide more targeted and/or related content overtime as the system “learns” more about the user, using dimensions such as “What Color Are You,” allows the site to provide ever-more relevant content and improve the overall user experience with the more the user visits the site. An online, personalized catalog or magazine that is visually appealing and entertaining is a powerful concept that to this point has not been successfully attempted and/or implemented in any appreciable way and can revolutionize the way content is provided in an online environment.

Streaming Customized Shopping Channel

Another feature that can be added to a site in accordance with various embodiments is a personalized shopping channel. There are many ways discussed and enabled herein for selecting items to be presented to a user based on profile and attribute information. Instead of simply presenting graphics and text, however, it should be understood that streaming audio or video also can be presented to the user in a similar way. (It should be understood that streaming is merely an example and that audio or video content can be communicated to a user in any of a number of different ways within the scope of the various embodiments). For example, a user that is connected to Ralph Lauren might see in a window, panel, or section of the site a streaming program relating to Ralph Lauren or featuring Ralph Lauren products, such as the latest Purple Label fashions. Sections of the site also can be configured to display a selectable item whenever an item is shown in the video, such that the user can add that item to the shopping bag, favorites, etc. When the Ralph Lauren video is done playing, the user might see an ad that is targeted to the user using rules discussed elsewhere herein, then might see another video connected to the user such as a summary of a fashion show, a celebrity video moment, or a more shopping-channel like program that is determined to be of relevance to the user. It should be understood that a user might select to receive only this video feed, such as over a cell phone or handheld device, which still will use the profile to select targeted and relevant information. A user also can have the option to select (or flip through) various channels and/or programming to be displayed through the “FashionTV” or other similar feed.

Tear and Share a Page

Another feature that can be used in accordance with various embodiments is a “Tear-and-share-a-page” feature. A “Share a Test Result” page enables a user to send a snapshot of a result page (or other content page) to a friend or several friends. The user can simply click on a “share” icon (or other selectable option) on the page and can be taken to a page with a pre-written message. The user can click on an “Edit Message” option to change the message to a more personal one. The user also can select a different style of “post-it” note by clicking on the arrow buttons below the post-it image. The user also can add a subject line and can send the page to multiple people by separating email addresses (or site usernames) with commas or semi-colons. Once the user clicks “Send,” a copy of this page can be included in an HTML-formatted email, a link can be sent, or a virtual screenshot can be created and send to the friend(s). An exemplary tear and share page is shown in FIG. 63.

For the tear and share page, the story navigation can display the same elements as was displayed on the previous screen (the one that is being “shared”), with the addition of “share result” HTML text appended to the end. For example, the sub-navigation section can include a listing such as “Retail Therapy Test:Entertainment Shopper:Share Result.

The screenshot can have been captured previously by the system, and the “tear” graphic appended to the left as shown. The screen can be designed in a 2-column format so that the “post it” and the form fields (shown below) can be placed in a 1000 pixel (or other appropriate) space. The Post It note can be displayed as shown. The message can be pre-written and not editable, but the user can click on “edit message” below and the text made editable.

A “change sentiment” option allows the user to select a different style of post-it, and the accompanying message. Each time the user clicks on either the “back” or “forward” arrows, the post-it can be replaced with a new one. An “edit message” option can allow the user to edit the message displayed in the post-it note. Once clicked, the text and its background can become highlighted as shown, and the user can remove or change the text. If the user removes all text from the post-it, and clicks “send,” the system can remove the post-it altogether from the page.

A “from” field can include the first and last name of the user (or username or other appropriate identifier) that clicked on the “share” icon. The field can be editable. An “about” field can have a default entry, such as “[test name] test result at glam.com.” This field also can be editable. If the user typed email address(s) or username(s) in the field on the page she was sharing before clicking the “share” button, these addresses or usernames can be displayed in a “To” field as well. The user can include email addresses and/or usernames in this field, separated by commas or semi-colons.

A “send” button can allow the user to send the page to her friend(s) or acquaintance(s). Upon selecting the button, the system can check to make sure the email address(s) and/or username(s) entered in the “To” field are in a valid format. If the addresses or usernames are not in a valid format, the system can return an error message such as “Sorry, the email addresses or usernames entered in the “to” field are not correct.” If the user did not enter anything into the “To” field, the system can return a message such as “You must enter an email address or Glam username into the “to” field.” A number of other options can be included within the scope of the various embodiments. As discussed above, the emailing of the message can be done through the site/software, or can be done using a user's email program as known in the art. Other appropriate technologies and formatting (such as picture messages for cell phones) can be used in ways that would be obvious in light of the specification and details contained herein.

Publishing Engine—Architecture Overview

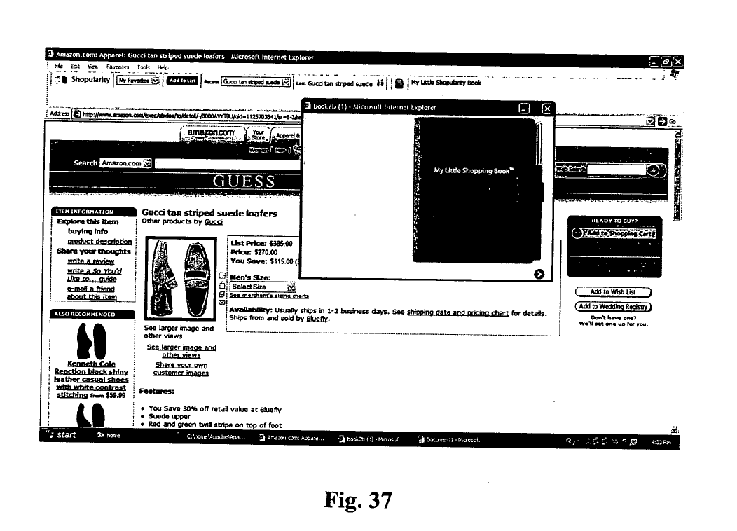

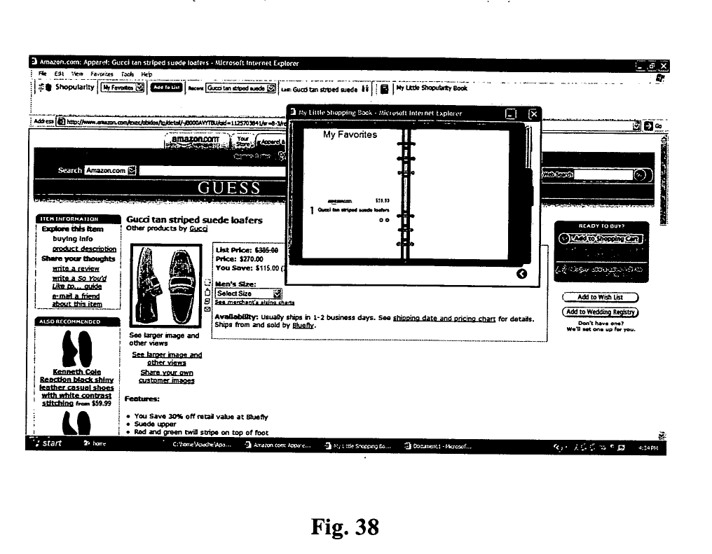

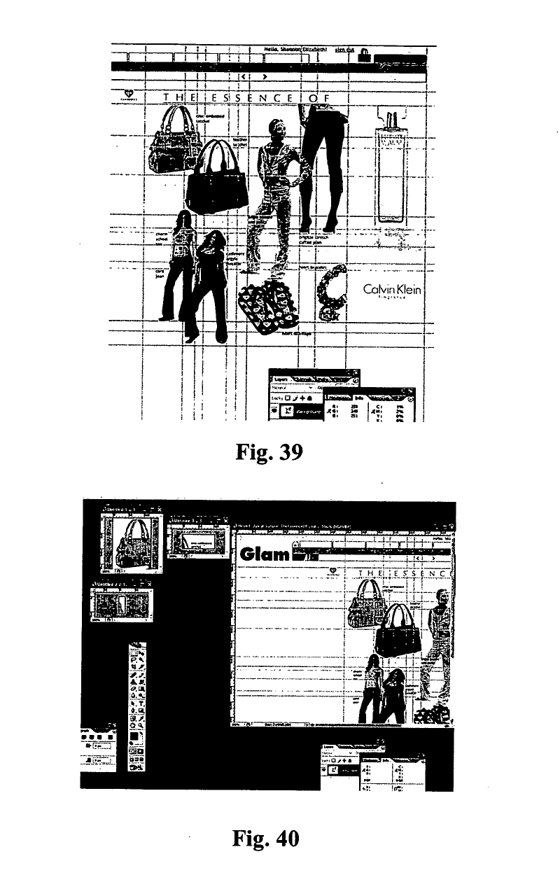

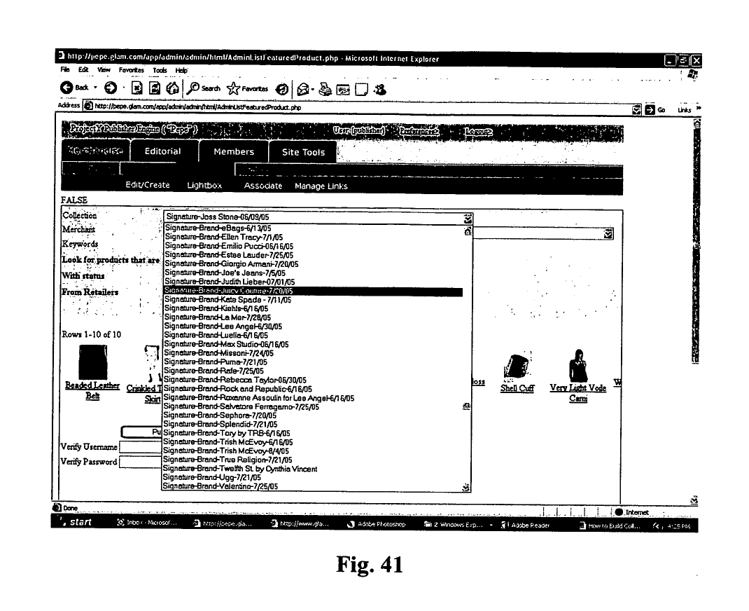

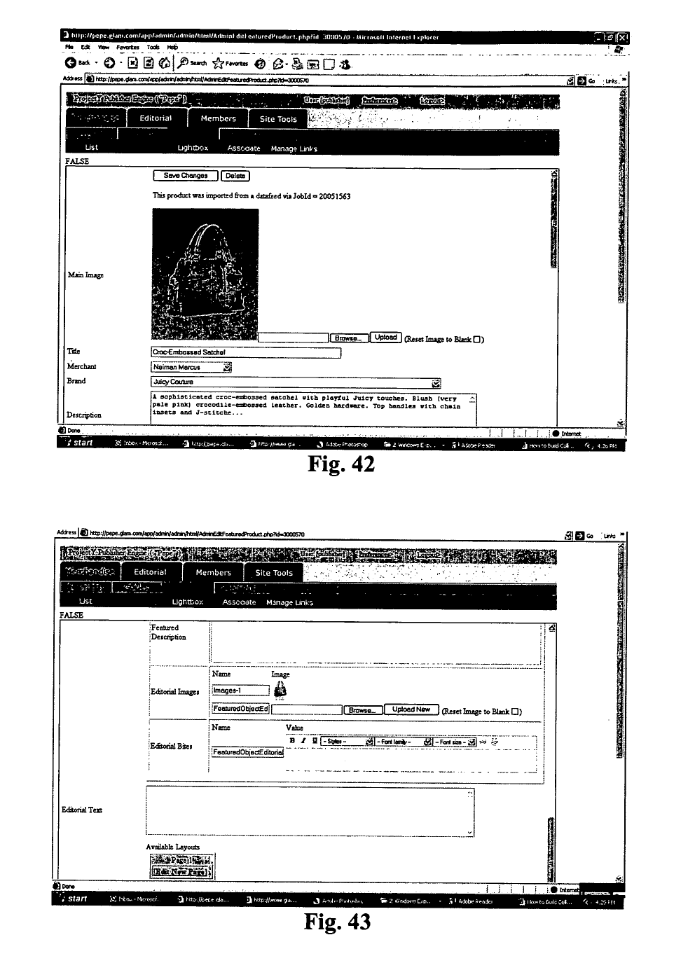

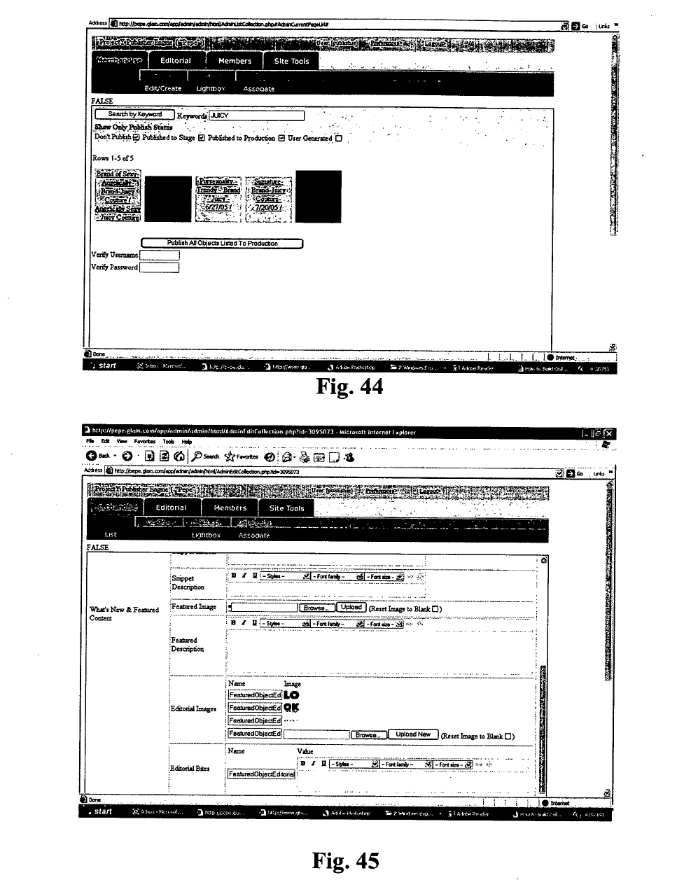

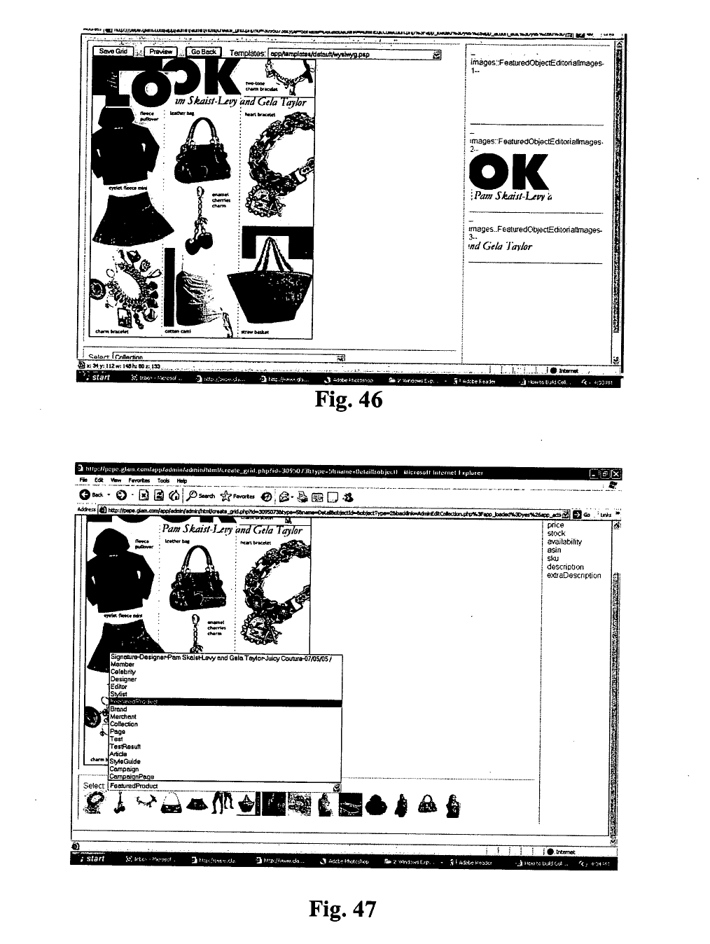

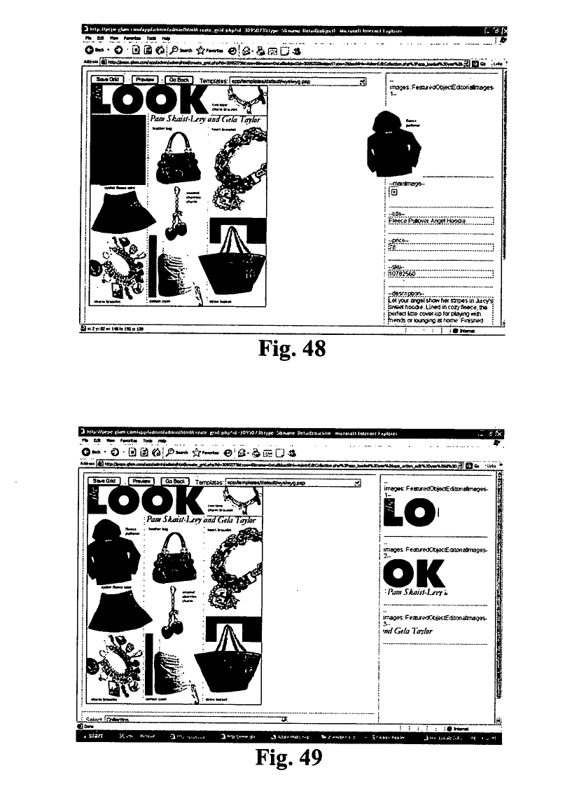

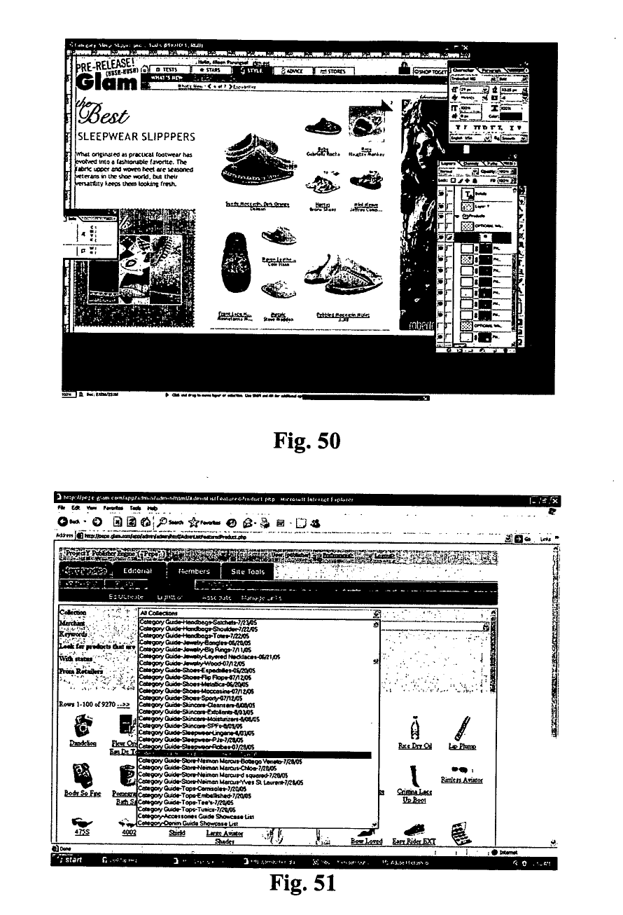

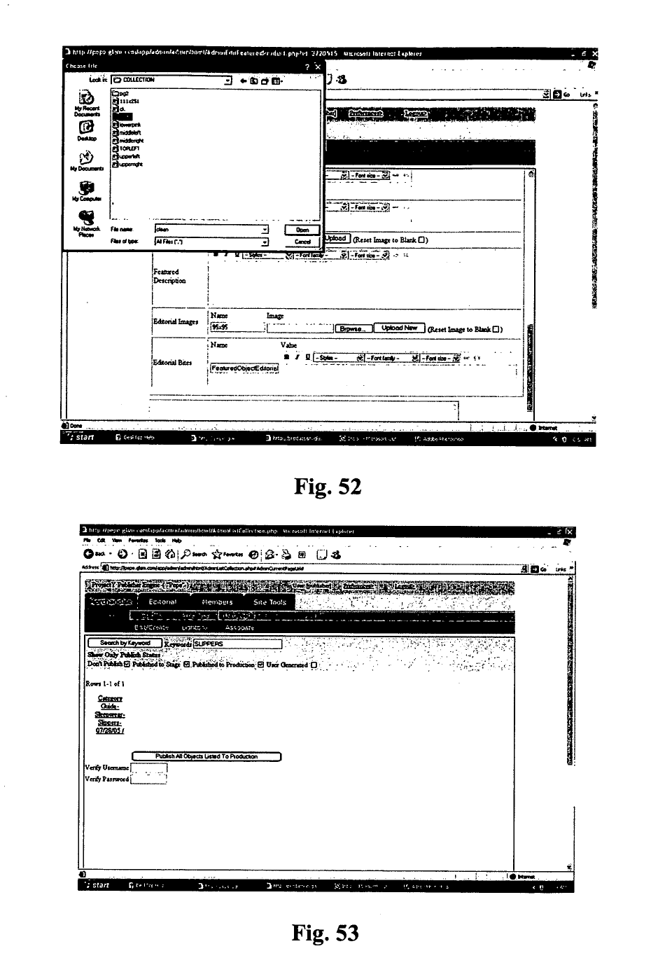

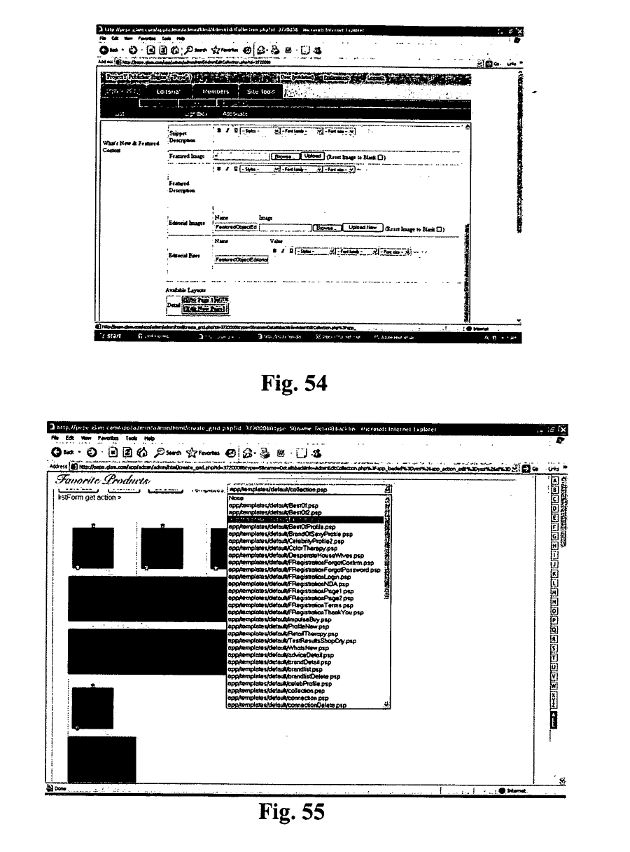

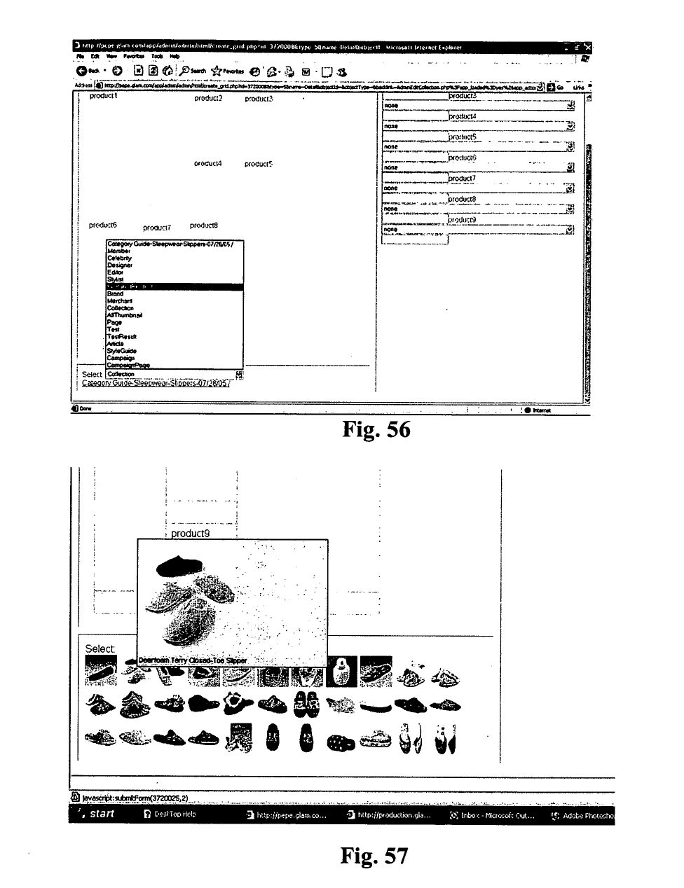

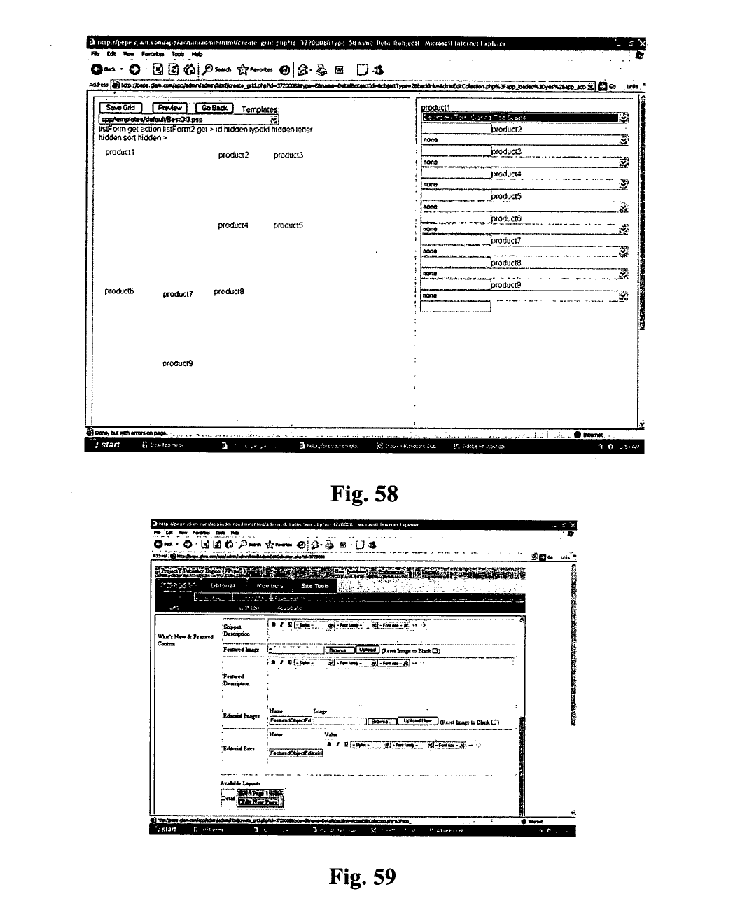

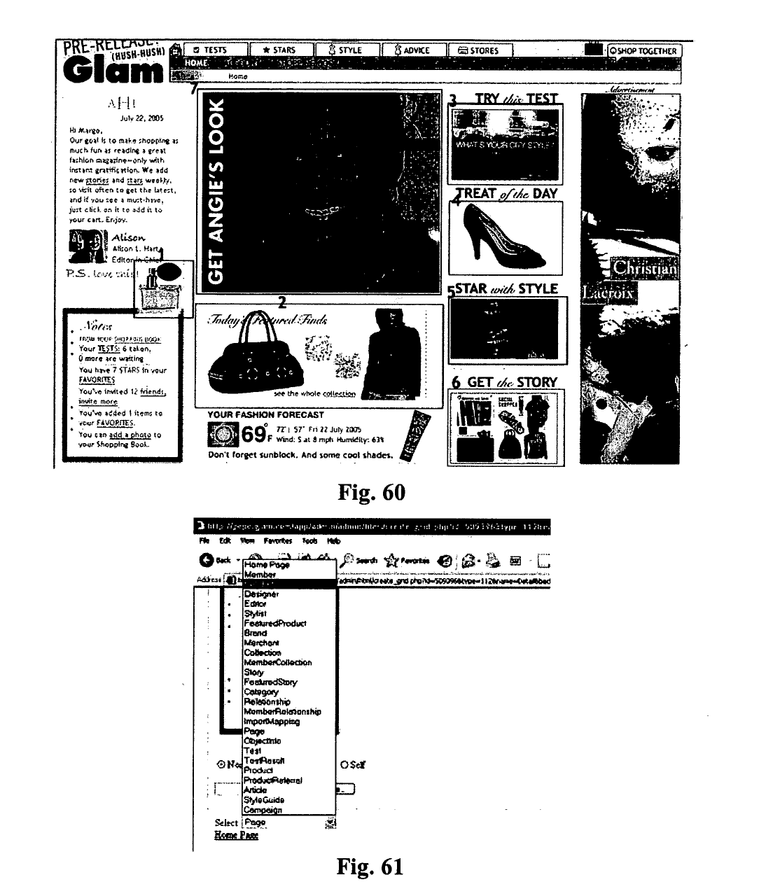

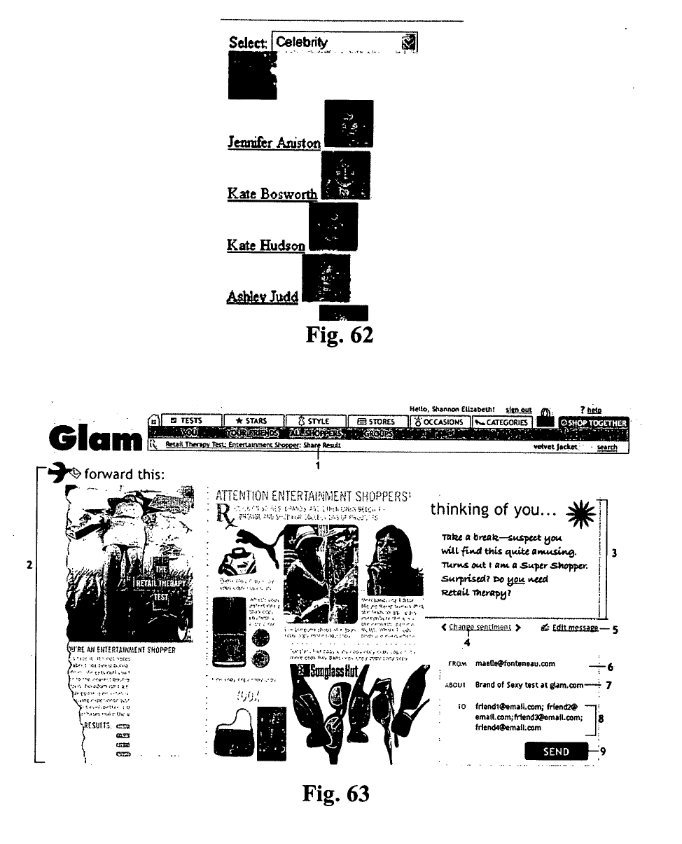

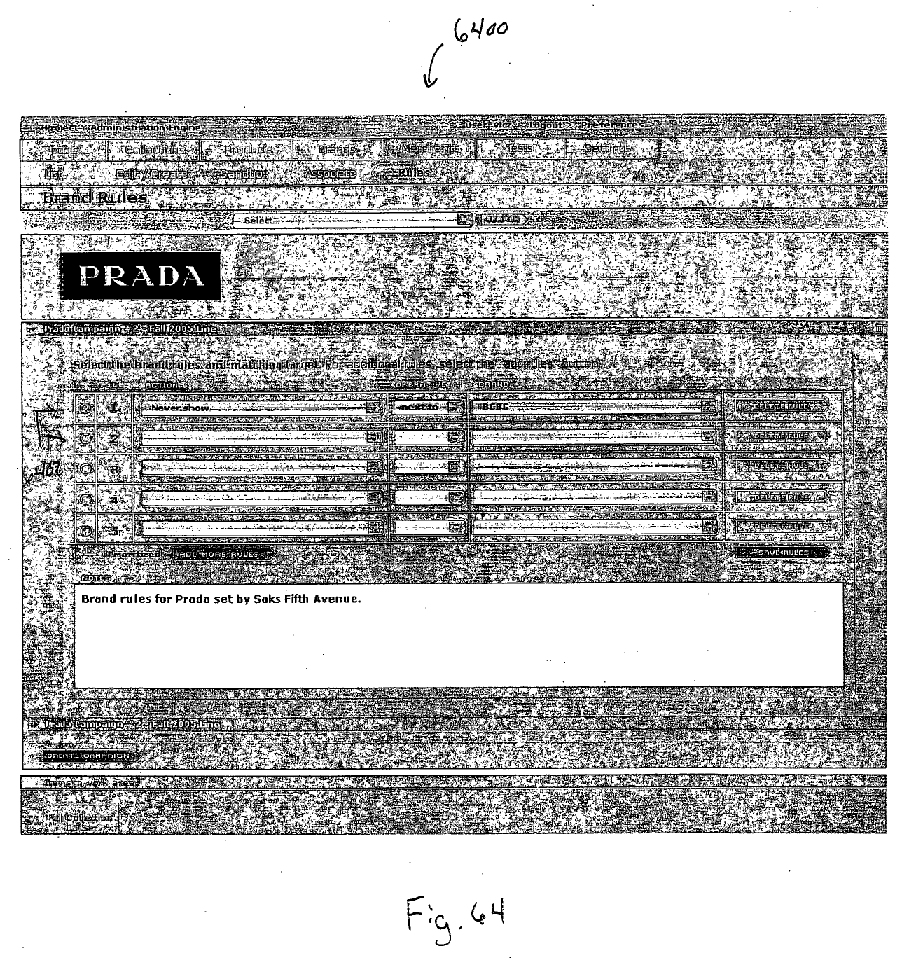

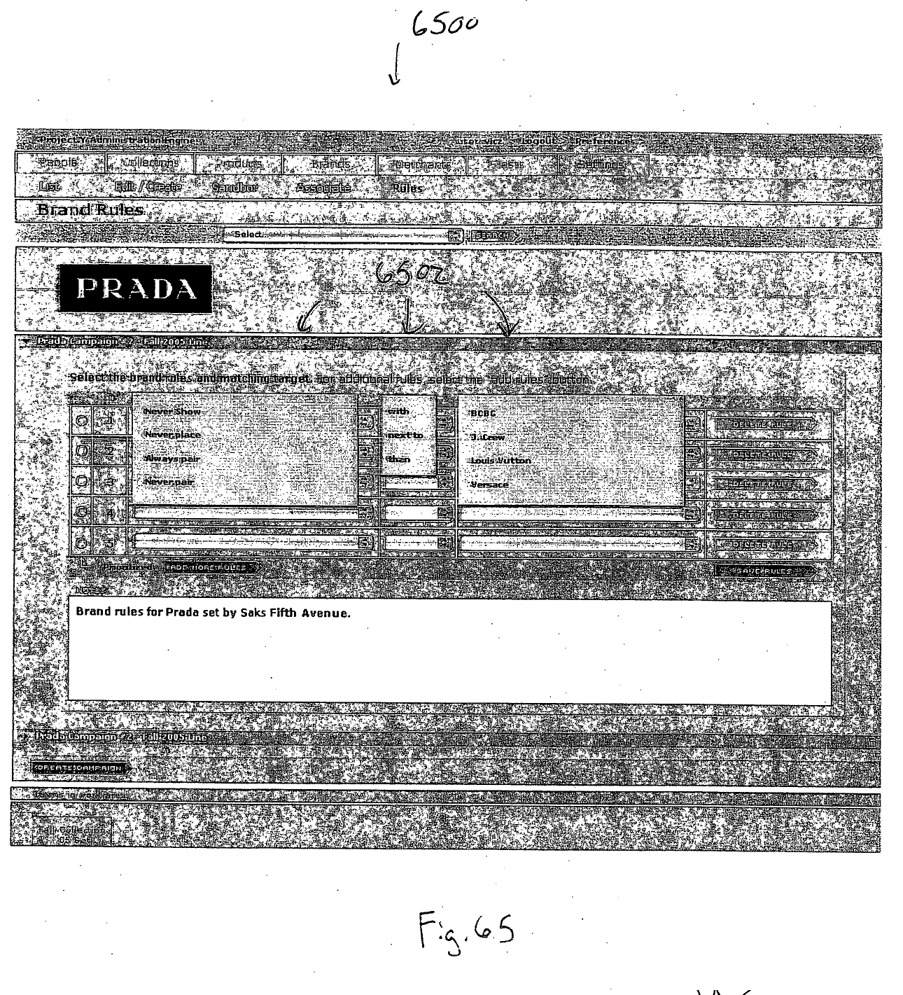

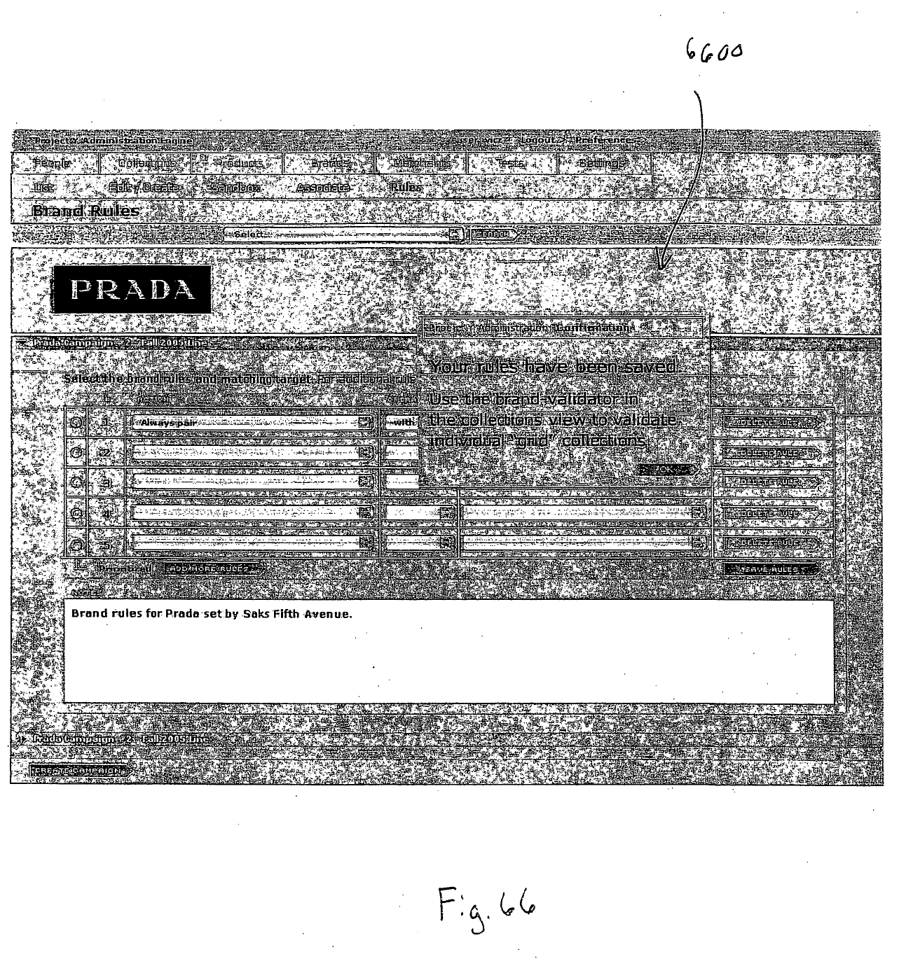

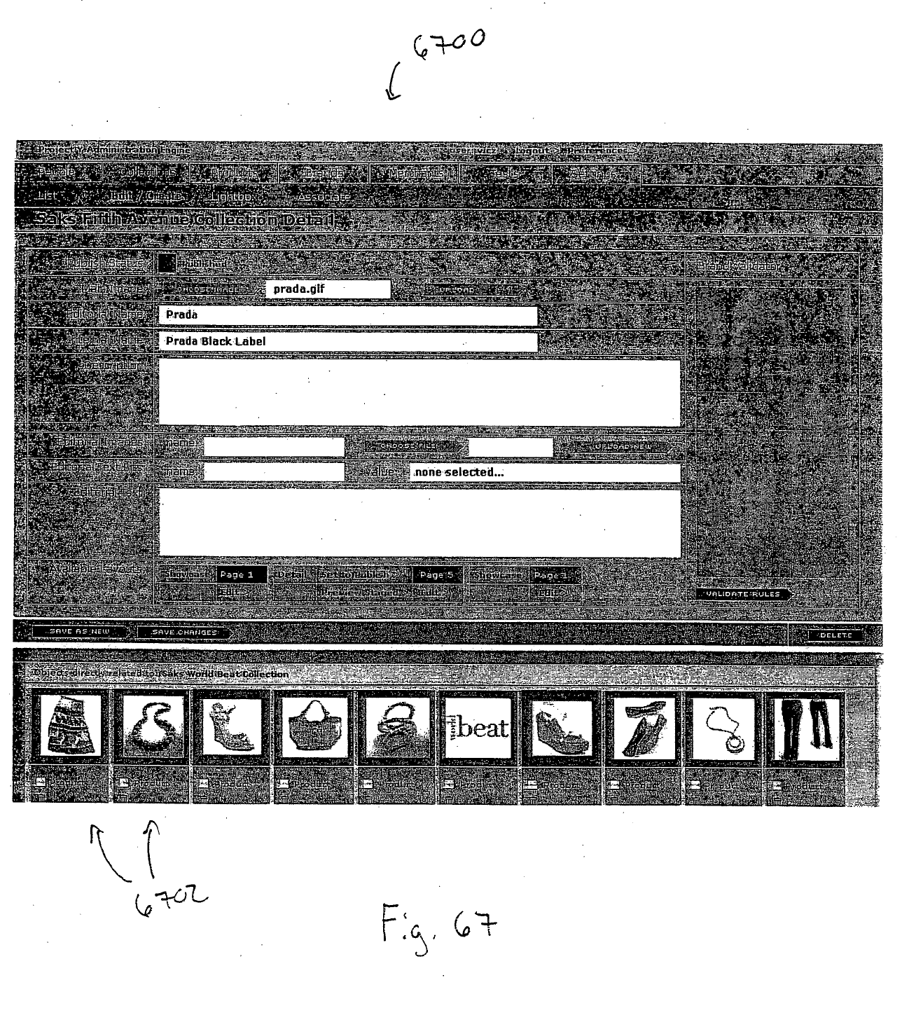

FIG. 84 provides an overview of the architecture of an embodiment of a publishing engine that can be utilized to implement the concepts of the invention discussed above.

Glam Media's Pepe Publishing Engine, shown in FIG. 84, is a database based content management system that provides a uniquely straightforward process for publishing Content and Ads from advertisers and affiliates to the Glam Sites and the Glam Network. It implements a workflow based approach that allows different types of content contributors and other sources to push and feed data to the different sections of the Glam Media properties, including the Glam Network. More specifically, it provides a centralized data repository and a set of ‘Content Contributor Web Based Interfaces’ so that non technical resources can jointly and concurrently work on the publishing of the Sites. That way:
1) Editors can log into the system and create database objects that hold the initial meta data and mapping for the stories to be published.
2) Merchandizers can manage & import Collections of products and their availability information from over a million records, made available to Glam via automated datafeeds that are updated every day.
3) Designers can prepare a custom layout for each page of a custom collection and upload the different graphical assets that will be required for building the layout
4) Production specialists can finally gather all the assets, lay them out and publish the Site as a part of the last step process.

Because of its built-in workflow features such as to do lists and publishing status provided for all the new Collections and Pages to be published, the Pepe Publishing Engine gives a very high level of automation that streamlines the process of updating the Glam sites. Such process is described as the 7 step process listed below.

Two key and revolutionary concepts make Glam Media's Pepe Publishing Engine unique:
1) Each individual who participates in the process of building the site can perform their functional task without having to code custom HTML by hand. This streamlines and speeds up the process for publishing the site and therefore allows for a very large content set to be updated and published every day. Because it is object oriented by nature, every time a fashion product or a brand is featured on a page of the site, the system automatically creates the links and tracking information required for it so there is no need to Test and do Quality Assurance on the pages create by the system. This also makes the publishing of the sites very efficient from the cost perspective.
2) Because the Glam Media's Pepe Publishing Engine was created as system to feature and help online merchandisers with their specific marketing and branding campaign objectives, ALL CONTENT AND ADS are tested against the Pepe Brands, Content and Ads Validator for checks consistency branding logic. This ensures that all pages are compliant with the branding rules that are made explicit by Glam's Advertisers, and therefore provides a reliable platform for them to market themselves. This is explained on step (5) of the document below. When a page or collection is not compliant with all the branding rules, it is listed on a report of non compliancy that allows the Editors, Merchandizers and Production Specialists to go remedy the problem. The branding and ad rules are entered via the same Web based type of interface as the rest of the production cycle and are stored in the Pepe Publishing Database.
   Publishing Engine—Process

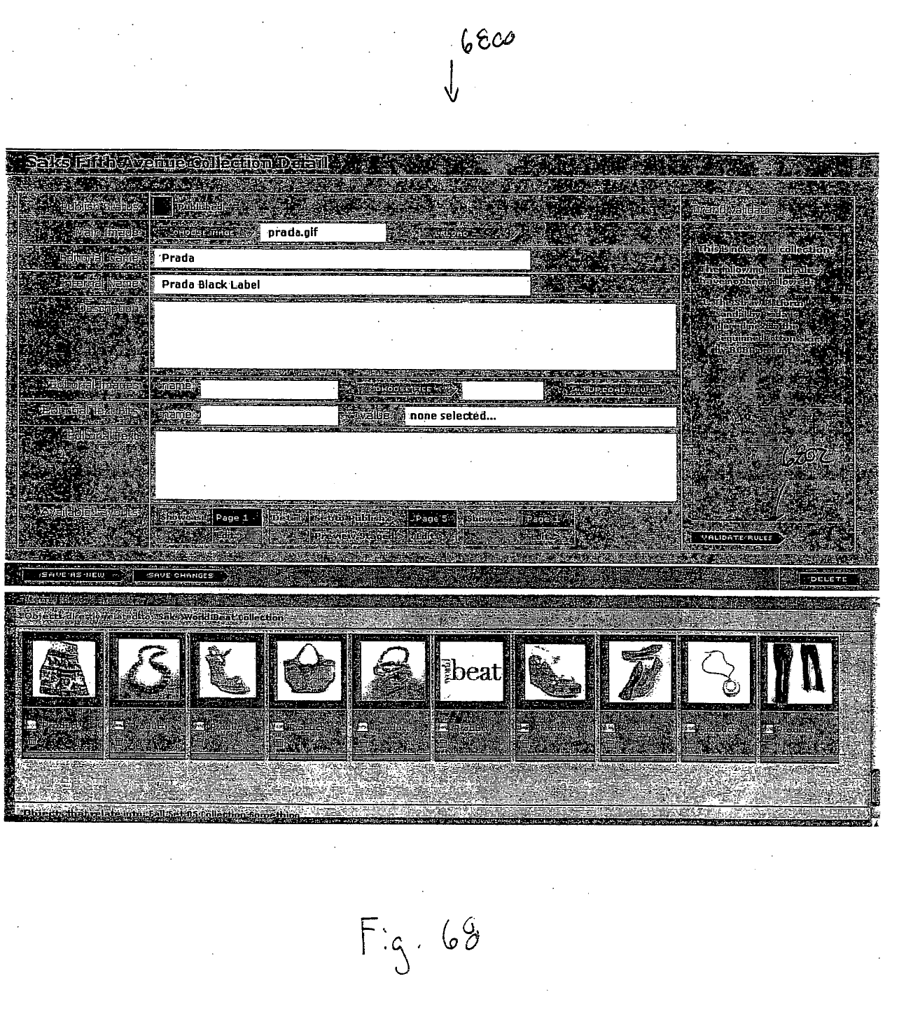

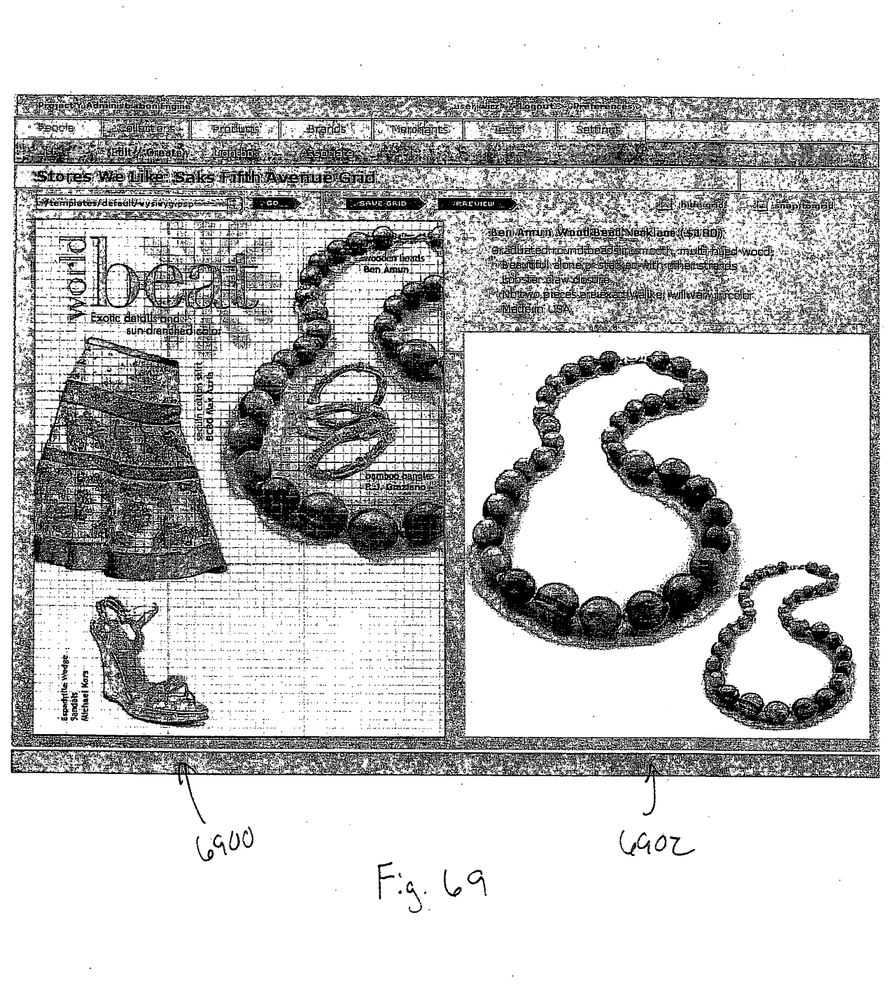

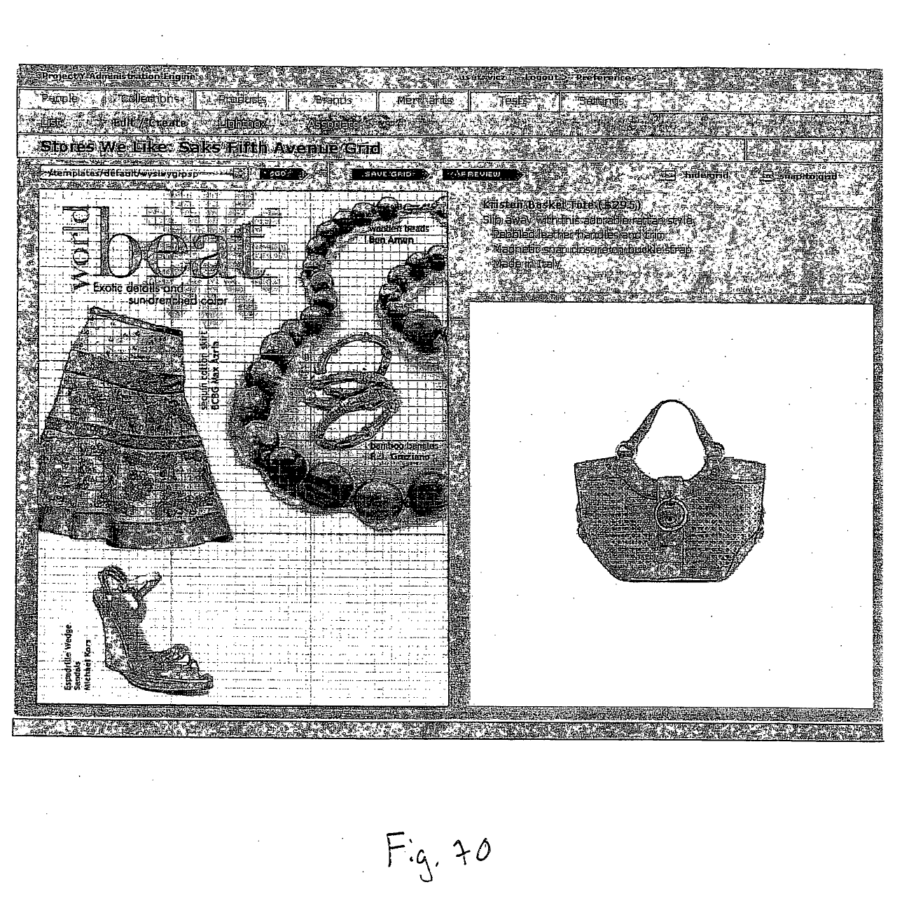

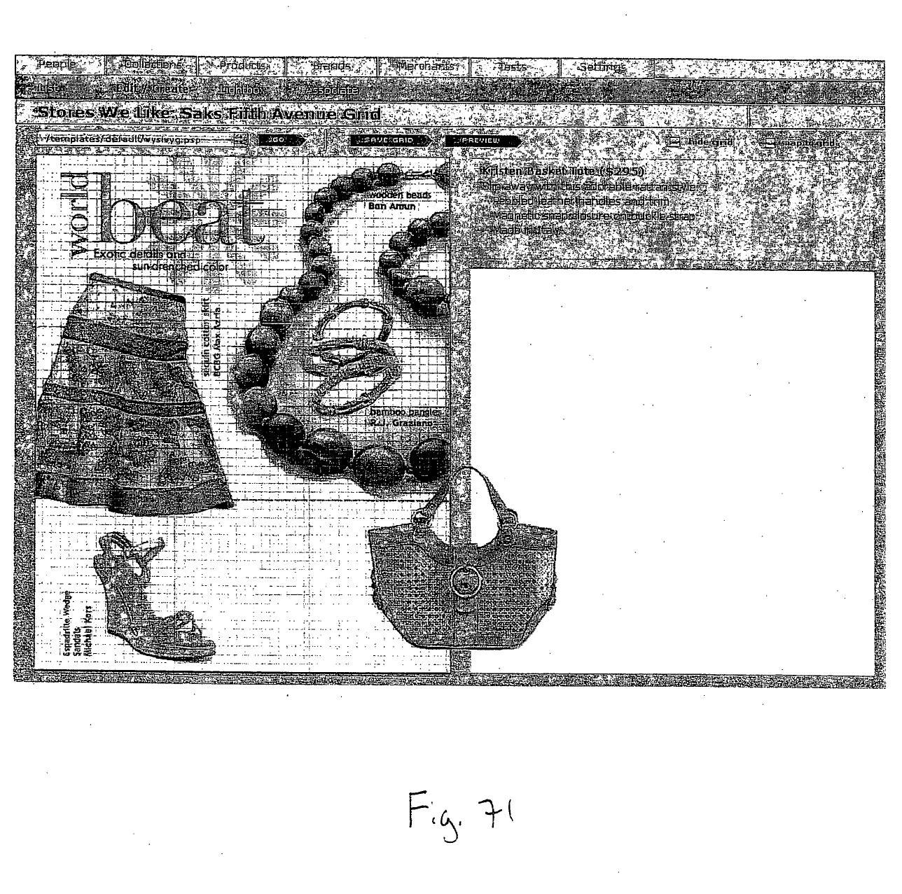

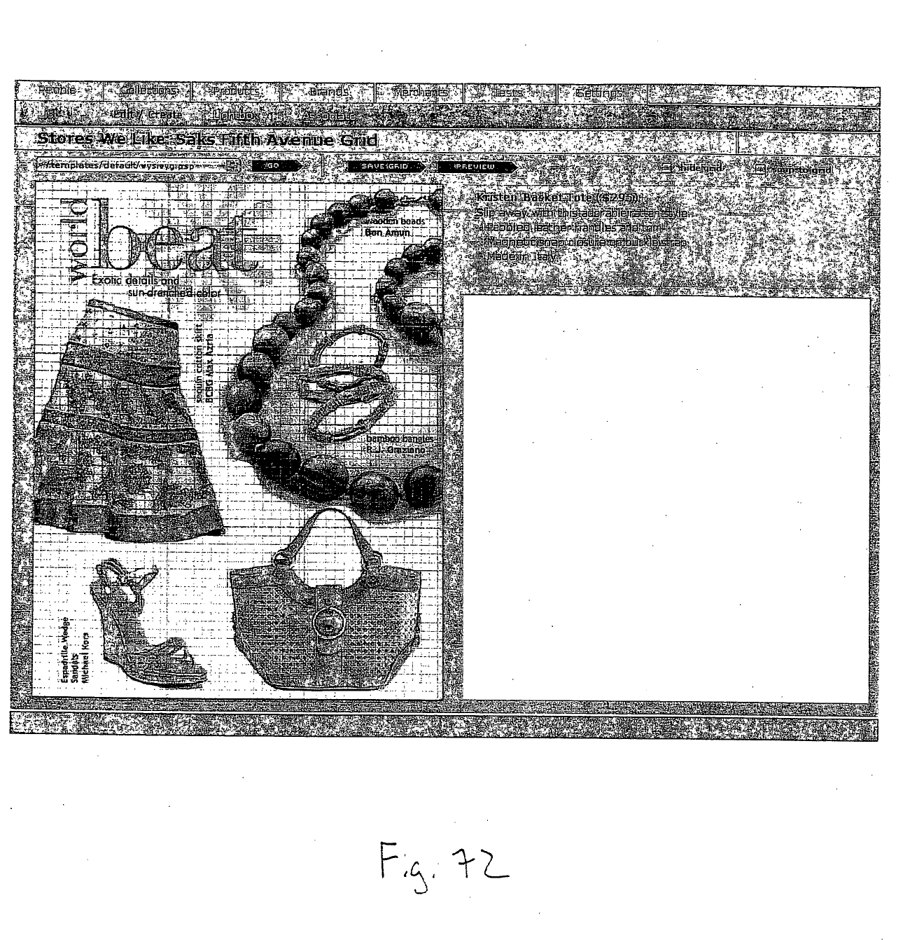

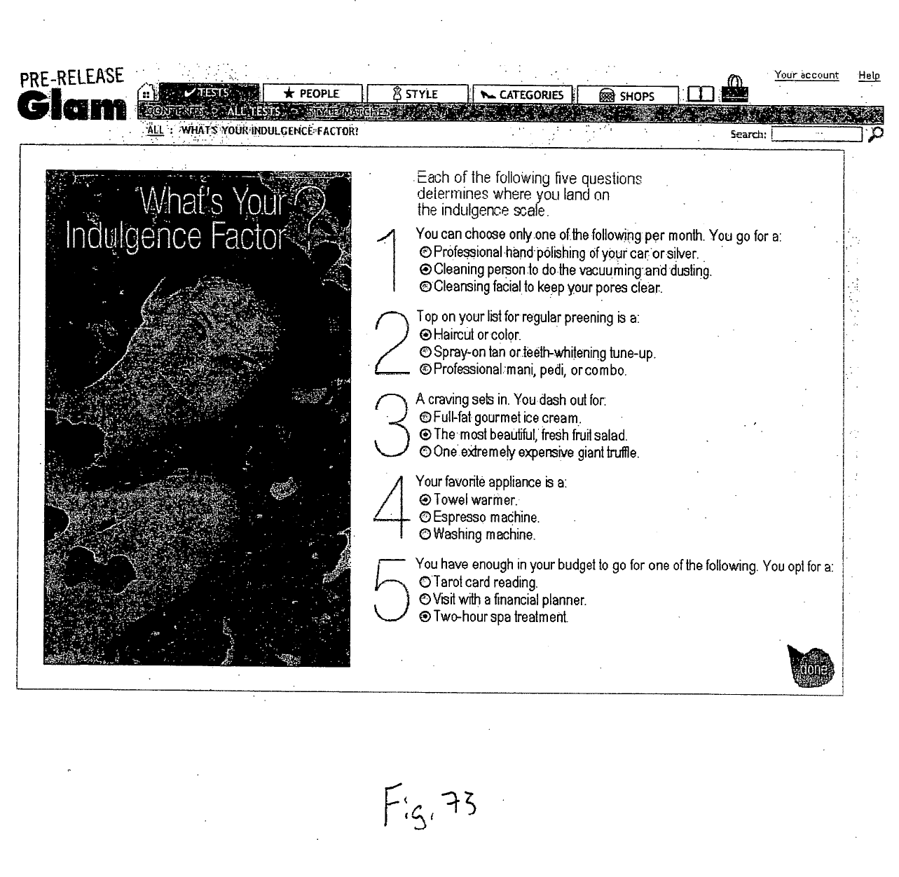

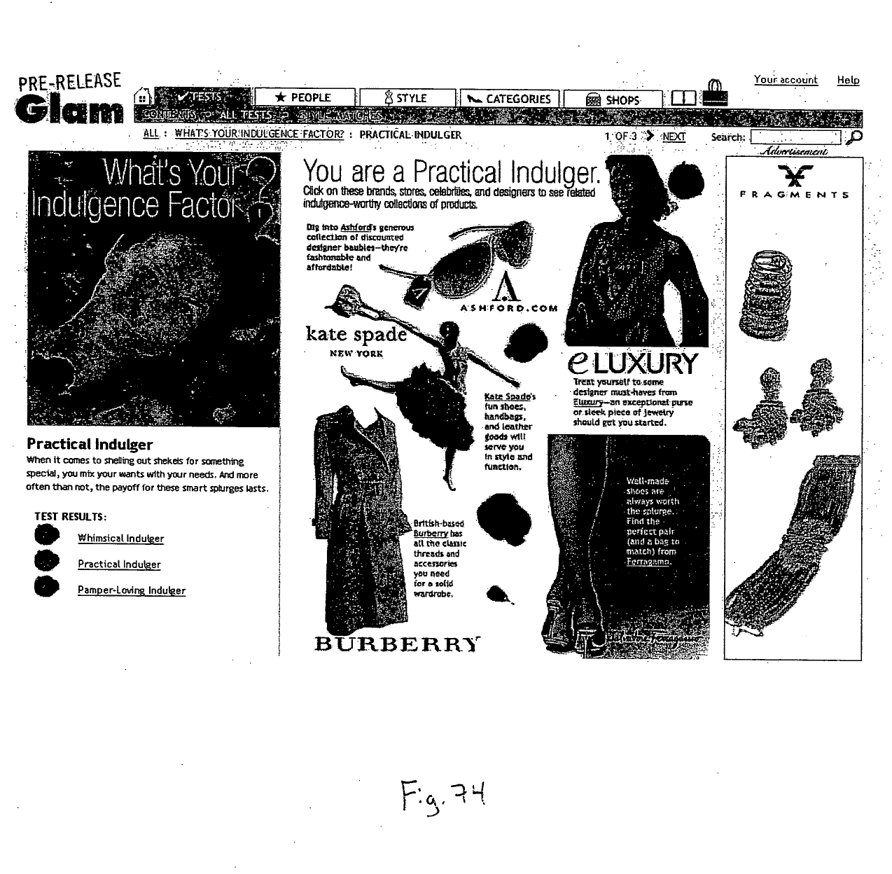

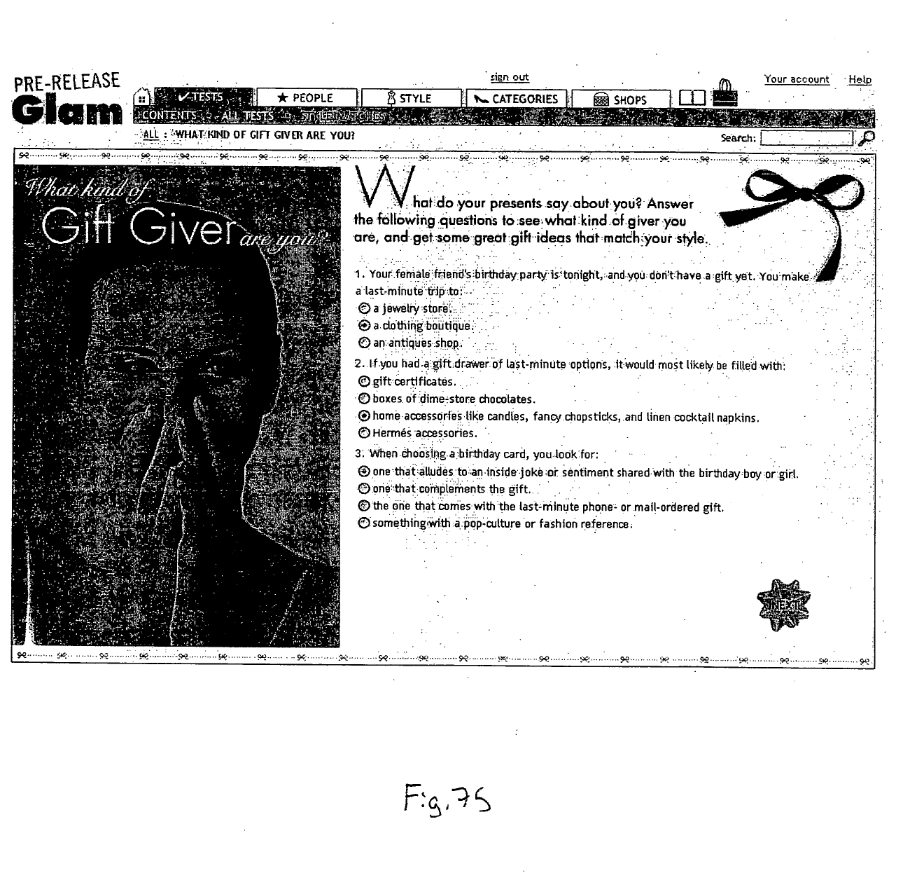

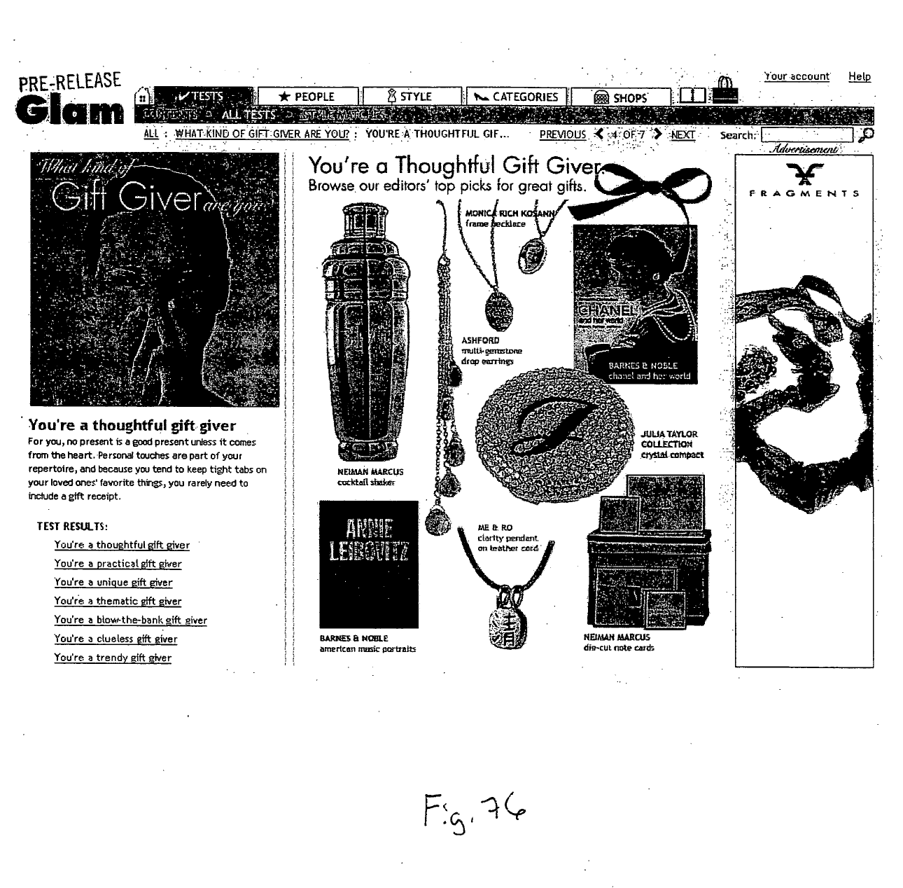

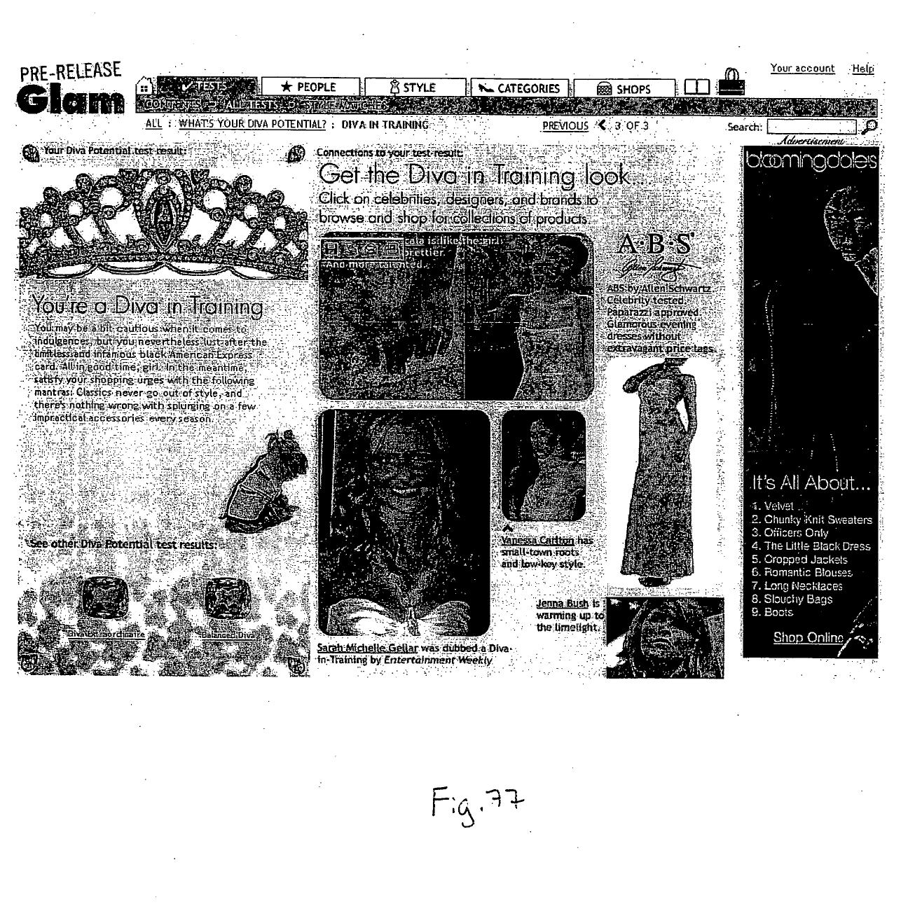

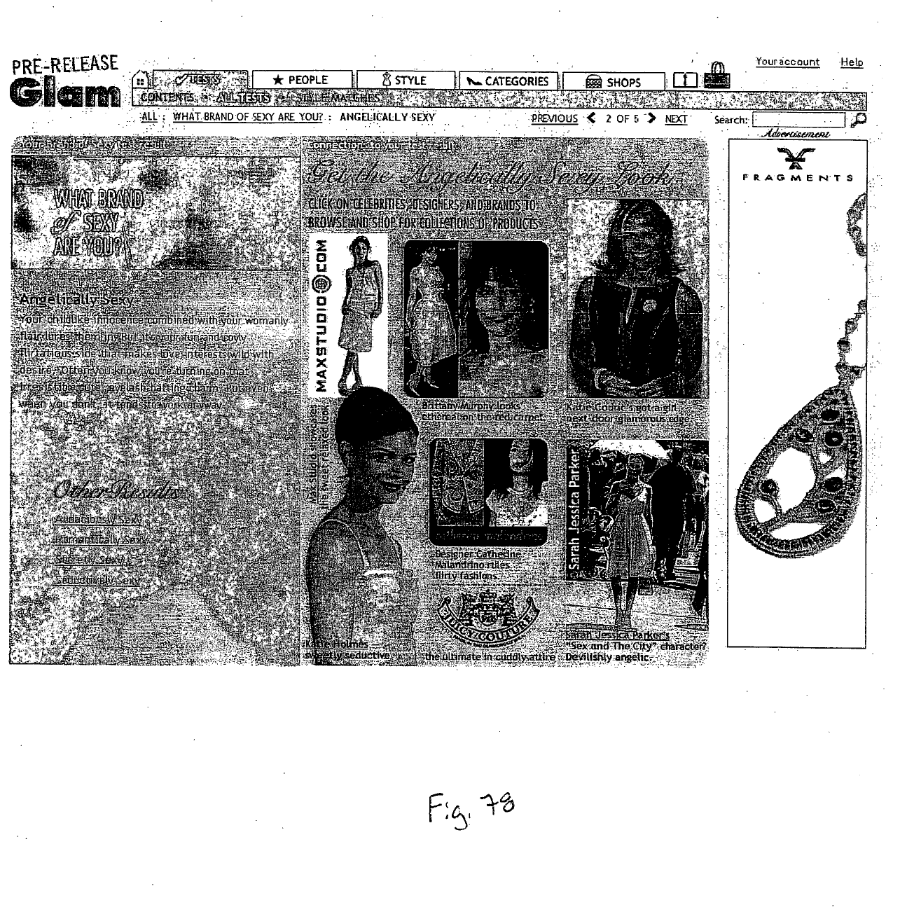

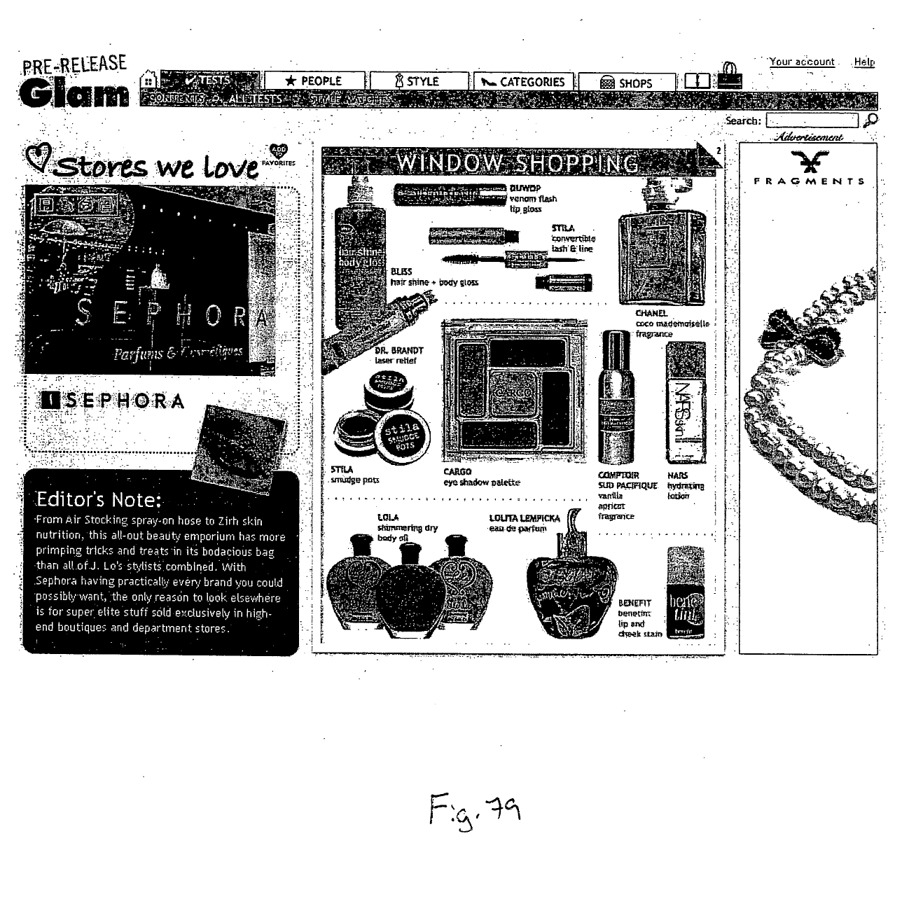

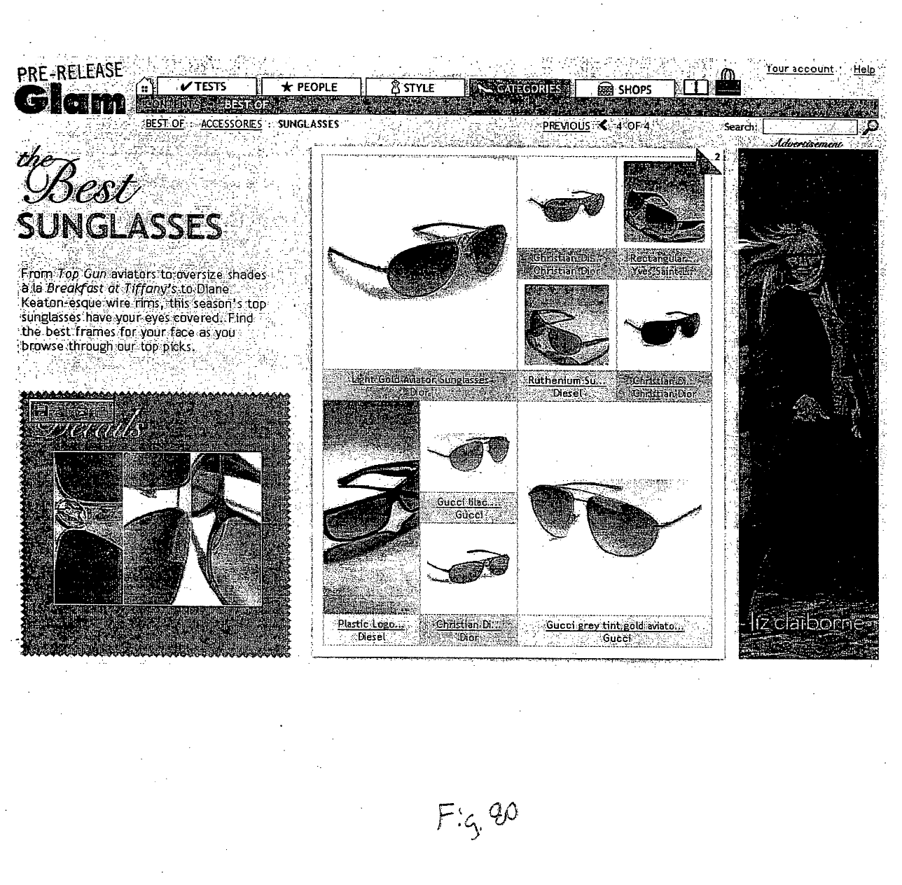

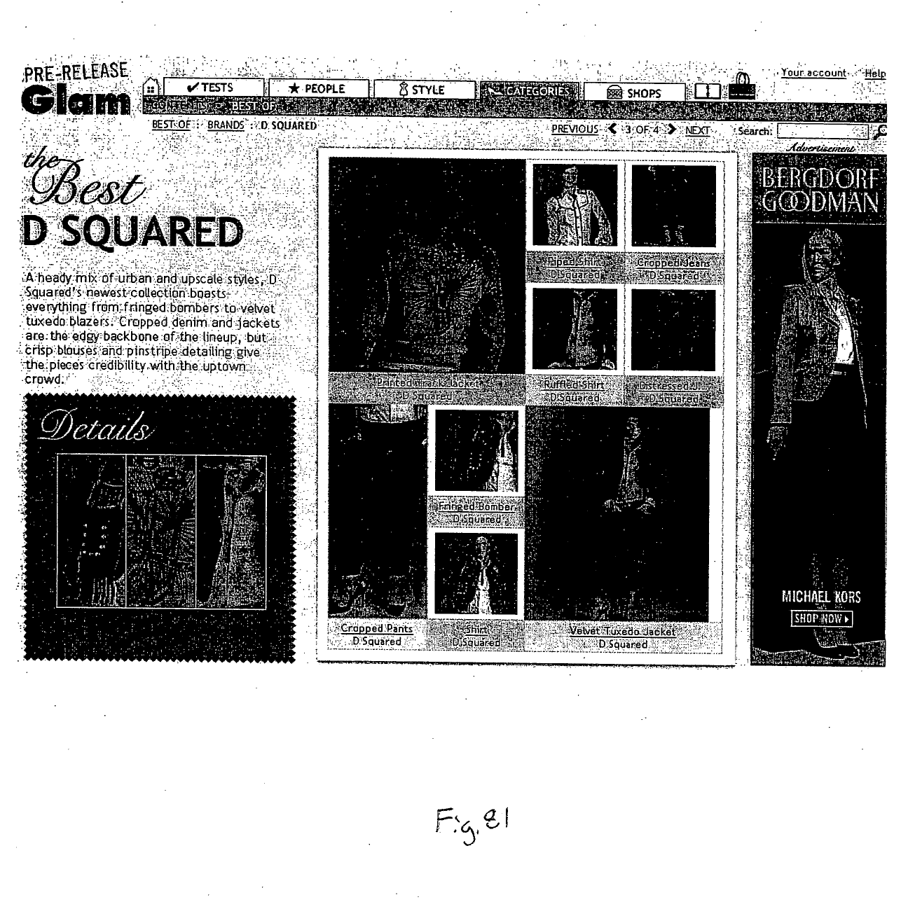

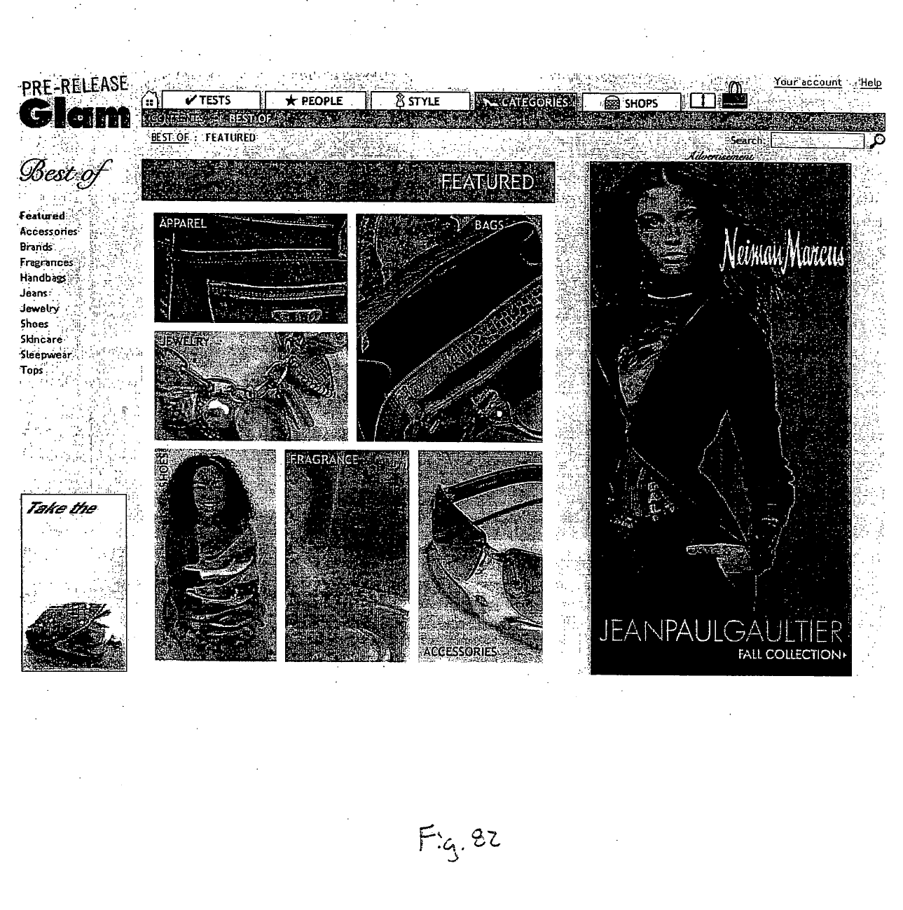

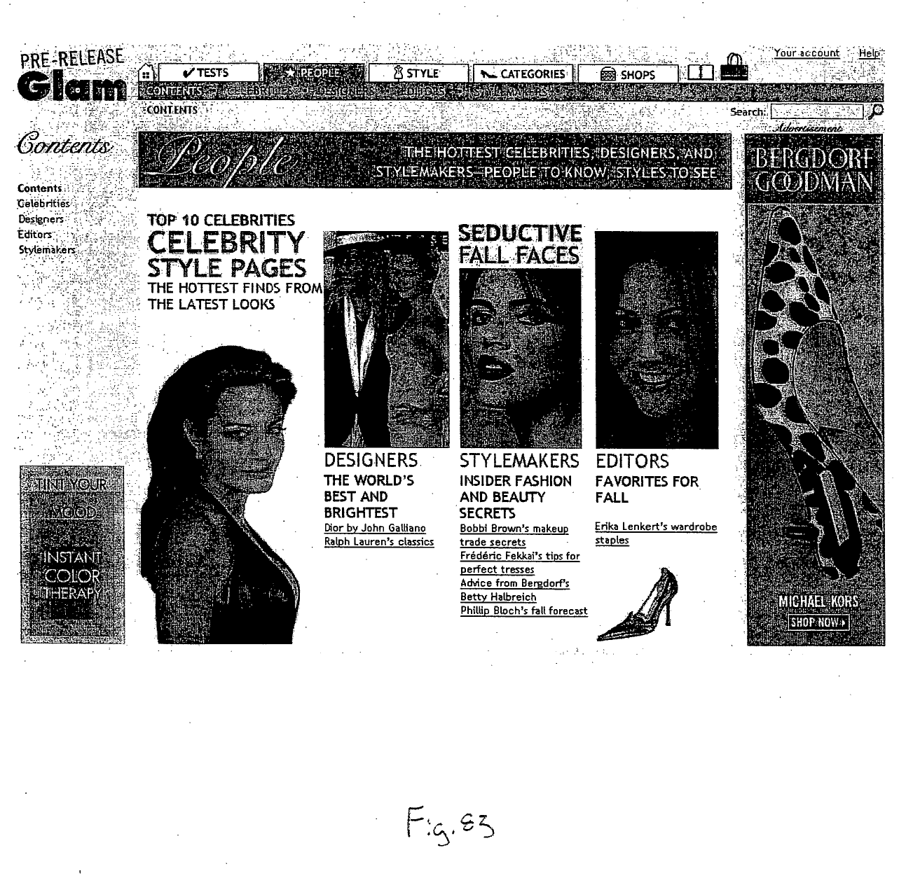

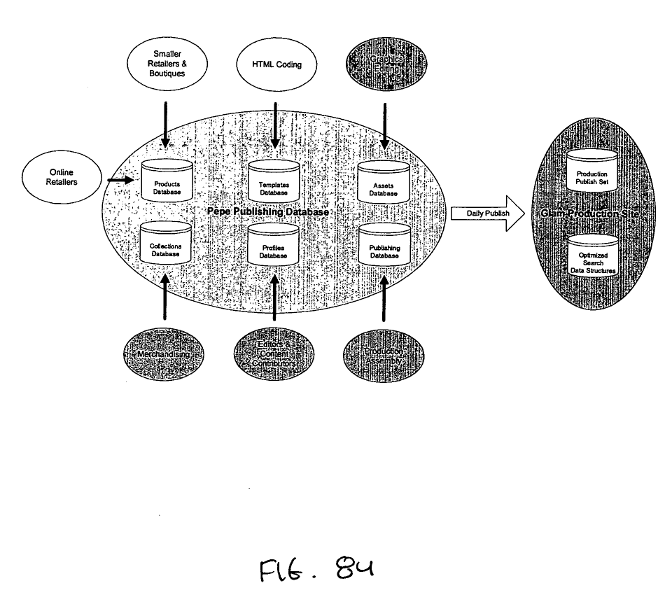

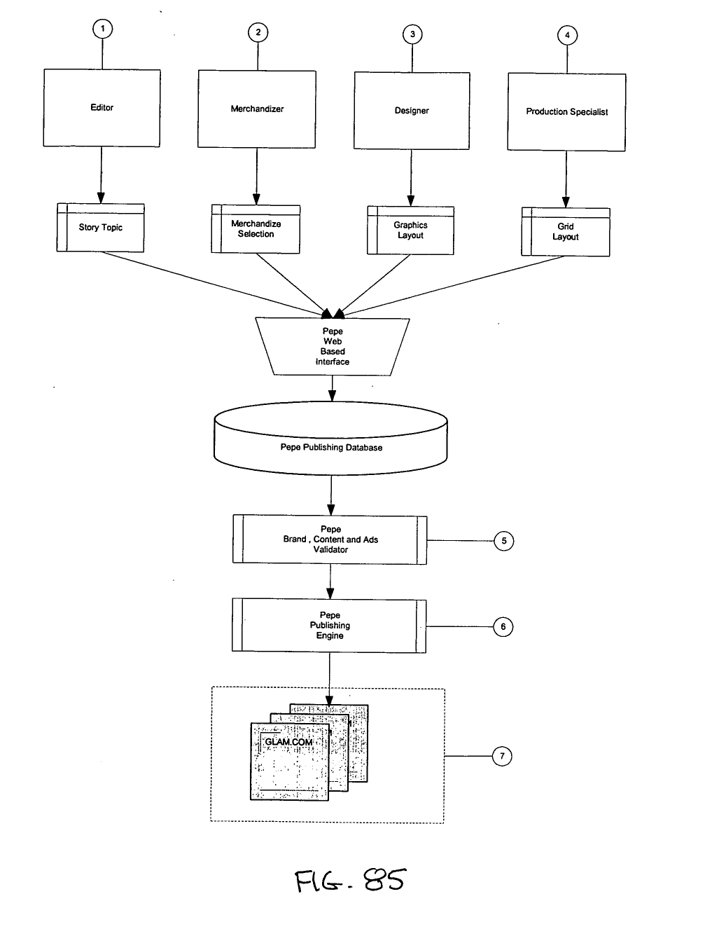

FIG. 85 provides a flow chart of a publishing engine process that can be utilized to implement the concepts of the invention discussed above.

As shown in FIG. 85, using a web-based interface, an Editors creates the object records for the story being authored for the site. As discussed in detail above, this may involve the creation of a “Collection” object. See, for example, FIGS. 53, 54 and 44. Using the web-based interface, Merchandisers can browse through millions of products imported every day from merchant affiliates and create groupings of products called “Collections” herein that will be designed later by a Designer and implemented by a Product Specialist. See, for example, FIGS. 41, 51 and 42. Using a graphics production editor such as Adobe Photoshop, the Designer creates a wysiwyg layout for the Collection. The layout then gets uploaded using the web-based interface. See, for example, FIGS. 39, 40 and 52. Using the web-based interface, the Production Specialist implements the wysiwig visual design for the Collection and then links to this page from the site. It is important to note that, because of this process, the resulting site is going to render this custom visual layout by dynamically generating html. Not a single line of coded html is required to make this process work. The creation of the layout happens by using drag and drop techniques between assets associated to the Collection. See, for example, FIGS. 55, 46, 47, 48 and 49. Before the site is published, the system validates via a batch process that all pages have content, brands and links that are compliant with the Advertisers and Affiliates Brands rules. As an example, products, advertisements or content from Saks Fifth Avenue and Neiman Marcus may never be displayed on the same page. The same concept applies to brands such as Gucci and Prada or advertisers such as Gap and H&M. After the Editorial, Content, Ads and Brands are validated, the publishing engine generates the required database exports and html files that are required to serve the site. As the site is being published, the applications servers adopt a new copy of the site. See, for example, FIGS. 60 and 63. Because the site was published as a whole using database based versioning and generation techniques, all prior generated content is available via different protocols such as RSS Feeds or a Search The Archives feature.

It should be understood that the sites described herein can use any appropriate technology, such as HTML, JavaScript, SQL server, etc., as known in the art for serving and displaying the material discussed herein. The information can be delivered by any appropriate means, such as over an Internet connection, over a wireless connection, offline from a computer readable medium, or via any other appropriate signal or information delivery mechanism. The material can be viewed on any appropriate device, such as a computer, television, mobile phone, handheld gaming device, or other device capable of displaying the information. The code and images for the site, as well as any other content, can be contained on a central server, on many different servers, on a number of networked computers, on a single computer, on a computer readable medium, or on any other appropriate device known or used for containing such information. The computer readable medium can be any appropriate medium, such as may include flash memory, hard disks, optical discs, CD-ROMs, DVDs, memory sticks, memory drives, memory chips, magnetic media, transmission signals, and any other appropriate medium. Portions of the sites and the tools for creating and displaying these sites can be implemented in software, hardware, or a combination thereof using any appropriate technology known or used in the art.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

What is claimed is:

1. A method of displaying information to a user in an online environment, the method comprising:
obtaining information and/or attributes from the user;
selecting and organizing content of a story based upon the information and/or attributes obtained from the user;
providing the content of the story to the user online in an interactive environment.

2. A method as in claim 1, and wherein the content of the story is provided to the user as a plurality of chapters, each chapter including a plurality of subchapters, each subchapter including a plurality of pages.

3. A method of displaying information to a user in an online environment, the method comprising:
creating object records for a story being authored;
creating collections groupings;
creating content for the collections groupings;
creating a page layout for the collections groupings content;
implementing a virtual design for the page layout;
linking the virtual design to an associated page of an online site; and
publishing the virtual design to the associated page.

4. A method as in claim 3, and further comprising:
prior to publishing the virtual design to the associated page, verifying that the virtual design has content compliant with rules.
